(19) United States
(12) Patent Application Publication
(10) Pub. No.: US 2007/0174079 A1
(43) Pub. Date: Jul. 26, 2007

(54) APPARATUS AND METHOD FOR DIGITAL IMAGING, EDUCATION, AND INTERNAL MARKETING SOFTWARE AND SYSTEM

(76) Inventor: Steven J. Kraus, CARROLL, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/566,129

(22) Filed: Dec. 1, 2006

Related U.S. Application Data
(60) Provisional application No. 60/741,267, filed on Dec. 1, 2005.

(51) Int. Cl. G06Q 99/00

(52) U.S. Cl. 705/1

(57) ABSTRACT

A method and system for automatically managing multiple different functions of an office by storing or linking together multiple different types of data that is normally stored separately, such that summary reports requiring data from fields normally not stored together can be created efficiently and effectively, and a method and system for automatically selecting client education, marketing or other business-related information or materials from a stored collection of such information or materials based on selection criteria established by the business, such that the selected information or materials are targeted to the specific client based on demographic and other client information and scheduling and other business information. In one aspect of the invention, a patient education module has a library of content on hand. The information and materials play automatically to a designated monitor near the location of the client and the material viewed is documented in the client's electronic record with customized notation by user. The material viewed has a supportive component hand-out or supportive accompanying written information that is automatically printed at the receptionist desk at the time the material is viewed on the monitor by the client.

### RELATED APPLICATION

This application claims priority under 35 U.S.C. § 119 of a provisional application Ser. No. 60/741,267, filed Dec. 1, 2005, and incorporates by reference that application in its entirety.

### I. BACKGROUND OF THE INVENTION

A. Field of the Invention

This invention relates generally to office management technology, and more particularly, though not exclusively, to a method for managing multiple different facets of an office, such as client records, education, marketing, and billing alone or in combination with each other.

B. Problems in the Prior Art

The use of office management software is widespread in the industry. For example, existing office manage software can perform billing, scheduling and client recordkeeping tasks automatically. This same software usually can store client, billing, scheduling and other business information, such as information used by the business in providing goods and services to the client. By way of example only, a medical office management software system practice may store patient information, such as the patient's name and address, billing information, such as billing address and/or credit card information, scheduling information, such as what patient is in what office at what time, and other information related directly to the provision of medical services to the patient, such as SOAP notes, diagnoses and other procedural information.

However, office management software normally separates client, billing, scheduling and business information from each other. As a result, tasks that require multiple different categories of information (i.e., client, billing, scheduling and business information) at the same time are either impossible or extremely inefficient to perform. For example, most office management software packages cannot efficiently and effectively provide summary information concerning billing, scheduling and services provided for a particular client. Moreover, if information that spans multiple categories is changed in only one of the categories, then inaccuracies and inconsistencies will result. Thus, an unfulfilled need exists for an office management system that can either combine or efficiently link the multiple different categories of information together into one storage or virtual storage location of all of the information maintained by the office. By way of example only, an unfulfilled need exists to combine or link together all of the client, billing, scheduling, and service provision-related information for a single client.

In today's highly competitive and specialized marketplace, consumer demands have caused businesses to offer unique advantages to be able to succeed. For example, while some businesses manually provide consumers with different types of information related to the businesses goods and services, this is not optimal. For example, when employees manually provide information to consumers, it is difficult for the business to ensure the employees present the materials in a consistent, quality fashion that is easy for the consumer to hear and understand. Moreover, consumers increasingly demand more utilization of multimedia in the provision of this type of information. However, office management software currently does not effectively store, manage, run and display multimedia technology. Current office management software can take up to several minutes to load video presentations in remote locations and may cause even further delay if different types of multimedia with different formats are played. Further, employees may not realize a video or other multimedia presentation is over for quite some time, such that the client may not be able to receive as much information as ideal given the anticipated wait time for the client. These delays and inefficient uses of client's time can be problematic for businesses with busy, impatient clients. As a result, an unfulfilled need exists for an office management system that can efficiently and effectively store, manage, run and display multiple different types of multimedia so as to maximize the consistency and quality of the information presented and to minimize undesirable delays.

Similarly, today's consumers increasingly desire to make more informed purchasing decisions. As a result, consumers demand more information and educational services from businesses. Moreover, consumers demand information and educational services that are directly relevant to them individually and that are presented in a quality and easy-to-understand fashion. However, business owners have a limited amount of time to spend with each consumer during an office visit. As a result, businesses often either provide insufficient information and educational services and/or provide generic information and educational services that are not targeted to an individual consumers. Either way, such businesses fail to provide enough targeted information and educational services to satisfy consumers' demands. Thus, an unfulfilled need exists for businesses to be able to provide consumers with high quality, easy-to-understand information and educational services that are targeted to the consumers without having to expend the time to ascertain which services are most relevant to the consumers during the office visit and without having to have a human provide the information and/or educational services. This is especially prevalent with information that is likely to be repeated numerous times during a giving day and that ideally should be presented the exact same way each time to ensure quality control. An example in medical practice is Informed Consent. It is a legal document. A staff person or medical professional normally must explain it face-to-face with the patient prior to surgery or whatever the procedure might be. This takes a significant amount of time.

Further, many businesses offer multiple and/or varying types of goods and services. However, consumers often do not know or comprehend all of the services that a particular business provides. Yet, consumers generally do not desire to view general marketing videos or brochures that are not targeted to their individual needs. However, as explained above, businesses and the existing office management software packages are not well equipped to make such determinations. Thus, an unfulfilled need exists for businesses to be able to provide marketing and other promotional information to clients that is targeted to each individual client.

Some businesses manually can separately review all of the multiple different records stored for an individual client and the business (i.e., client, billing, scheduling and other information related to the business' provision of goods and services) to attempt to ascertain which informational, educational, marketing, promotional and/or other materials are most likely relevant to the individual client just prior to visiting with the client in the business' offices. However, this is not optimal for most businesses for many reasons. As discussed above, most businesses do not have enough time to spend on this selection process and would have to hire additional employees to perform this task, which would increase the business' expenses and decrease the business' profit margin. Similarly, having a person make an on-the-fly analysis of all the client's information and thereby determine which information to provide to the client will increase the likelihood that materials selected significantly vary from those that the business as a whole would desire to be selected. Further, having different employees determine how to communicate the information would inherently import imprecision into what information is actually communicated to the clients. Again, an unfulfilled need exists to ensure the consistency and quality of the information communicated to clients.

### II. SUMMARY OF THE INVENTION

Thus, it is a primary object, feature, or advantage of the present invention to provide a method for managing a business office which satisfies these needs.

A further object, feature, or advantage of the present invention is to provide a method for managing a business office which stores or links together multiple different types of information traditionally stored separately.

A still further object, feature, or advantage of the present invention is to provide a method for managing a business office that efficiently and effectively stores, manages, runs and/or displays multimedia information to clients of the business.

Another object, feature, or advantage of the present invention is to provide a method for managing a business office that automatically selects which multimedia to be provided to a client based on selection criteria established by the business.

Another object, feature, or advantage of the present invention is to provide a method for managing a business office that can analyze multiple different categories of information related to the client, the business and the available multimedia and use such information to automatically select which multimedia the business desires the client to view based on selection criteria established by the business.

Another object, feature, or advantage of the present invention is to provide a method for managing a business office that can provide educational, marketing, promotional and other business-related information and services in a consistent, high quality and easy-to-understand manner.

Another object, feature, or advantage of the present invention is to provide a method for managing a business office that can provide educational, marketing, promotional and other business-related information and services in a manner that allows clients to comprehend the information and services provided regardless of the client's individual learning style or styles.

Another object, feature, or advantage of the present invention is to provide a method for managing a business office that can automatically track which educational, marketing, promotional and other business-related information and services have been provided to each of the business' clients.

Another object, feature, or advantage of the present invention is to provide an improved method for managing a business office that reduces the business' expenses while increasing the consumers' satisfaction in relation to office visits.

Another object, feature, or advantage of the present invention is to provide a method for generating more business for the office by increasing already existing clients' awareness of the office's different goods and services it can provide without decreasing clients' satisfaction.

Another object, feature, or advantage of the present invention is to provide a method for increasing the productivity of the employees of a particular business by decreasing the amount of time expended on: (1) selecting which educational, marketing, promotional and other business-related materials to provide to a client, (2) providing, conveying, explaining and/or discussing such materials to a client; (3) tracking which information has been provided to each individual client; and/or (4) training other employees to perform any of these three tasks.

According to one aspect of the invention, a method of and system for automatically managing an office is provided. This system stores multiple different types of information relevant to the business and its clients. The method of storing causes the information to be either stored all in one location or linked together via methods known by one of ordinary skill in the art. This linked or collection of information could then be efficiently and effectively searched to provide summary reports for the business or the client. By way of example only, in a medical office embodiment of this aspect of the invention, the system would store multiple different types of client, billing, scheduling, educational, marketing and other information related to the provision of medical services in a manner that all of such information would either be linked together or stored together. As a result, summary reports could be run for the office of for a particular client. Similarly, such summary information could be depicted in graphical format (e.g., in one glance a medical office employee could see whether a patient is responding to certain treatment in the form of a graph that summarizes past history of office visits measure certain conditions over time; this could show in one quick view of one graph whether a patient's range of motion is improving, staying the same or getting worse). For example, a medical office may run a report to determine which services are most efficiently run in each of the particular offices or a report to determine for which types of services a particular client pays on time and for which services a particular client does not pay within sixty days of the office's sending out of the client's bill. The system would preferably include or be capable of being linked to a system which is capable of automatically selecting which of a selection of educational, marketing, promotional and other business-related videos, brochures, posters, other multimedia and/or other media or information to provide to a client while the client is waiting to see a business representative based on parameters set by the business. The system would preferably be able to store multiple different types of educational, marketing, promotional and other business-related videos, brochures, posters, other multimedia and/or other media or information in such a way that they can be easily and quickly accessed, loaded, run and/or displayed in one or more offices in the business at the same and/or different times. The system would preferably be able to schedule the businesses various tasks based on information related to the business and the businesses' clients. The system would preferably be able to manage the billing aspects of the business based on information related to the business and the businesses' clients. The system would preferably be able to receive faxes from other businesses, automatically ascertain which faxes are relevant to the business, transfer the relevant faxes to the desired recipients and send a fax back to the sender of faxes that are determined to be unsolicited marketing, promotional or otherwise undesirable faxes demanding that the business' fax number be removed from the sender's list of fax numbers.

According to another aspect of the invention, a method of and system for automatically selecting which of a selection of educational, marketing, promotional and other business-related videos, brochures, posters, other multimedia and/or other media or information to provide to a client in the business' offices while the client is waiting to see a business representative based on parameters set by the business. Preferably, the automatic selection will be based on the analysis of information related to the multimedia and other information and/or goods and services to be provided to the client (e.g., length, category, etc. . . .), the billing information concerning the client (e.g., the client's ability to pay for certain procedures), the scheduling information for the office (e.g., the expected wait time for the client), client information (e.g., the client's demographics, hobbies, interests, etc. and/or the client's family members' demographics, hobbies, interests, etc. . . .) and selection criteria created by the business that ranks the priority of each educational, marketing, promotional and other business-related videos, brochures, posters, other multimedia and/or other media or information in light of the information. The method will also preferably have the ability to track which educational, marketing, promotional and other business-related videos, brochures, posters, other multimedia and/or other media or information has been provided to the client and to use that tracking information in the selection process. The apparatus will preferably also be able to store multiple different types of educational, marketing, promotional and other business-related videos, brochures, posters, other multimedia and/or other media or information in such a way that they can be easily and quickly accessed, loaded, run and/or displayed in one or more offices in the business at the same and/or different times.

One or more of these and/or other objects, features or advantages of the present invention will become apparent from the following specification and claims.

### III. BRIEF DESCRIPTION OF THE DRAWINGS

The present invention is illustrated by way of example and not limitation in the figures of the accompanying drawings, in which like references indicate similar elements and in which:

FIG. 1 is a diagram illustrating a layout of the hardware for a preferred embodiment of the office management method and system aspect of the present invention.

FIG. 2 is a diagram illustrating the basic components of a preferred embodiment of the automatic selection method and system aspect of the present invention.

FIGS. 3A-K are computer screen displays that illustrate aspects of an embodiment of the present invention.

FIG. 4 is a hardware layout according to an embodiment of the invention.

FIGS. 5A-N are computer screen displays and other illustrations of aspects according to an embodiment of the invention.

FIG. 6 is a system landscape diagram for a system according to an embodiment of the invention.

FIG. 7 is a screen display of an embodiment of the Dashboard Documentation Control Center feature.

FIG. 8 is a diagram of an embodiment of an Automatic Selection Method and System according to an embodiment of the invention.

FIGS. 9A-D are flow charts for an embodiment of the Automatic Selection Method and System.

FIGS. 10A-O are screen display examples for the Range Star™ feature according to an embodiment of the invention.

### IV. DETAILED DESCRIPTION OF THE PREFERRED EMBODIMENT

A. Automatic Office Management Method and System

One aspect of the present invention is directed to a method and system for automatically managing an office. The automatic office management method and system manages multiple different functions of a business office. Preferably, the automatic office management method and system manages the business office's client recordkeeping, billing, scheduling and core business functions (i.e., functions related to the actual provision medical goods and services for a medical office embodiment of this aspect of the invention).

Further, the automatic office management method and system stores multiple different types of information relevant to the client and the different functions of the business. The system and method for storing would cause the information to either be stored all in one location or be linked together via methods known by one of ordinary skill in the art.

If the information is stored separately in different tables that are not linked together, problems can arise. For example, the system may not be able to search all of the fields of all of the tables relevant to a particular client or to the business as a whole, such that summary reports could not be generated, at least not efficiently and effectively. Further, when fields overlap multiple tables without being linked for a particular client, changes to the data in one of those fields for the client will not necessarily change that same data for that field in the other tables for the client. Thus, inconsistent and inaccurate data storage can result.

In a preferred embodiment of this aspect of the invention, a relational database is used to store the business' information related to a particular client in one table. However, one of ordinary skill in the art will recognize that many different types of storage techniques can be used. By way of example only, multiple different tables could be set up for different categories of information relevant to different functions of the business. For example, a different table could exist for each different function of the business (i.e., separate tables could exist for client recordkeeping, billing, scheduling and core business information). Each of these tables could be linked based on key fields that overlap between the tables. As a result, the system is set up such that when data is changed for one of the fields in one of the tables for a particular client, it automatically will be changed for all of the tables that include that field for that client.

By way of example only, in a medical office embodiment of this aspect of the invention, the system could store multiple different types of patient, billing, scheduling, educational, marketing and other information related to the provision of medical services in a manner that all of such information would either be linked together or stored together. Examples of patient information include patient number, name, address, home phone number, work phone number, mobile phone number, gender, age, occupation, recreational activities, past health history, present illness symptoms, and how the client learned of the medical office. Preferably, the patient number is a unique identifier of the patient that can be used as a key indexer for linking, summarizing or otherwise collecting the patient's information. Examples of billing information include patient number, name, billing address, pay class (i.e., cash, insurance, credit, etc. . . .), insurance providers, insurance coverage, payment history and outstanding balance owed. Examples of scheduling information include the number of offices in the business, the availability and/or occupancy of each office, the expected time of a particular scheduled office visit, the number and name of the patient scheduled in a particular office at a particular time. Examples of educational and marketing information and/or materials include title of the information and/or materials, type (i.e., video, poster, poster group, etc. . . .), purpose (i.e., educational, relaxation, experimental, marketing, etc. . . .), category (i.e., action, chiropractic information, back care, nutrition, knees, foot care, neck, etc. . . .), point rating (i.e., the rating score of the information and/or other materials), duration of the educational, marketing and/or other business information and/or materials and whether the patient has previously seen the information and/or materials. Examples of information related to the provision of medical services include allergies, diagnoses, family history, gender, patient office visit information (such as visit number and date of last visitation), medical conditions, occupational activities, recreational activities, and past and/or scheduled surgeries.

According to this embodiment, numerous different summary reports could be run for the medical practice itself. By way of example only, a medical office may run a report to determine which services are most efficiently run in each of the particular offices, which doctor sees the most clients, which types of procedures are most profitable, which types of procedures are clients most likely to pay for within a month or ninety day period, and/or which doctors get the most referrals. Similarly, numerous different summary reports could be run concerning a particular patient or a group of patients. For example, a summary report could be run to determine for which types of services a particular patient pays on time and for which services a particular patient does not pay within ninety days, which age group of clients has the highest percentage of members with a certain medical condition and/or what is the zip code with the highest percentage of patients with a certain medical condition.

Similarly, in an insurance office embodiment of this aspect of the invention, the system would store multiple different types of client, billing, scheduling, educational, marketing and other information related to the provision of insurance services in a manner that all of such information would either be linked together or stored together. Examples of client, billing and scheduling information are essentially the same as for the patient, billing and scheduling information described in the medical office embodiment above. However, additional fields may also be relevant in the insurance industry, such as past accident history, number of claims made by the client, type of billing (i.e., monthly, bi-annually or annually), educational history and success, religious affiliations and alcohol consumption habits and history. Most of the same types of educational and marketing fields will overlap between the insurance office embodiment and the medical office embodiment. However, many of the core business fields will be different for insurance office embodiment. For example, examples of potential desirable fields of data related to the provision of insurance services include the type of good(s) and/or services the client has with the insurance agent (i.e., home, automobile, life, personal liability umbrella policies, etc. . . .), the specific coverage (i.e., whole life vs. flexible life, collision vs. comprehensive automobile, etc. . . .), and/or what discounts the customer has (good driver discount, good student discount, no drinking or smoking discounts, etc. . . .). Again, numerous different types of summary reports could be run for the office or for a particular client. For example, the insurance office could run a summary report to determine which ages or genders of clients are the most likely to get in an accident, pay premiums on time and/or get coverage in multiple different categories of insurance and financial products. Similarly, the insurance office could get a summary of a particular client's payment history broken down by the different types of coverage the client has.

The system would preferably include or be capable of being linked to a system which is capable of automatically selecting which of a selection of educational, marketing, promotional and other business-related videos, brochures, posters, other multimedia and/or other media or information to provide to a client while the client is waiting to see a business representative based on parameters set by the business. A more detailed description of this educational, marketing and other business related information and/or other materials management system is provided below.

The system would preferably be able to store multiple different types of educational, marketing, promotional and other business-related videos, brochures, posters, other multimedia and/or other media or information in such a way that they can be easily and quickly accessed, loaded, run and/or displayed on one or more monitors in one or more offices in the business at the same and/or different times. Preferably, this would be accomplished by a virtual document storage system, which is a collection or library of different electronic items (such as documents, videos, other multimedia or media and/or other materials and information) that can be provided or shown to clients of the business. Preferably, the virtual document storage system can store all of these types of items for the business office, such that no paper versions of the items would have to be kept. It could also have alert screens to provide business employees with information that may be relevant to the provision or showing of certain items to the business' clients. It could also could have viewing screens that allow the business to input data concerning new items to be stored in the virtual document storage system, change and/or update data concerning items already stored in the virtual document storage system and to delete or modify the content of the items themselves. Preferably, the user would also be able to use touch-screen technology to perform these tasks. The virtual document storage system could also store items in multiple different formats. For example, the virtual document storage system could preferably store some items (e.g., x-rays) that are in dicom format. Further, the virtual document storage system could have a separate storage area that temporarily stores items before a business representative inputs the initial data about the item. For example, faxes received by the business would temporarily stored in this separate area until the business representative determines whether it is undesirable to maintain or whether it is something that should be input into the system.

The virtual document storage system could also store multiple template documents for the business. Further, it can include a user screens with toolbars and an icon on each toolbar demonstrating how many documents have been filed specifically for a particular business representative's clients. For example, the system could include a counter that tracks the number of documents that have been filed today for that specific persons clients and send that information to the icon where it can be displayed. The user can then click the icon to view on which clients that they have received a document that has just been filed from the staff. The user can then view that document and click the document after reviewing it, and that reviewed document could then be removed from the in basket as having been reviewed. This allows each user to know what documents have arrived, and the user can quickly click the item to remove it from the list. It further allows for each business representative to be aware of any new documents filed within his or her specific client list. Only those items associated with that business representative would appear on the in basket icon on the toolbar.

The virtual document storage system also could have the ability to create a customized file for a client. For example, the user could choose to create as many tabs on the file as they desire. The user could also select subcategories under teach tab. By way of example, in creating a customized medical chart for a medical embodiment of this invention, the user could choose to have the following main tabs: General history, Examination, Radiology, Lab results, Daily clinical notes, Reports from other providers, Insurance and Prescriptions. The user could then select subcategories under these main tabs, for example, under Radiology the user may select: Plain film x-ray, Digital x-ray, MRI, CT, Bone scan, or Bone densitometry. Any business can customize the detailed level of filing documents. Later, when the user chooses to categorize documents within a file, they can choose to list every document within all of the tabs of a chart, they can list on a summary screen only those items in the radiology tab or they could further customize the list by minimizing only those documents stored under plain film x-ray. The virtual document storage system can either be part of the office management system or a stand alone system.

The method of storing the documents can be highly detailed by date it was filed and the date the document was created, the creator of the document or person ordering the test, and whether the document was created from within the business or obtained from outside the business. The virtual document management system could further include the ability to print, burn to a CD, e-mail, or fax directly from the system selected items or all items from a client's chart. The e-mail is encrypted requiring a password to open the document. The user has the ability to select only those documents created within the business or the user can perform a query to select documents between certain dates or in certain categories. The system requires the user to answer where the documents were sent and for what reason with the user entering their past code so the system tracks who sent documents where.

The system would preferably be able to schedule the business' various tasks based on information related to the business and the businesses' clients. Many different scheduling systems already exist in the industry and the basic functions of these scheduling systems are well-known by those skilled in the art. However, this system offers some unique scheduling system features. For example, this system preferably provides the business with the ability to estimate the time a client will have to wait for a representative. Preferably, the system makes this estimate based upon information related to both the business' and client's past practices. By way of example only, the system could track how long each individual client is actually in a particular office or location for a particular type of office visit. Similarly, the system could track how long each of the business' employees takes for a particular type of office visit. The system could then create averages and other statistics which can be used to estimate how long a scheduled appointment with a particular client and a particular business employee will take and further estimate the overall estimated schedule for the client based on such information. This would include how long the client would have to wait for the employee in light of the other estimates. In addition, the system could be designed to automatically update the status of different offices and/or appointments based on new events (i.e., reschedules, missed appointments, cancellations, transferring clients to different rooms), and it could further be designed to track who input those new events. The system could also be designed to provide an appointment history for certain or all incoming clients.

Further, the scheduling system can be designed to customize a list of room names within a business. When a client enters the business, the scheduling system can note that client has arrived and assign that client a room on the scheduler. This allows for everyone in the business to know who is in what room. The convenience for the business representative is to know which and how many clients are waiting as well as how long they have been waiting in a specific room. This information can be incorporated into an automatic selection system and/or method as described in more detail herein, and the information can be used by that system as part of the criteria used to determine which client education, marketing or other business-related item to be provided to the client and to which room they should be sent to do so. One of the benefits to the consumer of this feature of the invention is that no time has to be wasted simply waiting in a room to visit with a business representative. Rather, they can be educated on their aspects relevant to them and the business (and not just view a generic video). Similarly, one of the benefits to the business of this feature of the invention is that the entire time the client is present, the client is obtaining a value-added encounter by receiving information specific to the client's interest.

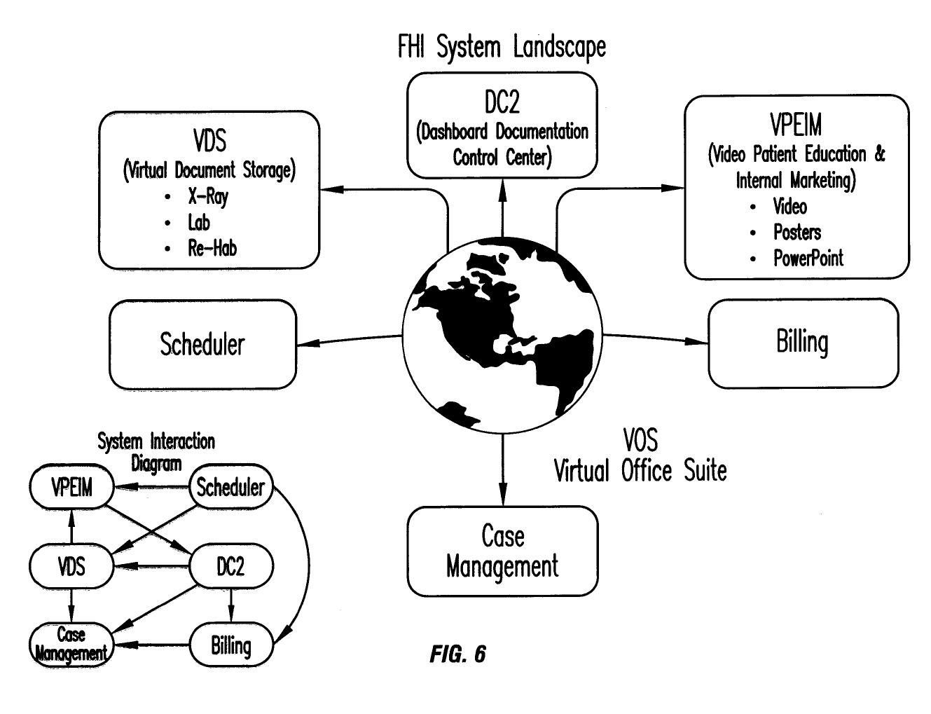

The system would preferably be able to manage various billing aspects of the business based on information related to the business and the businesses' clients. Many different billing systems already exist in the industry and the basic functions of these billing systems are well-known by those skilled in the art. However, this system offers some unique billing system features. For example, billing functionality of the office management system could have the ability to automatically receive data from an electronic client data record, such as data concerning services provided or diagnosis codes selected by the user. Normally, systems require entry directly into the billing software, but the billing functionality of this office management system preferably allows dual entry from a one time entry, which serves at least three areas of any business or clinic. For example, the business representative can create a note by selecting services or diagnosis codes within the system, which can result in meeting the needs of the clinical documentation. In addition, the billing functionality of this system can transmit information related to what is owed on the account for services that day to the front desk or checkout area. Further, the billing department of the business can receive the same service or diagnosis code information automatically into the billing system. This saves the business significant time by eliminating the need for double entry of duplicative data. FIG. 6 and Section H.2 below describe one embodiment of the overall office management system.

The system would preferably be able to receive faxes from other businesses, automatically ascertain which faxes are relevant to the business, transfer the relevant faxes to the desired recipients and send a fax back to the sender of faxes that are determined to be unsolicited marketing, promotional or otherwise undesirable faxes demanding that the business' fax number be removed from the sender's list of fax numbers. As explained above, the system preferably can temporarily store incoming faxes in a virtual document storage system until either the system automatically or a business representative manually reviews the fax and determines whether it is desirable to input it into the virtual document storage system. For example, the system could detect the outside source of the sender of a faxed document by examining the fax number to determine whether it is one recognized by the business or system. The initial setup of the system could be programmed such that when a outside fax document is received by the system, the user could enter in the fax name, number, address, and contact individuals within the organization. As a result, the sender of the fax could then be recognized on any future receipt of a fax. This allows for a faster filing of the document in the system since these pieces of information would automatically be filled out on the filing screen. For example, the date received could automatically be completed. In a preferred embodiment of this aspect of the invention, only the date the document was created and the client name would need to be manually entered upon filing the document. If the received document was classified as part of a specific subcategory, then the user would have to select from a drop-down list box as to which category the file needs to be stored. Ideally, it would take less than five seconds to file a document received from one entity.

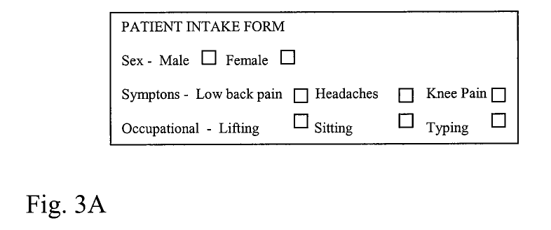

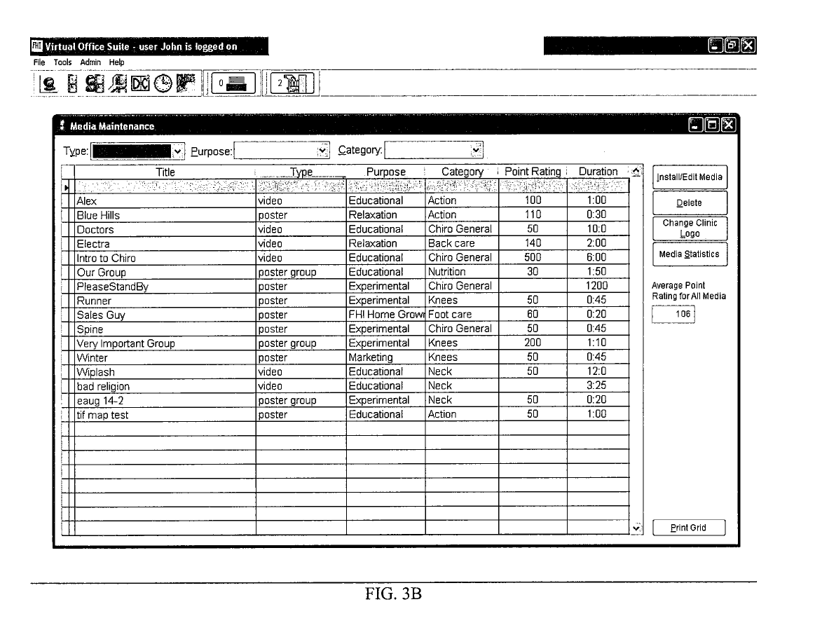

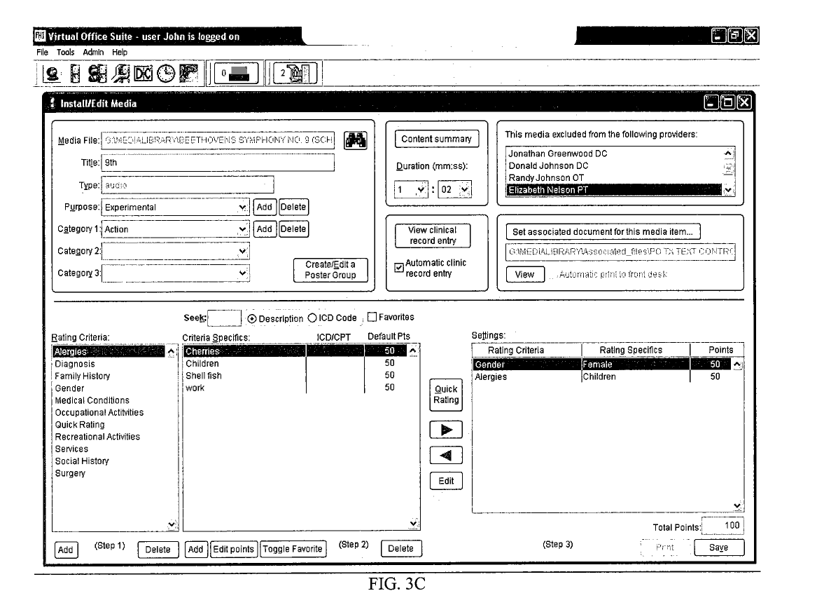

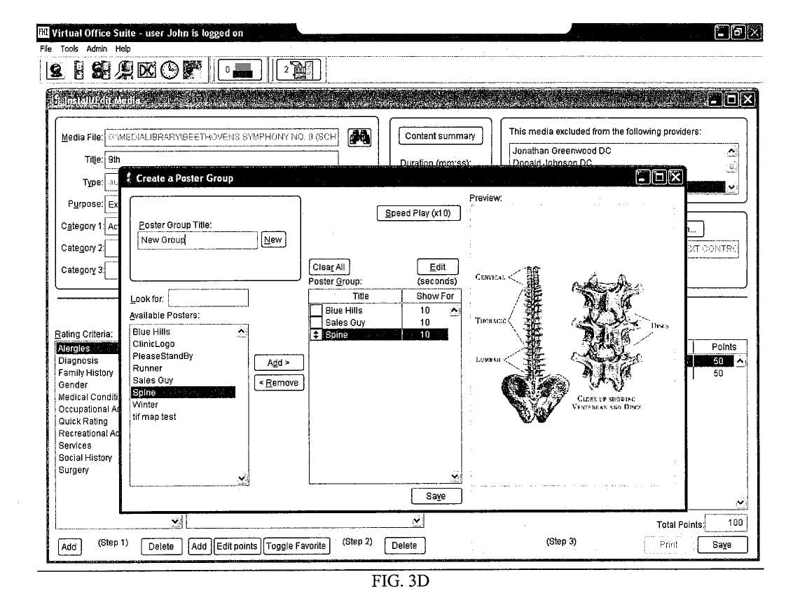

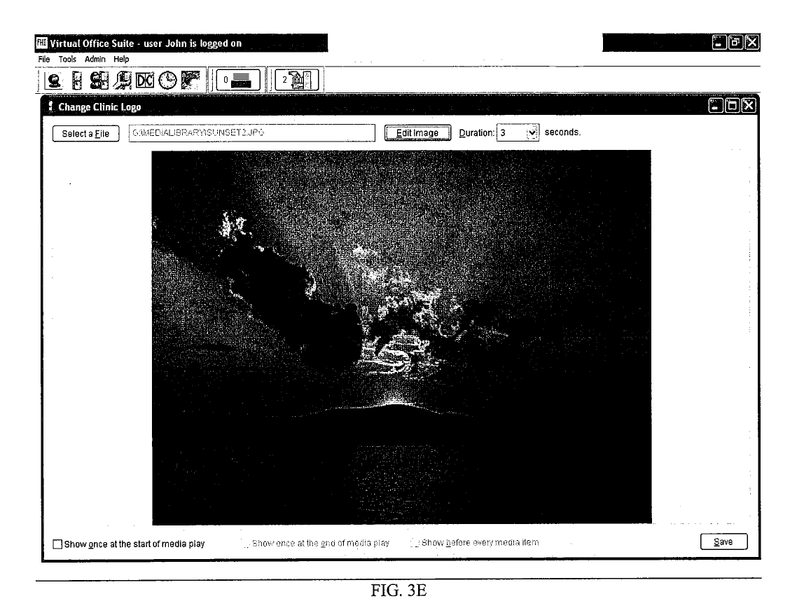

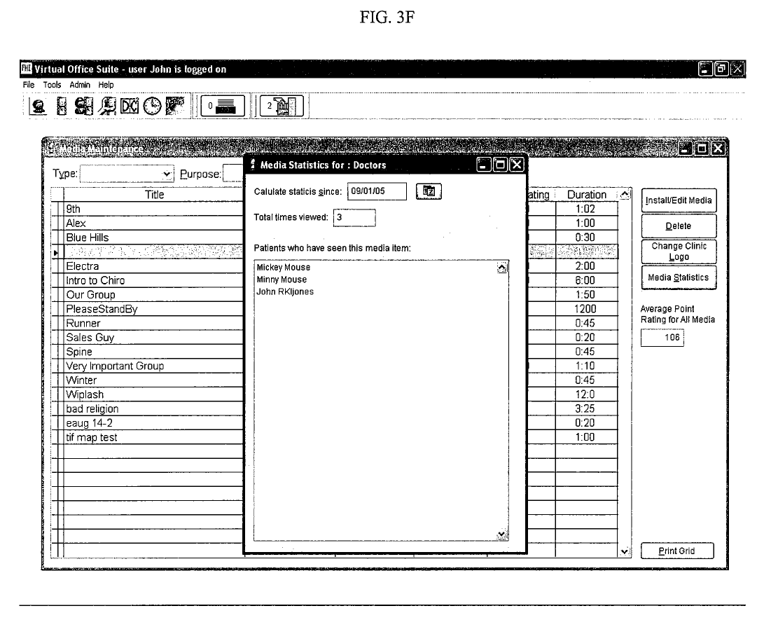

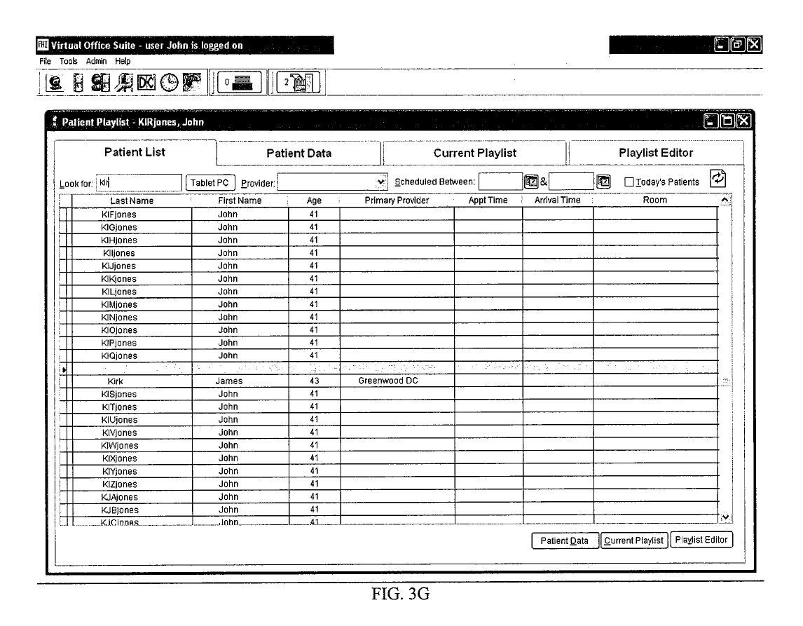

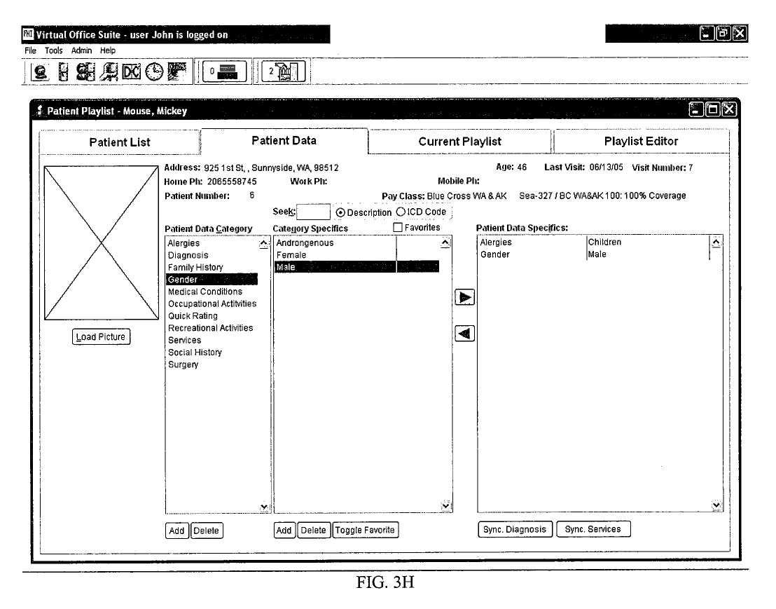

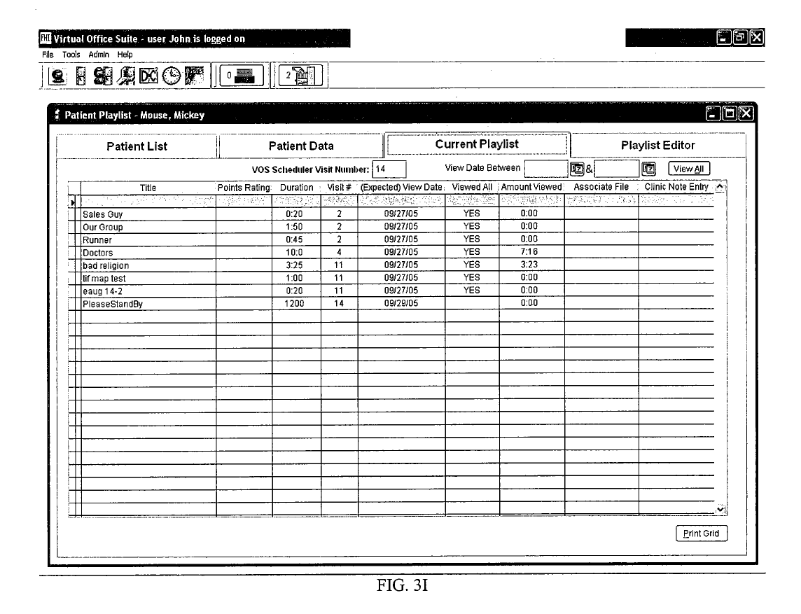

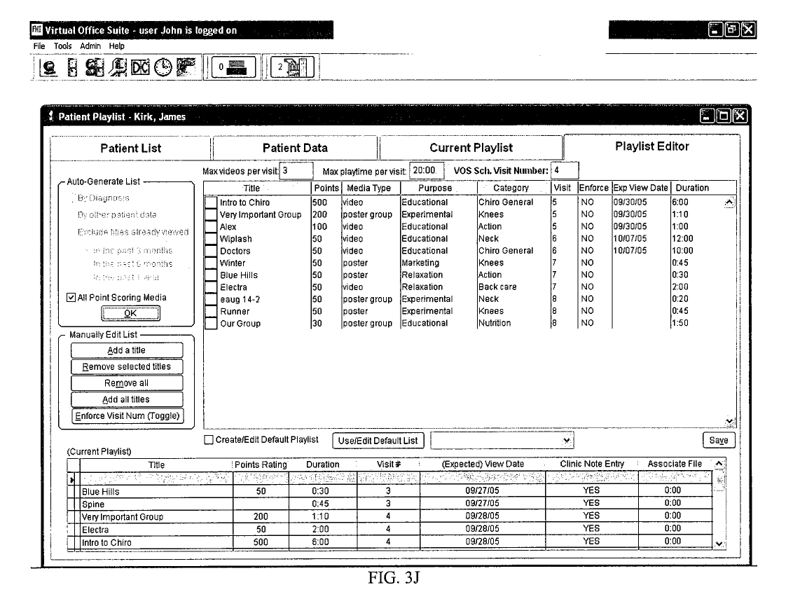

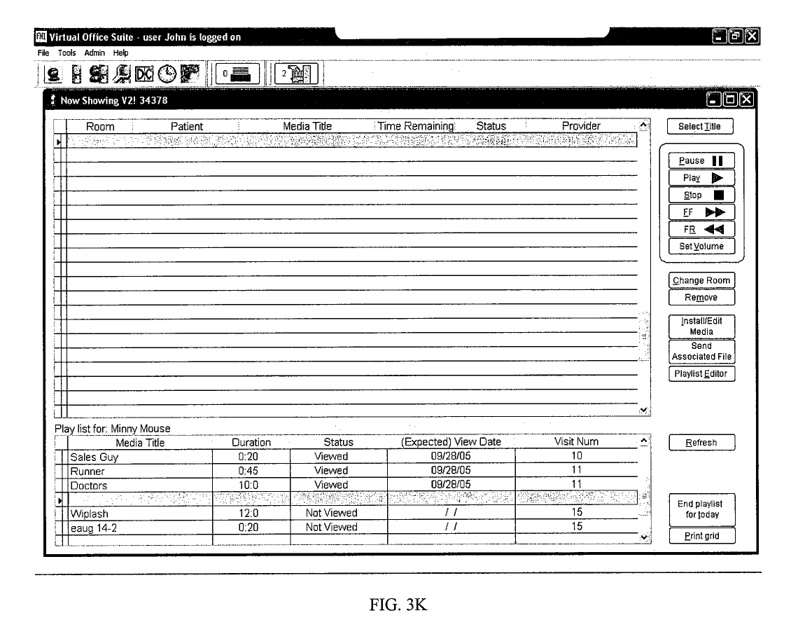

In addition, the office management system would preferably have a graphical user interface (GUI). This GUI will preferably be easy to use and organize the different functions performed by the system in such a way that a user can easily peruse through the system. An example of one preferred GUI is depicted in the screen shots in FIGS. 3A-K, 5A-N, 7, and 10A-O, and discussed in Sections H.1, H.2, and H.3 below.

Further, the office management system would preferably be able to allow all of the features described herein to communicate and share software and data efficiently and effectively with each. Preferably, each feature described herein would have access to the software and/or data generated or stored by the other features and be able to access that data without significant delays. While those of ordinary skill in the art would be able to implement numerous different information technology designs which will accomplish these goals, a preferred hardware layout is set forth below.

In addition, the office management system preferably has a dashboard documentation control center feature. For example, in a medical office embodiment of the office management system, the dashboard documentation control center can be software that is used to generate a daily clinical note. This note can interface with an item from the collection or library described in more detail below and an associated file, or it can allow a user to be able to view other clinic entry components described above. By way of example only, the dashboard documentation control center can have an automatic clinic entry icon or screen. If the user selects the automatic clinic entry icon or screen when a patient is viewing an item from the collection or library, then a paragraph summary of the item is automatically entered into the patient's daily record on the day that they reviewed the item. For liability purposes, this feature can be valuable because it documents what was viewed with the patient and the material contained, such that a clinic could prove that a patient watched an item including information relevant to a certain condition or treatment in dispute in a malpractice or other liability dispute. The dashboard documentation control center could both put a summary into the patient record and print off an associated file at the front desk wherein the associated file has a much higher detailed summary of the information conveyed in the item viewed by the patient. The associated file could be intended to be given to the patient as a take home handout.

The dashboard documentation control center could also interface with the scheduling system described above. For example, the center could include a feature that allows a business representative to view a list of all of that business representative's clients scheduled for that day. If the clinical note was not completed during the patient encounter, a special list of unfinished daily records is available on the screen for that specific doctor so the doctor can quickly click the name of the patient and complete the records that have been unfinished.

The dashboard documentation control center can includes a range star feature in a medical office embodiment. This feature applies to the range of motion of a joint and the planes of the range of that joint. There are several range stars since the elbow joint moves differently than the lumbar spine. The range star feature can enter the specific degree of the range from a spinner bar at the end of each point/stick of the star. The feature can also allow the user to enter a description of the range by selecting a box on the plane/stick. The feature can have six boxes that can be checked on each stick of the range star. For example, each stick can represent a plane of motion such as right lateral flexion, flexion, extension, left lateral flexion, right rotation and left rotation for 6 planes or 6 sticks of the range star for cervical spine range of motion. The elbow would only have 4 sticks representing the 4 planes of range of motion for that joint: pronation, supination, flexion and extension. Of the 8 boxes on the stick plane for each plane of range of motion the closest box to the center of the range star represents “normal,” the next box is “mild,” followed by “mild to moderate,” “moderate,” “moderate to severe,” and “severe.”

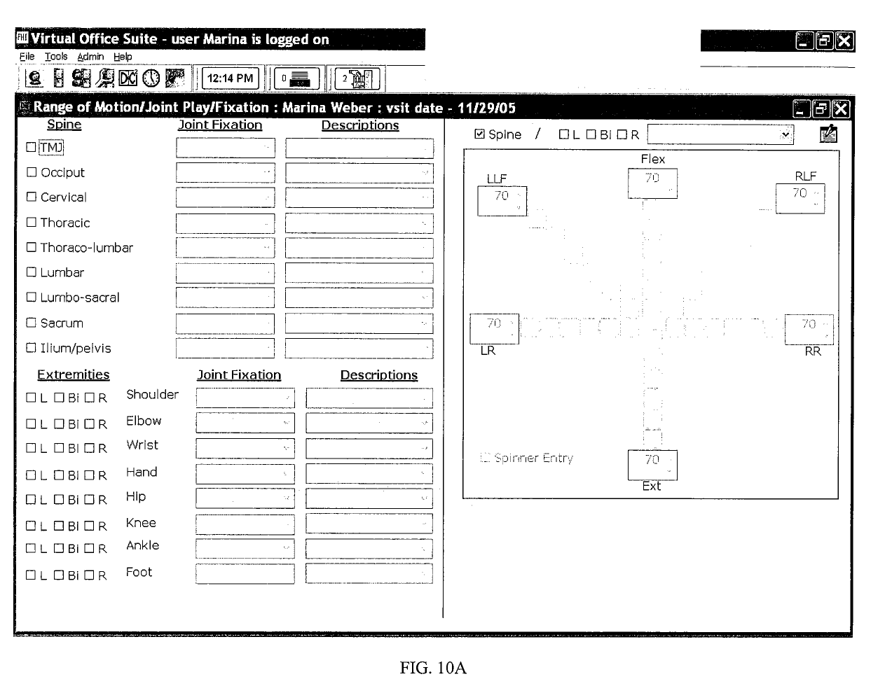

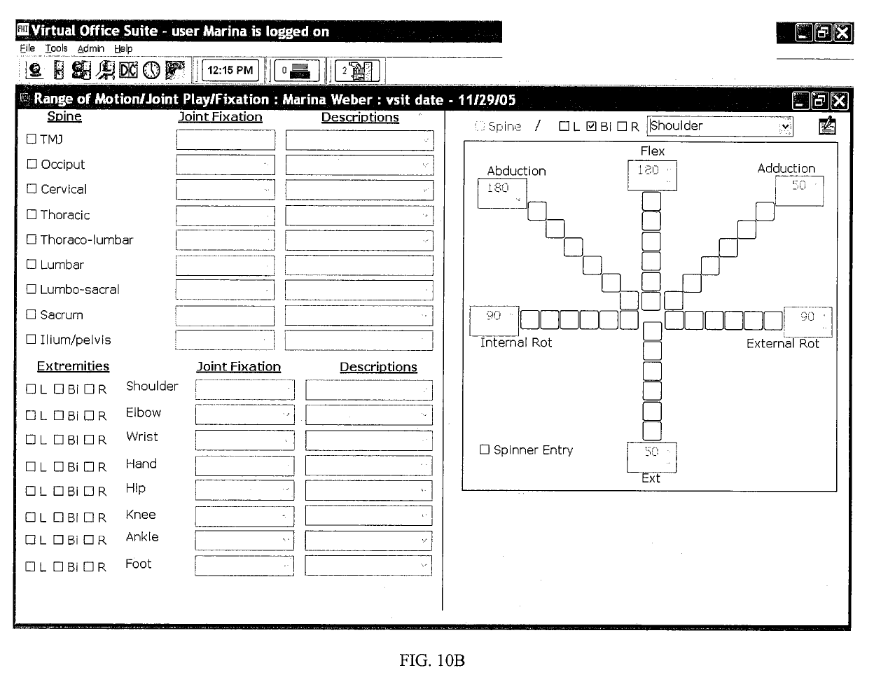

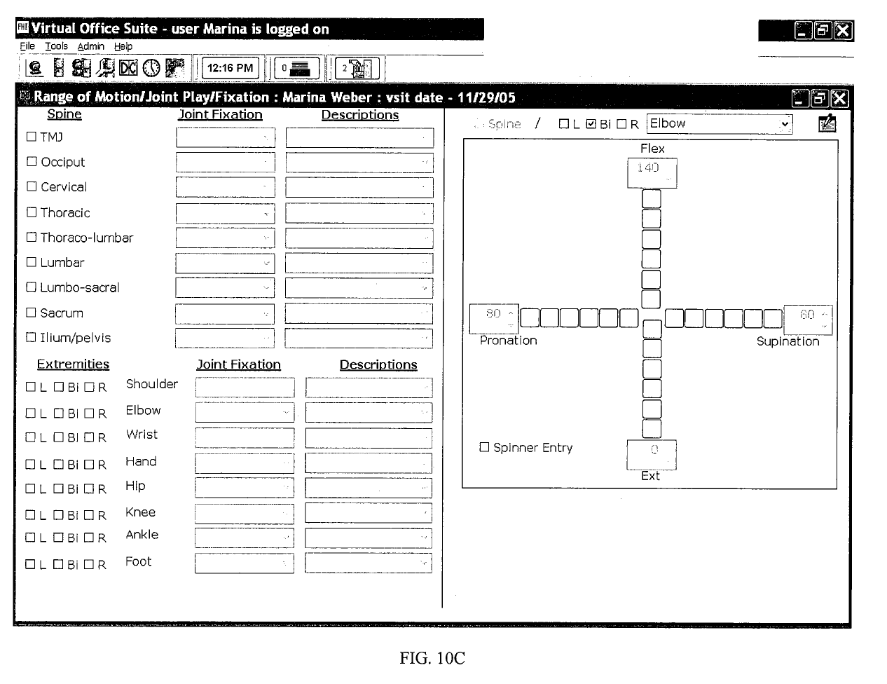

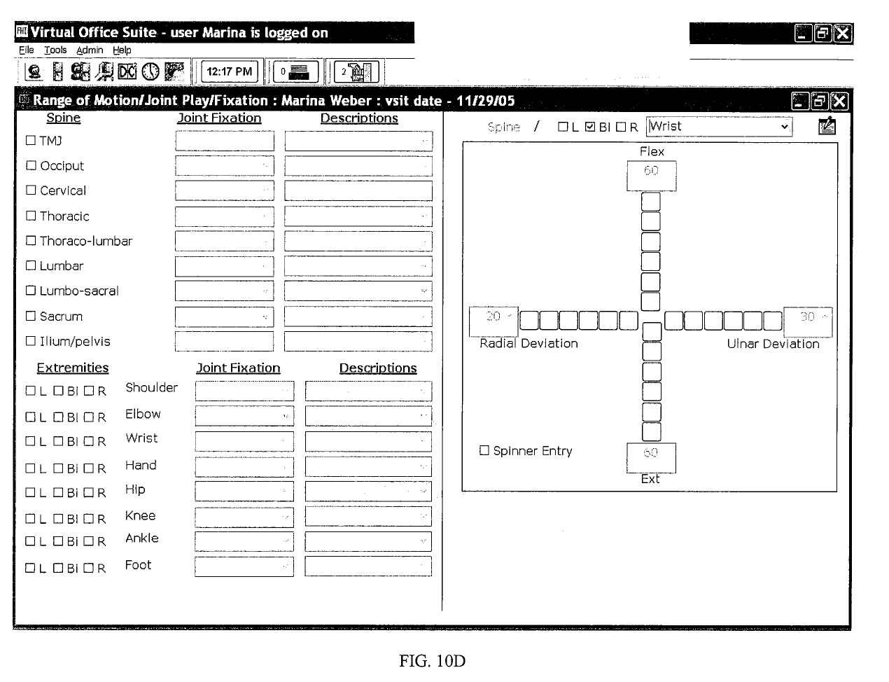

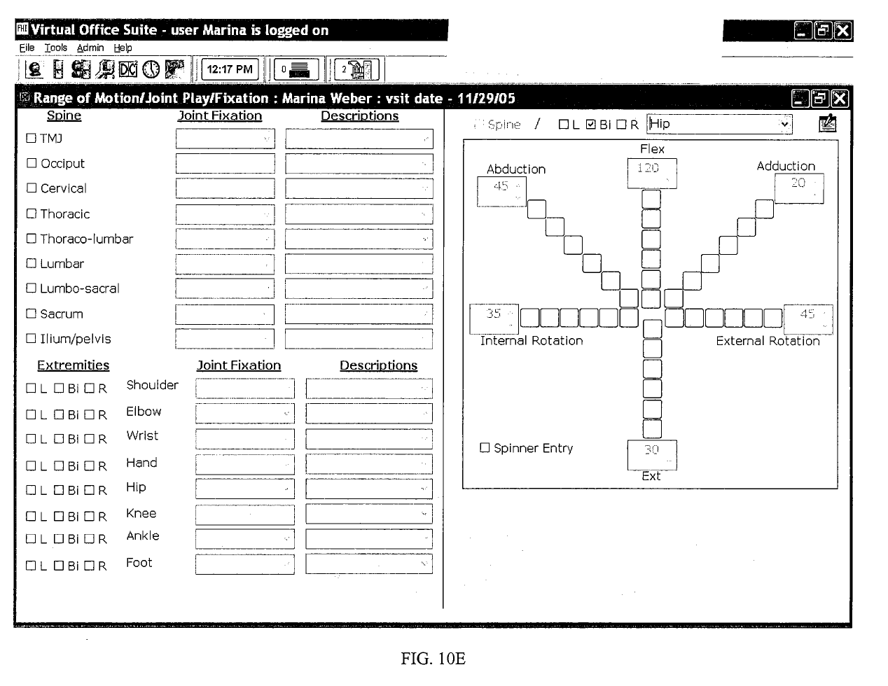

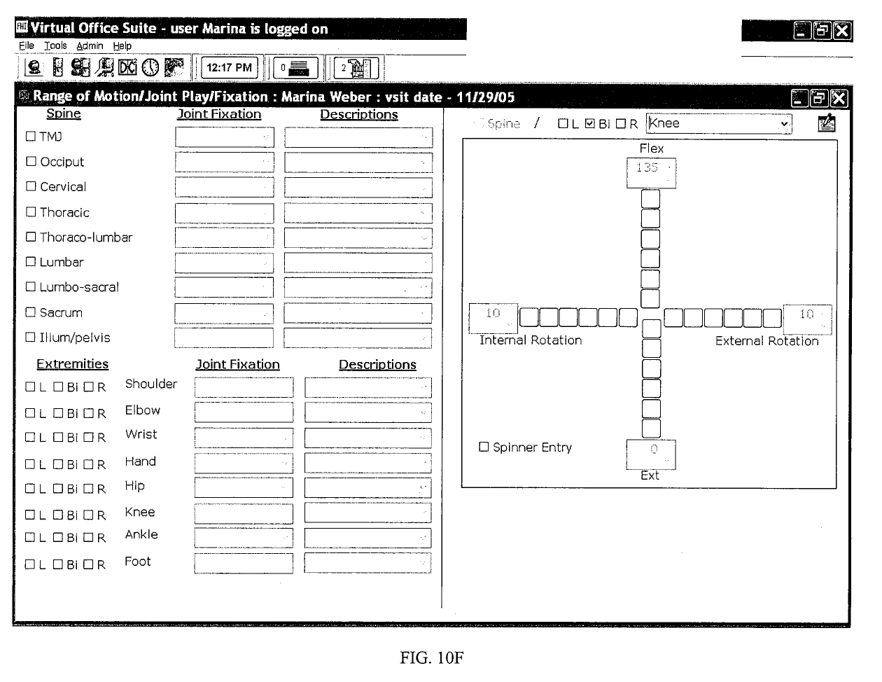

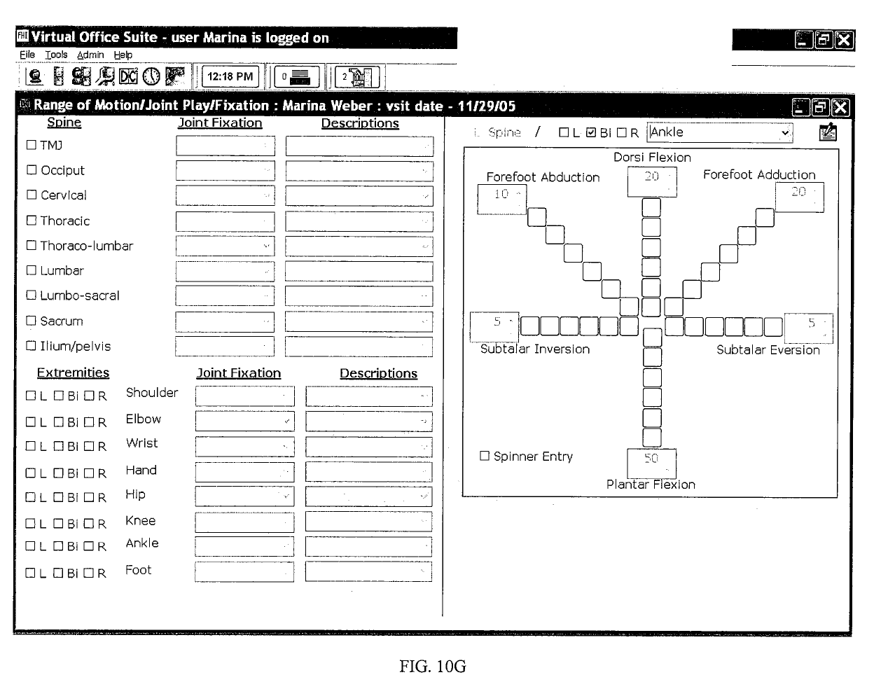

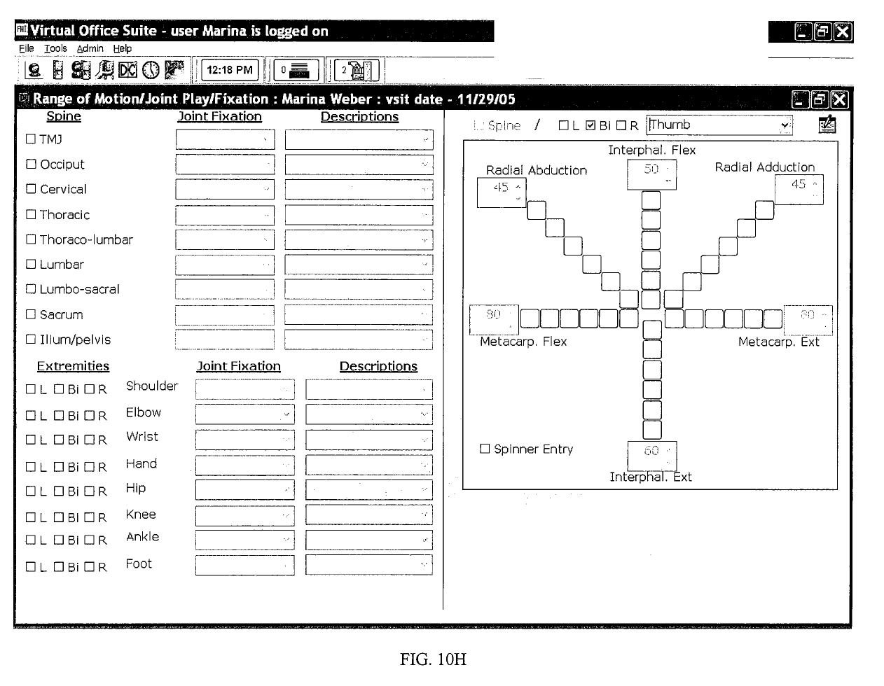

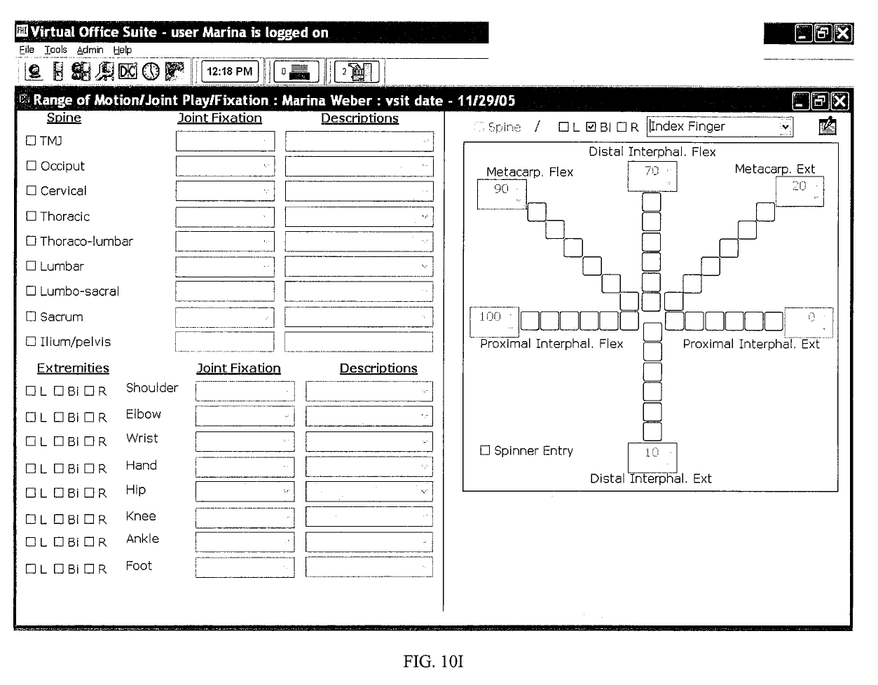

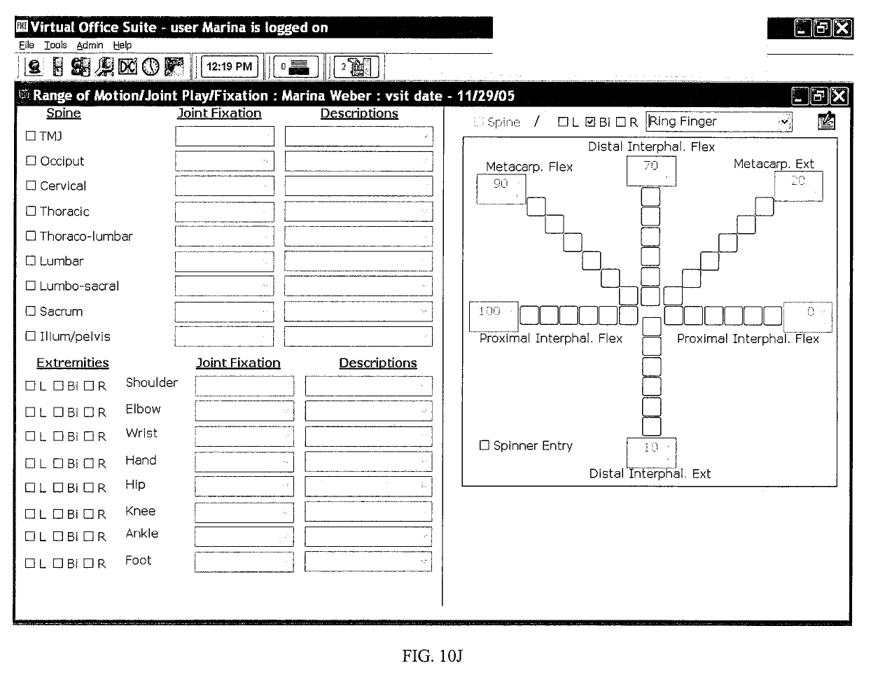

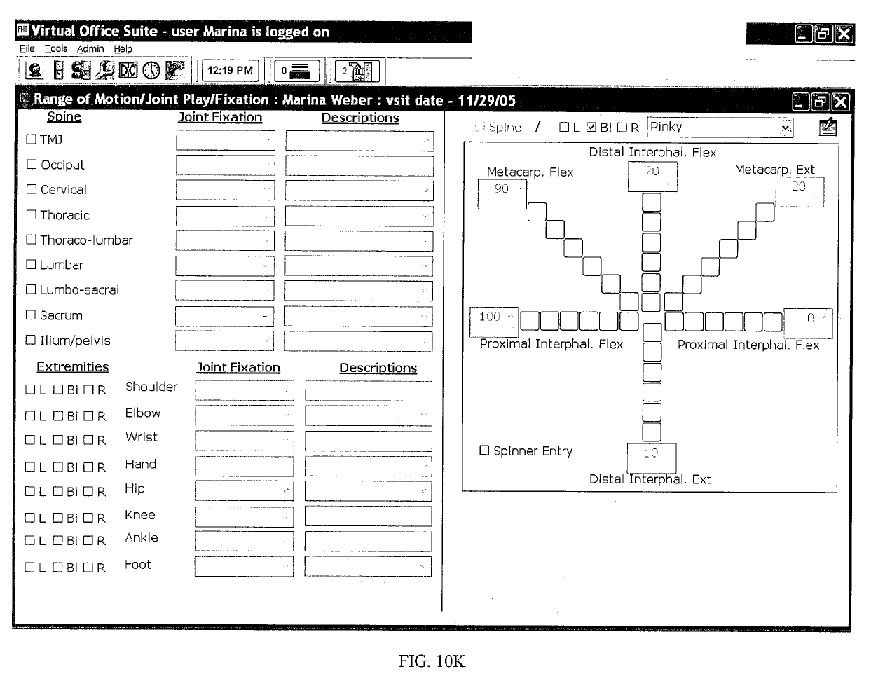

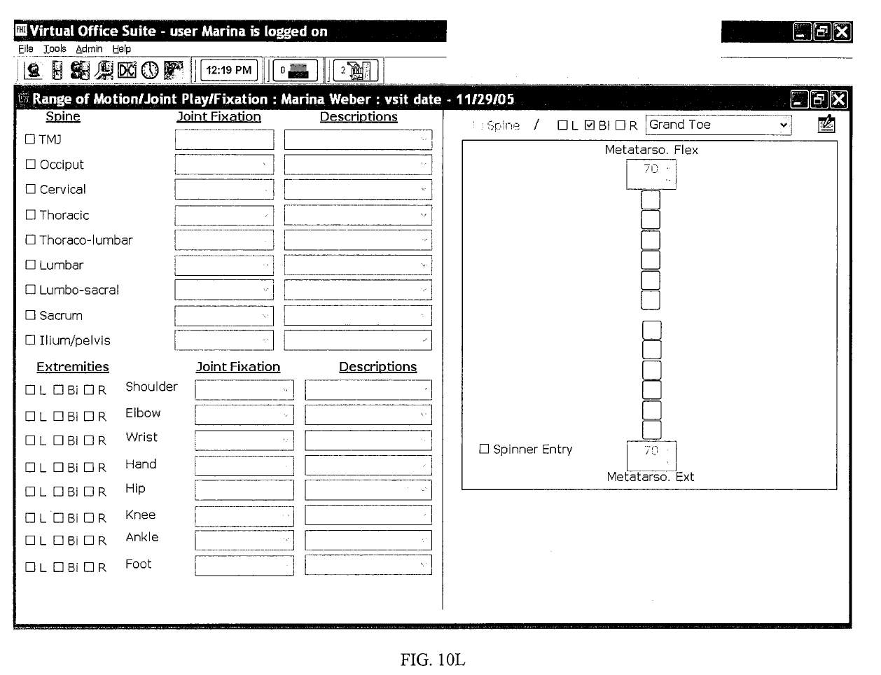

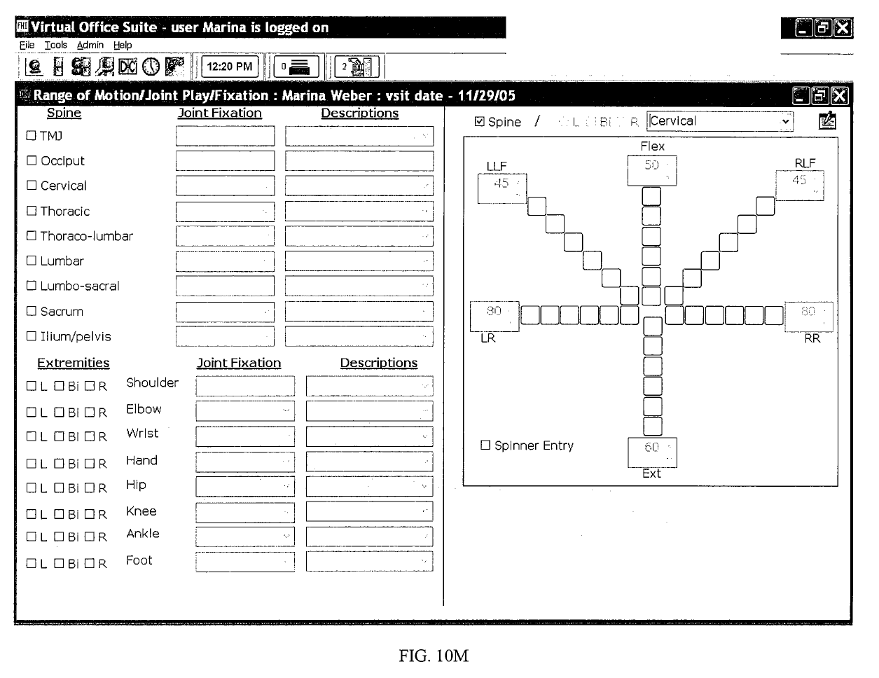

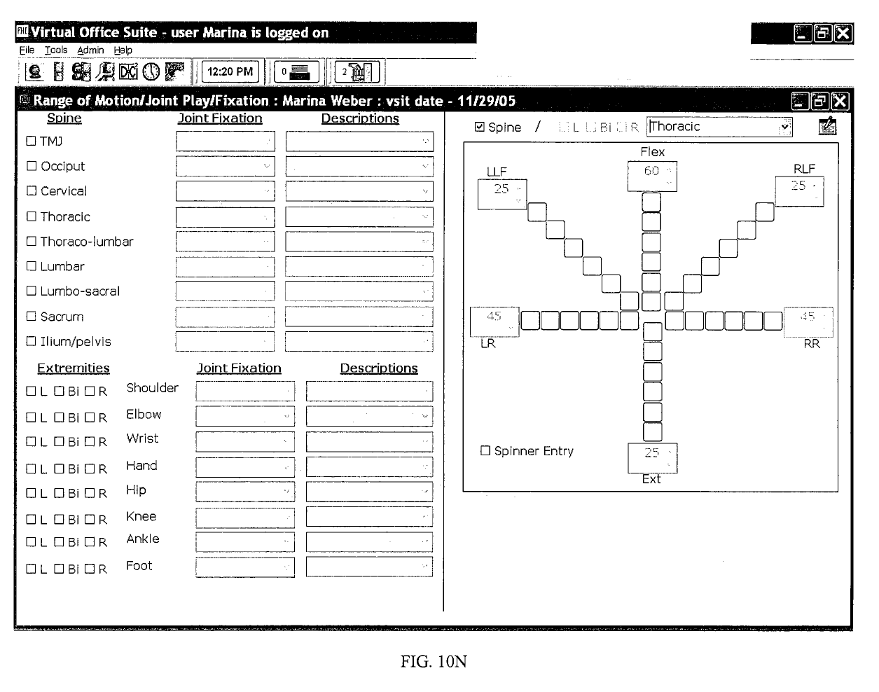

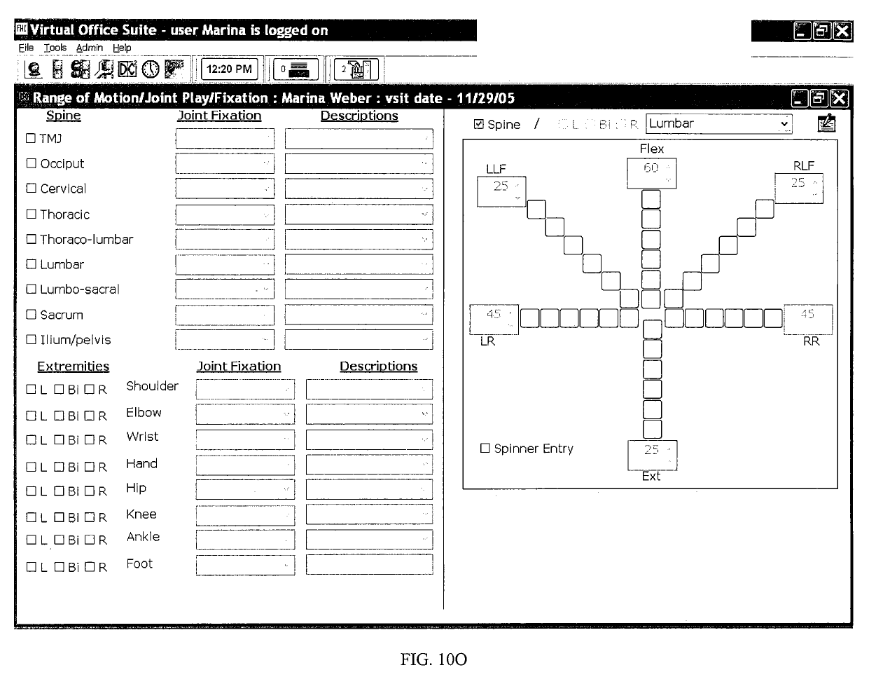

When the user selects one of these methods, either the spinner bar entry to give a specific numerical figure by degrees, or a description of the range of motion, the selection can be entered in a sentence format into the daily clinical record in the patient chart under the category: Objective clinical findings, range of motion. Examples of some of the screens in this range star feature are set forth in FIGS. 10A-O.

Another possible feature of the dashboard documentation control center is the treatment and diagnosis screen. This screen has a unique feature to document the location of where therapy modalities have been placed on the human body. This screen allows the user to select a specific therapy modality such as ultrasound by clicking a button. Once this button is clicked by the user, the user then drags an icon, such as a blue circle, to a body diagram on this screen and clicks the portion of the body that the ultrasound was performed. This allows for a visual feature to know what surface area on the body the ultrasound was performed if the surface area on the body is larger than the size of the blue circle, the user can click multiple areas of the surface to do note multiple blue circles to demonstrate the entire area of the body that had the ultrasound performed. There are separate icons for electric muscle stimulation, phonophoresis, iontophoresis, myofascial release therapy, trigger point therapy, and laser light therapy. Multiple therapies can be documented on the same body diagram. This body diagram can be printed in the clinical note to demonstrate two third parties where the therapy was applied. It also helps the doctor communicate to the staff exactly where to place the therapy if there is a therapy assistant. The doctor no longer needs to verbally communicate with staff that maybe in another area of the building they can simply review on the body diagram exactly where to place the therapy. In addition there is any written component created also explaining where the therapy was located. Certain parameters such as the length of time and any machine settings for a therapy are also available to the doctor to fill in on a preset window for each modality. This information is then transmitted along with the body diagram to the appropriate therapy assistants.

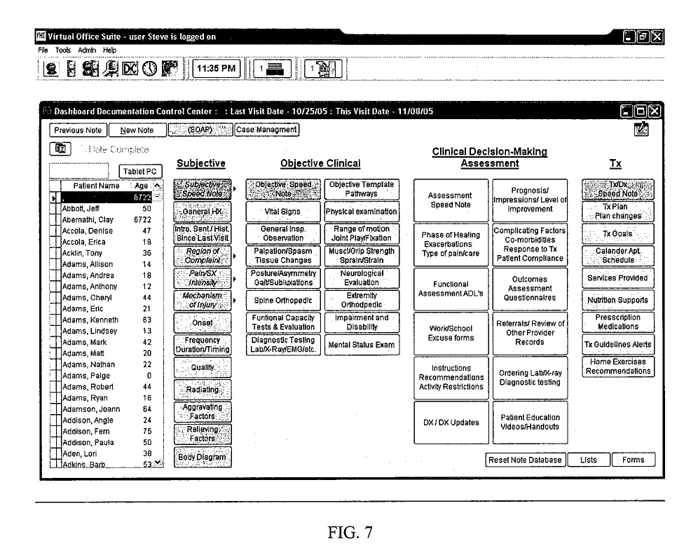

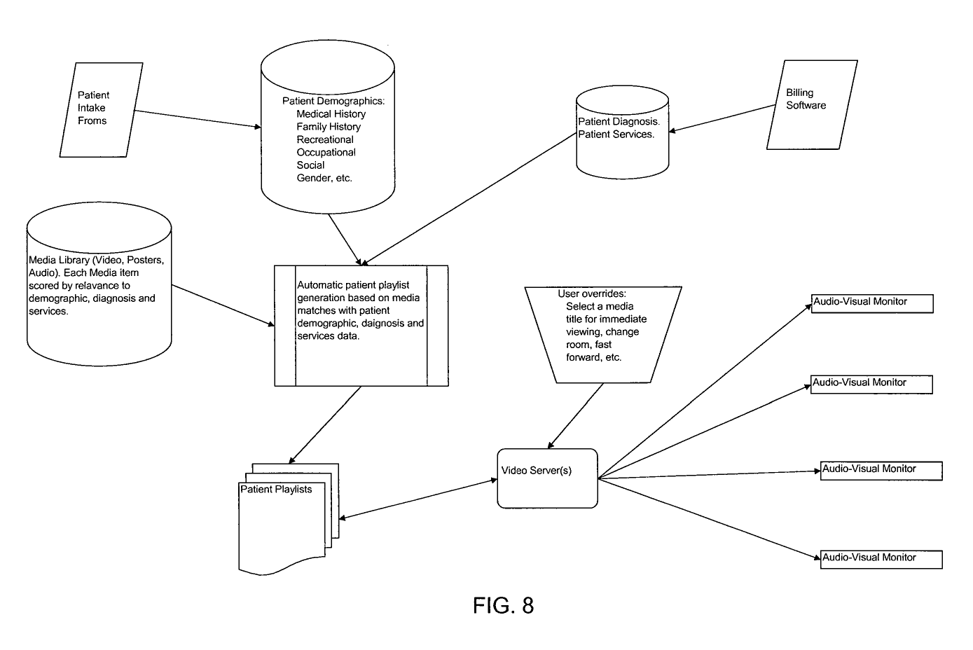

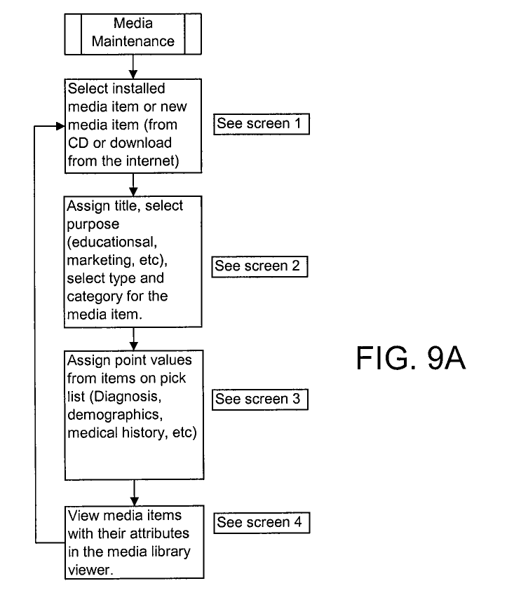

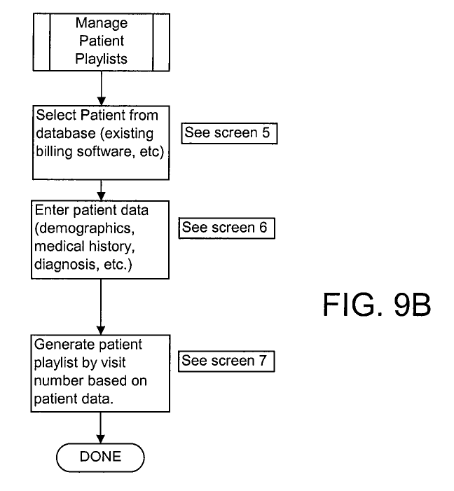

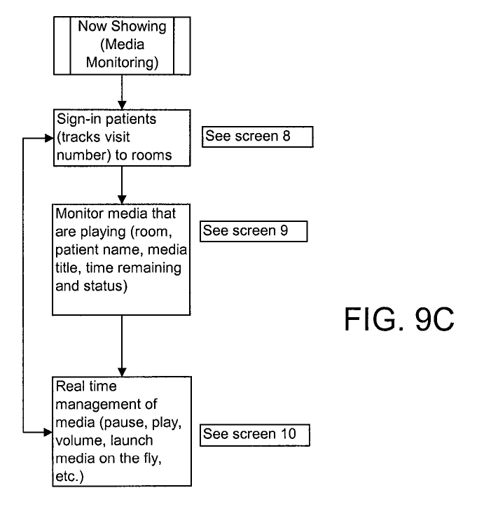

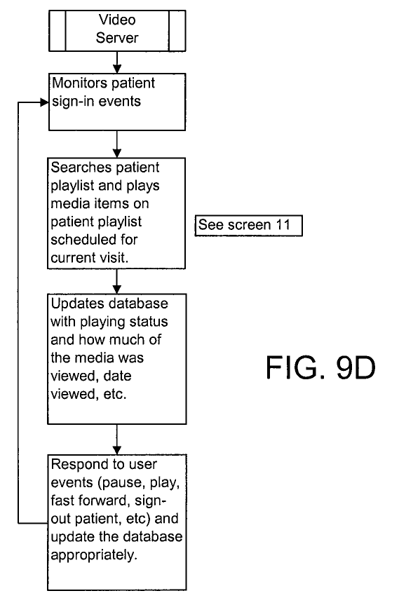

Further, the dashboard documentation control center can be designed such that all of the different features can be accessed from a main screen or page and the main screen or page can be accessed from any of the screens or pages in the dashboard documentation control center. As a result, the user can easily switch back-and-forth to different functions of the dashboard documentation control center simply by toggling between the screens or pages created for those functions and the main screen or page. Examples of some of the screens in this dashboard documentation control center are found in FIGS. 7 and 10A-O.

For example, the following describes some aspects of the system. The software will access and maintain a database of patient data (diagnosis, demographics, medical history, etc). Media such as videos, posters and audio files will be stored on pcs connected to the network with monitors in the various rooms (exam rooms, treatment rooms, etc). When the media items are installed in the system, they are assigned point values for the various demographics, diagnosis or medical conditions based on the content of the media item and its relevance to a particular demographic, diagnosis, etc. Patient playlist are then automatically generated and saved in the database based on the point value of the media items that have been installed (most relevant at the top of their playlist). When the patients arrive for their visit, they are logged into the system and the next items on their playlist are shown to them automatically in the room that that are assigned to. The program keeps track of what they viewed or how much of a media item they viewed if the viewing was interrupted. All the media that are being played in the office (with the patient name, room name, view time remaining, etc) can be monitored from tablet pc with a wireless connection to the central network. The user is able to sign-in/sign-out patients, bring up specific media for patients on the fly, adjust volume for any room and in general control all the monitors and playlist from the tablet pc.

B. Office Management System Hardware Layout

Infinite different hardware layouts can be used to implement the office management system of this aspect of the invention. For example, server technology is one of many possible technologies that could be used to manage the overall office management system. However, one of ordinary skill in the art would understand how to implement the office management system using other technologies, such as various different mainframe design technologies. In addition, multiple different types of devices could be used by the business employees to access the data stored in and the software managed and run by the office management system. For example, desktop, laptop, and tablet personal computers (“PCs”) could be used. However, other hand held devices, such as PDAs, wireless remote email devices and more sophisticated cell phones are just a few additional examples of hardware business employees could use to access the office management system's data and software.

Further, while the office management system can be linked to the Internet so that certain business employees can access the system's data and/or software from locations remote from the business' premises, such would likely increase the overall expense by likely requiring at least an additional level of security (such a firewall and related security protocols). Thus, Internet access is not a requirement of the office management system. In addition, while state of the art multimedia equipment (such as high quality surround sound equipment and flat-screen monitors) would be ideal for providing the optimal viewing experience for clients, such again would increase the overall expense of and is not necessary for implementing the office management system. Similarly, while a wireless network would minimize the number of visible cords in the office and/or the amount of reconfiguration of the structure of the office to conceal the cords, a wireless implementation is more expensive and not critical to the invention.

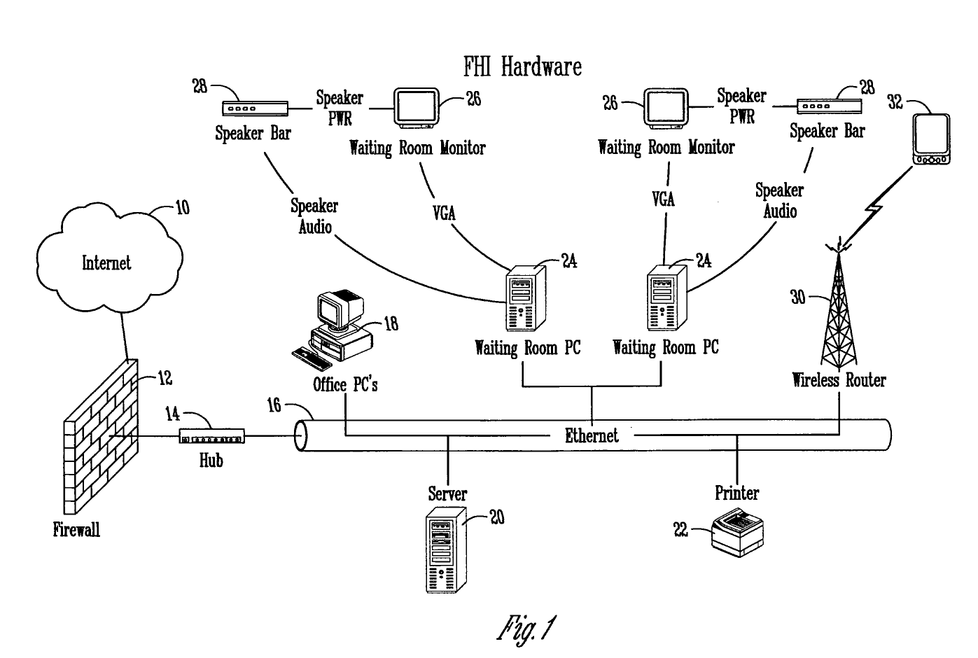

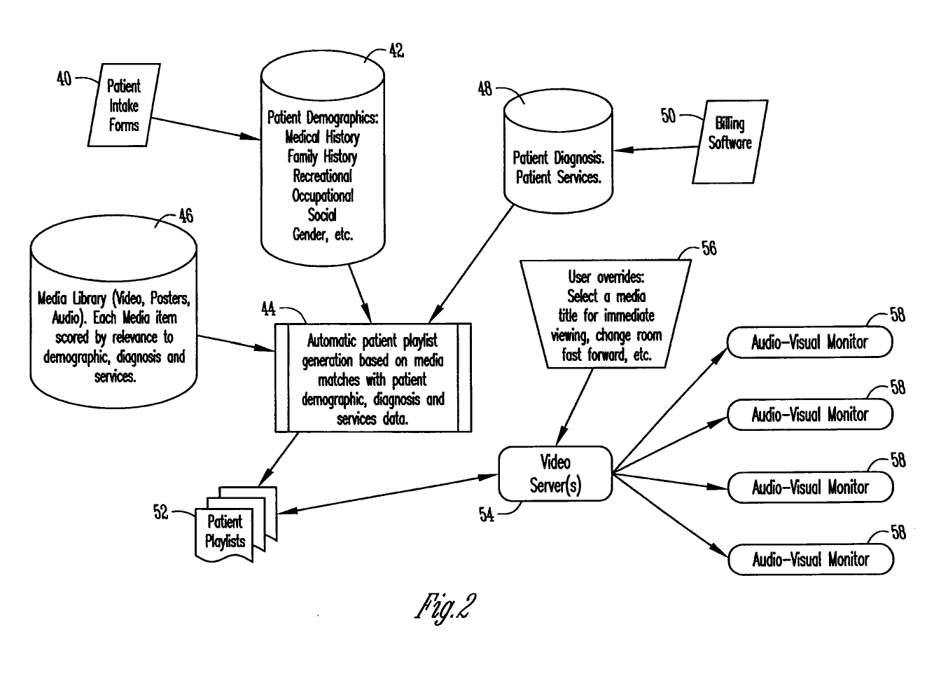

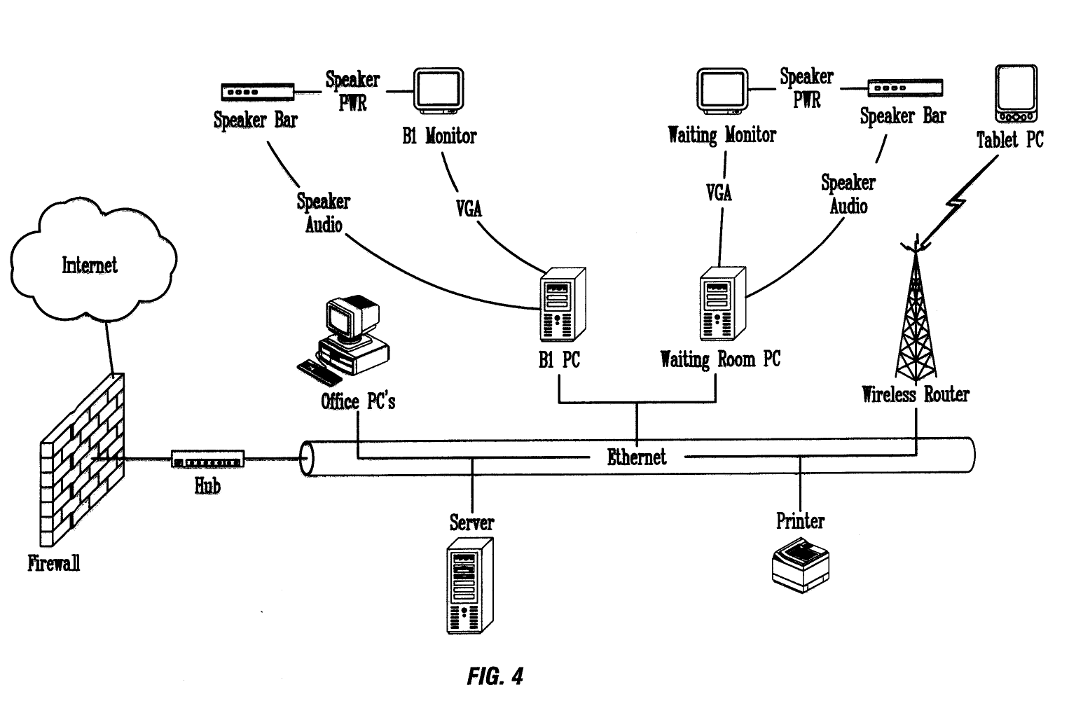

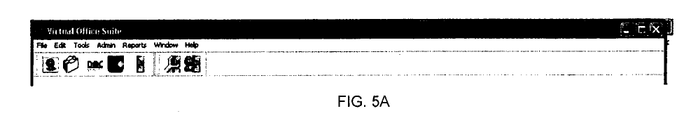

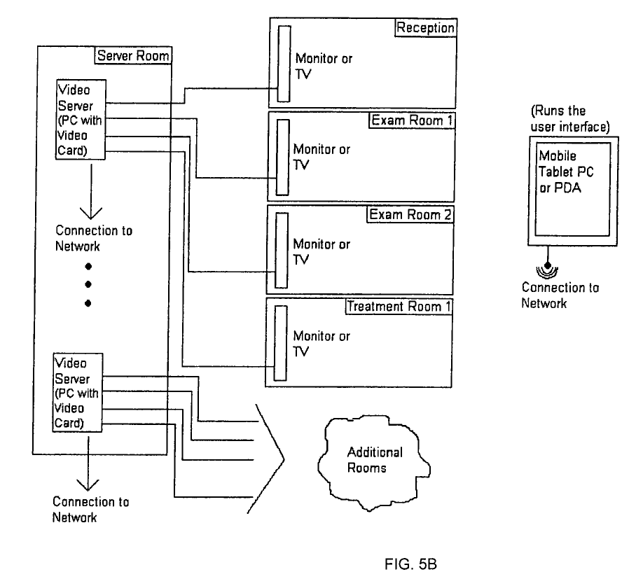

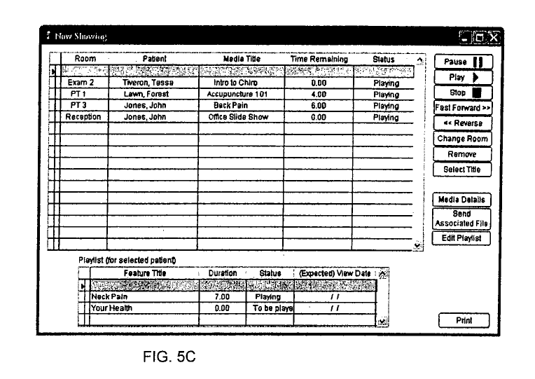

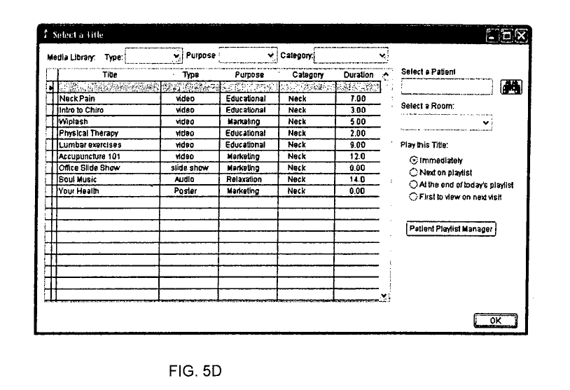

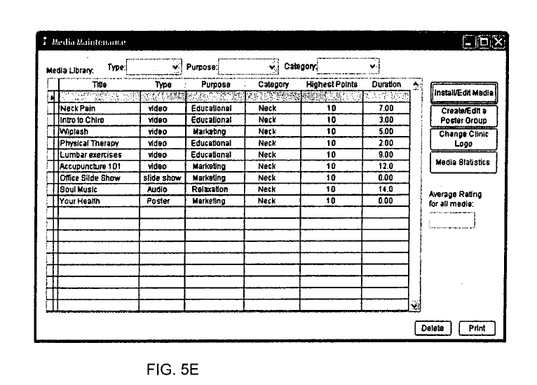

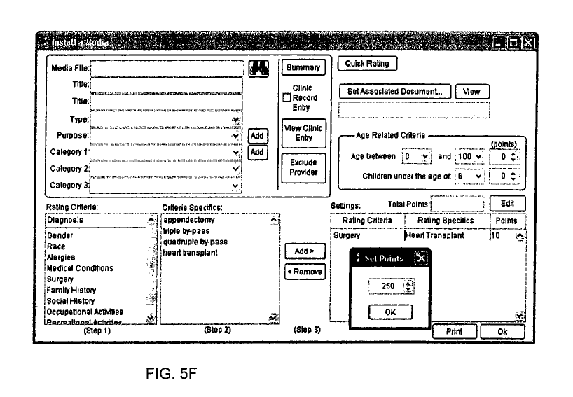

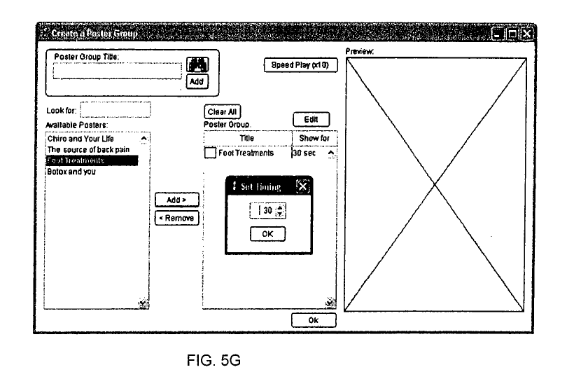

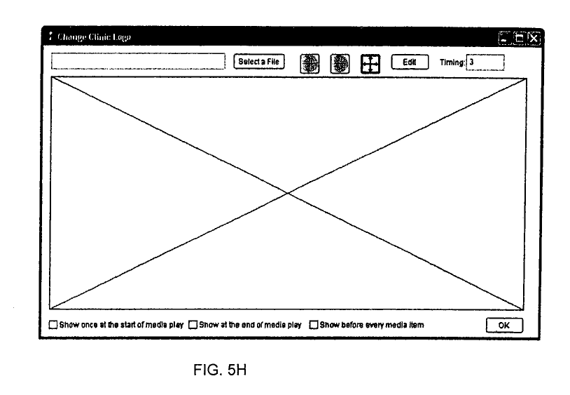

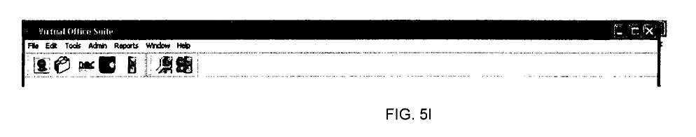

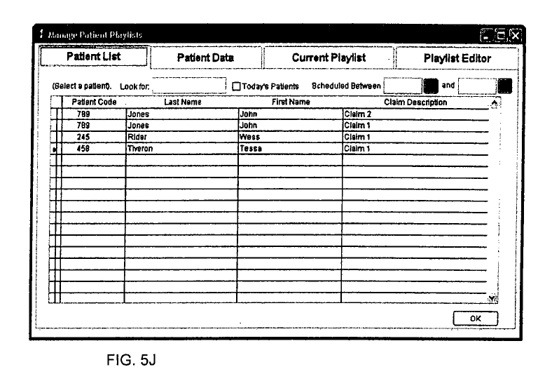

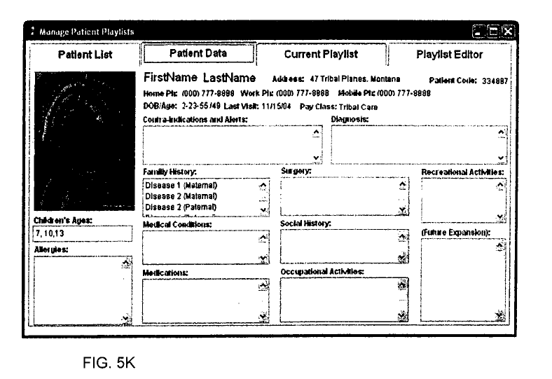

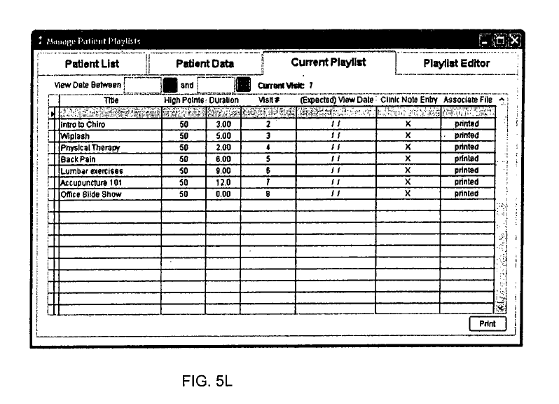

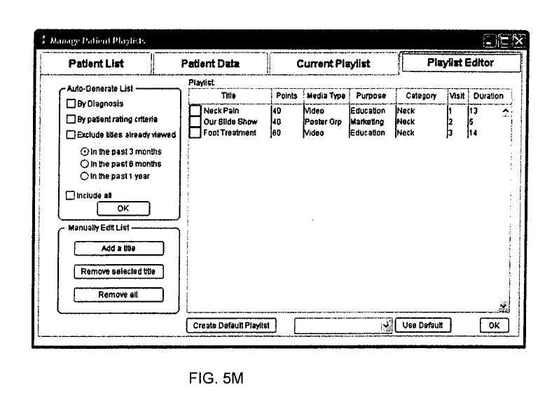

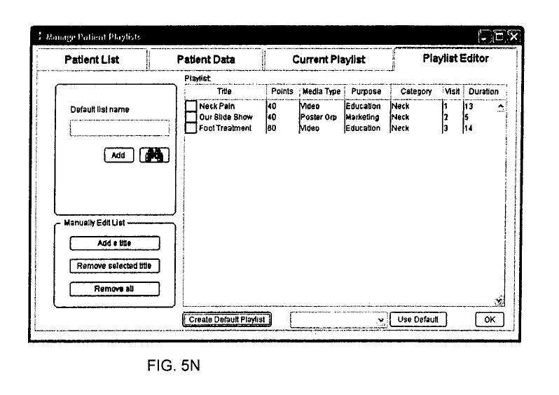

FIGS. 1 and 4 depict the hardware layout according to a preferred embodiment of the office management system. According to this embodiment, the office management system would be connected to the Internet 10 via means well-known in the art. To increase the level of security in light of the Internet connectivity, this preferred hardware layout would include a firewall 12 and other security protocols which are well-known in the art and widely available in the industry. The firewall 12 is connected to a hub 14 that is connected to an Ethernet or other network 16 or other connection on which the core features of the office management system are run. For example, servers 20, office PCs 18, printers 22, wireless routers 30 and waiting room PCs 24 can all be connected to the Ethernet connection 16. This preferred embodiment of the office management system includes software to run the different functionalities of the system and database technology to store the data utilized by the software. This preferred embodiment of the office management system also includes other technology on which the educational, marketing and other business information and materials can be run and through which employees of the business can access the office management system's data and software.

For example, in this preferred embodiment of the office management system, office PCs 18 can be used by employees to run scheduling and billing tasks, tablet PCs 32 connected to the server via wireless routers 30 can be used by other business employees to ascertain information relevant to performing certain core business duties (i.e., in a medical office a doctor may desire to use the tablet PC 32 to review a patient's medical chart, to enter soap notes during or after consulting with the patient, etc. . . .) and waiting room PCs 24 can be used to load and run educational, marketing and/or other business-related information and/or materials while the client is in a waiting room. The waiting room PCs 24 can be connected to speaker bars 28 in the waiting room via speaker wire or other well-known audio or audio-visual connections, and the waiting room PCs 24 can be connected to flat-screen, touch screen monitors 26 via VGA or other well-known audio/visual connections. The servers preferably manage the office management system software and database technology and communicate with the other devices through the Ethernet connection.

C. Client Educational, Marketing, Promotional and Other Information System

According to another aspect of the invention, a method of and system for automatically selecting which of a selection of educational, marketing and other business-related information and other materials to provide to a client in the business' offices while the client is waiting to see a business representative based on parameters set by the business. This automatic selection method and system can either be a standalone system or be part of or connected or interoperable with other office management systems. The automatic selection method and system preferably includes or is linked, connected or at least interoperable with a virtual document storage system, such as the one as described above, which stores the selection of educational, marketing and other business-related information and other materials. As described in more detail below, the items in the virtual document storage system would preferably be ranked or valued according to certain selection criteria which can either be customized by the business or predetermined (i.e., by the use of default values already in the system). The automatic selection method and system also preferably includes or is linked, connected or at least interoperable with other office management systems, software and/or data, such as that for client recordkeeping, billing, scheduling and other core business functions. Preferably, the automatic selection method and system can access information and/or data stored about the client and the business in the office management system(s), compare it with the items in the virtual document storage system (and the items rankings, valuations and/or selection criteria) and create a prioritized playlist that is specifically targeted for the client based on the information stored about the client and the business and the rankings, valuations, selection criteria and other information stored about the items in the virtual document storage system.

The automatic selection method and system could then allow one or more business representatives to override the playlist by changing the items in the playlist or the order of those items. The automatic selection method and system preferably would then cause the first item on the playlists to automatically be displayed in the room where the client is located. Preferably, the client would not have to wait more than 30-60 seconds in a room before the first item would be displayed. Normally, the system does not display the actual playlist itself to the client. However, the system could do so and allow the client to choose certain items from the playlist, but the business may want to automatically cause certain marketing or promotional items to be displayed at given intervals even if the client is allowed to choose the order of display from the playlist.

The automatic selection method and system preferably would also have the ability to automatically place certain information into the client's record after the client has viewed some or all of the items. The automatic selection method and system also would preferably automatically send a message to one or more business representatives if no items are generated by or remain on the playlist for a given client while the client is waiting to see a business representative.

In addition, the automatic selection method and system preferably has a graphical (GUI), which preferably will be easy to use and peruse through the system. An example of one preferred GUI is depicted in the screen shots in FIGS. 3A-K and 5A-N, and discussed in Sections H.1 and H.3 below.

The automatic selection method and system will have multiple options that help it be optimally used by business representatives and/or clients. For example, the system can have icons and/or screens that can be used to inform business representatives what items are being viewed by what clients in which rooms and how much time is remaining on that item. Similarly, it can have icons and/or screens that can show the playlist for individual clients and icons and screens for fast forwarding and/or rewinding through certain parts of certain items. It can also have icons and/or screens allowing a business representative to move a client and that client's playlist to another room. It can also have the capability to manually or automatically print, e-mail, fax or otherwise provide to the client materials related or associated with one or more of the items viewed by the client. The automatic selection method and system can also have screens and/or items that allow a user to view the items in the collection or library and to group them by different fields. For example, the system preferably provides the information stored about the items in the collection or library in a table format, and a user preferably can click on or otherwise select one of the columns whereby the table will sort the records by the information stored in that column (i.e., all items with the same category will be grouped together if the category column is selected).

FIG. 2 depicts and describes one such preferred embodiment of this aspect of the invention. According to this embodiment, the system has either hard or electronic client or patient intake forms 40 that are filled out by the client or patient or a business employee with the assistance of the client or patient. The system then stores such information (which can include the client or patient's name, address, medical history, family history, recreational interests, occupation, social interests, age, gender, etc. . . .), preferably in a database 42. The business also stores various other types information, media and/or other materials to be shown to the business' clients in a collection or library 44, such as the virtual document storage system described above. This collection or library 44 of items preferably includes videos, posters, audio clips and other media that are specifically designed to educate or inform the business clients effectively, regardless of the clients' individual learning styles or deficiencies. This collection or library 44 preferably can contain at least one hundred video clips of 1-5 minutes in length. Thus, preferably, these materials will be easy-to-understand and in simple English terms (i.e., not full of technical jargon), be explained by people or other entities that do not have unique or difficult to understand accents, dialects, speech impediments or other issues that may make it difficult for some clients to understand them, and will use multiple different types of media (audio, visual, graphical, etc. . . .). Preferably, the business will create selection criteria by which these materials are given a score or value as they relate to the different traits or fields stored in the system (i.e., clients' age, recreational interests, hobbies, occupation, etc. . . .). The system will then automatically generate 46 a playlist based on a comparison of the selection criteria and the items in the collection or library 44. Similarly, the system will have billing software 48 and store both billing information and information related to the business' goods and services used by the client (i.e., in a medical office, software related to patient conditions diagnoses) 50.

Again, all of this information ideally will be stored or linked together, such that the business can easily access such information for running multi-functional tasks. By way of example only, when a client schedules an appointment with the business, the automatic selection method and system would analyze all of the relevant fields of data stored for the client and compare that information up with the scoring or ranking of the items in the collection or library. As a result of this comparison, the system will preferably create a client or patient playlist 52 (which ideally will be a prioritized list of materials that are targeted to the consumers based on the selection criteria). For example, in a medical office embodiment of this aspect of the invention, the automatic selection system and method could prioritize the playlist of media available from the collection or library 44 by comparing selection criteria concerning a patient and/or information related to the items in the collection or library 44.

According to this embodiment, the system will ideally also include one or more video servers 54 (preferably a PC with a video card that is connected to the network), which stores and/or loads the selected materials onto monitors, which preferably are audio-visual monitors 58 as described above. The client or patient playlists 52 are then ideally sent to these video servers 54, at which point a business representative has the opportunity to override 56 the playlist. For example, the business representative could select a different or new item from the library that is particularly relevant to the client in light of new or otherwise not stored information or could delete or fast forward through items on the playlist that may not be as ideal for the client in light of new or otherwise not stored information.

D. Types of Information and Materials to be Shown to Clients

Each particular business can select which types of educational, marketing and other business-related information and/or other materials to store in its collection or library of materials. This information and/or materials can be in any form. Preferably though, the information will be stored in video, poster, poster group or other multimedia formats.

While it is not a requirement of this aspect of the invention to do so, the library will preferably include a broad scope of each of these different types of materials. For example, the system preferably will include a broad range of educational materials. Educational materials generally, though not exclusively, describe the goods and services offered by the business or certain background, aspects, features or related information to the business' goods and services. By way of example only, in the case of a medical office embodiment of this aspect of the invention, educational materials would include descriptions of the different ailments, injuries, medical conditions and methods of preventing, curing and/or treating the same.

The system would also preferably include a broad range of marketing information and/or materials, which generally, though not exclusively, comprise information about other products provided by the business. For example, in the case of a medical office embodiment of this aspect of the invention with multiple different medical specialists (i.e., a podiatrist, chiropractor, ophthalmologist, etc. . . .) in one office complex, marketing materials would include promotional-based descriptions of the different services provided by each of these different specialists. Similarly, in the case of an insurance office, the marketing materials would include promotional-based descriptions of other goods and services provided by the office (i.e., for a life insurance policy holder, materials concerning automobile insurance, mutual funds, bonds and other financial products provided by the insurance office).

The system would also preferably include a broad range of other business-related items stored in the library or collection. This could include many different types of information that could be beneficial to business if viewed by its clients, such as the business' logo and history, information related to its employees and volunteering services to the community, information related to related interests of the business' clients (local sports teams, news, etc. . . .). Notably, the system is not required to have all of these types of materials, let alone broad ranges of each of them.

The system will preferably have a category field for tracking the item's category. The system will also preferably allow the business representative to create groups of items, which can then be viewed together. The system then could allow the business representative to choose the sequence of items in the group.

E. Tracking Viewed Information and Materials

The system also preferably tracks the information and/or materials viewed by each client and stores the information so that it can be used as part of the automatic selection process. Preferably, the system will be able to identify how much of the information and/or materials the client viewed and place such information in the client's record. Thus, for example, the system could re-start a video that had just started prior to the business representative entering the room and meeting with the client, whereas the system may choose not to re-show a video if it was 95% complete prior to the business representative entering the room and meeting with the client. Ideally, the system would be able to restart the video at the exact same point that the business representative entered the room, such that the client would be able to see the entire video without having to watch any portions again. While one of ordinary skill in the art would appreciate that many ways exist as how to track which information and/or materials have been viewed by a client, one way to do so would be by including fields in a database that store the playing status (i.e., waiting to be played, playing, finished playing, etc. . . .) whether and/or when the information and/or materials were viewed by the client, the duration of information and/or video and the length of time the video was viewed by the client.

1. Patient Education

a) Benefits

Some advantages and benefits of what is called the Patient Education module of the system include, but are not limited to:
1. It can be specific and unique to each patient.
2. The patient education system is linked to highly targeted demographics embedded within the patient health record. The software chooses which video to play for the patient.
3. Provides for faster, more accurate and meaningful patient education offering a better value-added experience for the patient-customer.
4. Allows access to literally hundreds or more of high quality anatomical posters and videos anywhere in the clinic.
5. Videos are filmed in High Definition (HD).
6. Visual graphics can be directly accessible while with the patient.
7. Customizable to load the provider's own favorite existing video library.
User can download any self-made video, PowerPoint, or other products into this system.
8. Offers patients a clinic experience totally dedicated to their healthcare with more time devoted to them.
9. Can assist in growing the health professional's with referrals from highly satisfied patients.
10. Has the ability to generate additional per-patient-visit revenue by offering additional services within the clinic of significant value to their specific healthcare condition.
11. Can improve the quality and purpose of patient-doctor dialogue.
12. Viewed videos and images are automatically documented in the patient record.
13. The availability for individualized provider personalization.
14. Each educational video is automatically selected by the software or manually chosen by staff/doctor.

b) Operation

The Patient Educator is patient-education software that seamlessly integrates with the electronic health record. The media library includes hundreds or more of anatomically correct posters and high-definition videos, which turn wasted waiting time into valued information sharing for the patient.
1. Patient's information is entered into the electronic health record (EHR)
2. The artificial intelligence of the EHR automatically selects diagnostic- and demographic-specific videos that pertain to the patient
3. If the patient leaves one therapy bay and goes into another, the EHR will stop the video and start it exactly where it left off in the other room
4. Before the patient leaves the clinic, a printout of the recommended exercises are given to the patient at the front desk
5. The videos that were viewed are entered into the patient's EHR

One exemplary embodiment can provide the following types of benefits:
1. Fully utilizes the patient's three to five minutes of waiting time
2. Video educates the patient in regard to their condition and outlines recommended treatment options
3. Enhances patient's understanding of condition
4. Saves doctor time by answering commonly asked questions about the video
5. Promotes other services offered by the clinic
6. Generates patient referrals
7. Secures additional income

Patients need to feel they receive a real value from visiting their health care provider. It goes beyond treatment. They need to feel special, that their time in the clinic was not wasted. The patient educator is the link between a satisfied patient who follows the recommended treatment plan, finds value, and refers the practice.

c) Display and Documentation

The information and materials play automatically to a designated monitor near the location of the client and the material viewed is documented in the client's electronic record with customized notation by user. The material viewed has a supportive component hand-out or supportive accompanying written information that is automatically printed at the receptionist desk at the time the material is viewed on the monitor by the client.

An example of exemplar features of the Patient Educator are as follows:
1. The clinic scheduler knows which room a patient is in. The scheduler instructs that a video be played to the patient in that room, and the system can do so without requiring personnel to go to the room, turn on the display, etc. The video content is held in a centralized device with storage capacity for many such videos.
2. The system automatically creates a “play list” of videos for that patient. As previously described, the system has a list of videos that are correlated to that patient based on such things as diagnosis(es) and demographics specific to that patient. Therefore, the media and content of the videos for education of the patient is specific to or customized for that patient.
3. The play list is ranked in relative importance by the ranking system previously described. The ranking essentially prioritized which video plays (a) first, and/or (b) at what time, and/or (c) at which patient visit. Alternatively, personnel can manually override the play list and select whichever one they want. Thus, the system can automatically select which media or video to play at that particular time for that particular patient. As previously discussed, this can be based on the factors for that specific patient. The system selects a video based on the ranking of the patient-specific videos.
4. The system tracks which videos have been played to that patient and when. In certain circumstances, if a video is selected by the system but the patient has already seen it, the system will pass over that video and go to the next ranking video in the patient's list. In some cases, however, the health care provider may want the video played again to the patient at that time, and the system can respond accordingly.
5. If the patient is moved to a different room or location, the system can be informed and display the video to the patient at the new location. It can even stop the video at the old location at any point, and start it in the new location at that point, so the patient does not have to start viewing from the beginning.

Features of integration with other components of the system can include the following:
1 After the patient watches a video, the system inserts a documented notation into the patient history documentation component of the system. This is automatic which saves much time for the provider. The system is flexible so that the provider can add manually information to the note and/or literally digitally insert the video into the digital documentation of the visit. Moreover the provider can add other information to the note.
2. Additionally, the system can automatically instruct a hard copy printout of the content of the video (or some portion or paraphrasing thereof) that could be given to the patient (e.g. at the check out counter). This would allow the staff to have it waiting for the patient at check out. The system could automatically flag or alert the receptionist or check out staff on his/her computer screen that a printout for the particular patient is waiting in the printer and should be given to the patient. The staff could retrieve the printout from the printer, give it to the patient, and confirm it was given. The system would document this. It would give the patient the ability to refer to the printout at his/her leisure. The system could automatically document the patient's history that he/she was given the print out.
3. Currently, providers are allowed to charge for providing certain education information to patients. The system knows which information is being given to which patients and can automatically bill for the same. This improves efficiencies because the educational task can be performed automatically for the patient, without requiring staff, and then it can be automatically documented and billed. This provides more time for the provider to spend personally with the patient. The system can be pre-programmed to have the appropriate billing code correlated or associated with each video that can be billed, and then apply that code to the patient's billing. This saves time and resources and improves efficiencies. Because the system knows the patient watched the video, it can do these further tasks.
4. Also, reports can be generated that are helpful to the provider. For example, the system, knowing and storing which videos have been watched by which patients and when, can generate reports such as the following. A report can summarize how many patients watched a particular video (e.g. diabetes) in a particular time period (e.g. month). The provider can analyze this and take action, if needed. For example, it may indicate that the diabetes video needs to be scored differently (see previous discussion of scoring and ranking) so that it is played more or less frequently to the patient population for the provider. Sometimes the provider may want every patient to see a particular video (e.g. explaining informed consent). The system could monitor and alert the provider or staff if this has or has not occurred. As can be appreciated, because the patient educator module knows which video is shown to which patients, and stores this information in a searchable fashion, the system can be “mined” or queried (like any database) to get a variety of information that can be useful to the provider.
5. Also, the system is flexible and customizable. For example, it allows an override or adjustment. If the provider does not want a particular video shown to a particular patient, the system can be instructed and the system will not do so. Furthermore, if the provider does not want something documented in a patient history, the system can be so instructed. For example, a flag or instruction can be entered that a certain patient should never be played a certain video. An example would be as follows. A video in the video library may advise that pharmaceuticals for a particular disease or ailment are to be avoided. The system may rank this video of importance based on a particular patient's factors. However, the provider may disagree with the content of the video for this particular patient or the particular disease or ailment (the provider may feel certain drugs are very effective). The provider can forbid the video for that patient (or all similar patients).
6. The system is flexible because videos can continuously be added or removed or changed in scoring or ranking in the system. The provider can score them as he/she sees appropriate, but can adjust those scorings at any time.

As can be seen, this is what might be called a “deeper integration” between the virtual patient educator module of the system and other modules, e.g. billing and documentation, than simply having common demographic data or more superficial integrations between billing and documentation. This “deeper integration” is anchored in the virtual patient educator. The system of automatically gathers patient-specific intelligence which is more than name, address, insurance number. This deeper, patient-specific intelligence is thus available to make many other tasks of the health-care provider more efficient, over and above just keeping track of what each patient has been presented in the way of videos or other media. It allows the system to work autonomously to automatically perform tasks appropriate for each patient. This saves much time of the staff and health care professionals, which frees up more time for patient care.

The example of Informed Consent is illustrative of advantages of the invention. For example, Informed Consent within a healthcare facility is performed with a legal document explained to a patient and the patient signs prior to surgery or whatever the procedure may be. Using a digital video that is customized to the diagnosis of the patient that is queued up automatically by the software technology to the exact room the patient is located, all known from the scheduling software contained in the software product. The informed consent video plays a consistent message with images and audio that helps the patient understand more clearly and as a result of the video playing, a one page note describing the video and its content are inserted into the patients record automatically providing the proper documentation to comply with informed consent guidelines. Videos about the diagnosis of the patient can play in the specific room all controlled by the software looking at the specific diagnosis of the patient in the electronic health record of the patient.

F. Parameters for Automatic Selection

A business may use whatever parameters it desires to determine which educational, marketing and/or other business-related information and/or materials to provide to a particular client. Preferably, the business will use parameters that take into account data related to the educational, marketing and/or other business-related information and/or materials to be provided to the client, the billing and other information concerning the client, and the scheduling information for the office as part of its selection criteria. These selection criteria can either be created or customized by the business or be default values already existing in the software for the system, and they value or rank the priority of items in the library or collection to be provided to the client in light of these parameters. By way of example only, the selection criteria for a medical office embodiment of this aspect of the invention could include patient demographics, diagnosis codes, services already provided, patient history, recreational activities, occupation, and other patterns entered into the customized system.

1. Parameters Related to the Items in the Collection or Library

Each business can choose which fields concerning the items stored in its collection or library to use in the valuation or ranking process. Preferably, the business will include information related to the tracking of previously seen videos as part of the valuation or ranking process. For example, the system could cause items previously viewed by a given client to be valued or ranked so low that they would not be automatically selected again for viewing for that client unless a business representative overrode the playlist and specifically inserted that item into the client's playlist. Alternatively, the system could cause items previously viewed by a given client to be valued or ranked in this way only for a specific period of time, such that those items could reappear on the client's playlist after that period of time.

Further, the business will preferably also include information concerning the duration of the item in its valuation or ranking process. For example, the selection criteria could be arranged such that if all other selection criteria for numerous items are the same, the automatic selection method and system would select those items that will allow the client to see the most videos. Further, the selection criteria preferably is structured so that the items selected will be displayed such that the client does not have any period of time where the client is waiting in the room without any item playing and that the last scheduled item to be played from the playlist will end contemporaneously with the anticipated arrival time of the business representative in the room.

2. Parameters Related to the Billing and Other Information for the Client

Each business can choose which fields concerning the billing and other information about the client to use in the valuation or ranking process. For example, the business could include information related to the client's payment history in its valuation or ranking process. The business could structure the selection criteria such that only items related to goods and/or services for which the client has a good payment history are selected and/or such that items related to goods services for which the client has a bad payment history are not selected.

Further, the business will preferably include information related to the client's demographics, interests, hobbies, recreational activities and other life interests in its valuation or ranking process. By way of example only, a medical office could value or rank certain items related to how to optimally perform in certain sports with a high enough value that it will likely be selected for the playlists of clients who actively play those sports. Similarly, the medical office could value or rank certain items concerning certain medical conditions that are most likely to occur in clients with certain demographics (i.e., breast cancer videos for women over a certain age) such that those items are likely to be selected for the playlists of those clients that have those demographics.

3. Parameters Related to the Scheduling Information for the Business

Each business can choose which fields concerning its scheduling system to use in the valuation or ranking process. Preferably, the business will include information related to the expected wait time for the client in its valuation or ranking process. For example, the system preferably will have a schedule for each office room and each business representative in the business. The system will also preferably be able to estimate the amount of time the client will be waiting in a room prior to when the business representative is available to meet with the client based on information concerning what the business representative has scheduled before that time, how long the given business representative normally takes for those scheduled tasks and how long the clients for those already scheduled tasks already take. As a result, the business preferably will be able to structure its selection criteria so that the items selected will be displayed in a manner that increases the amount of time the client is viewing videos while waiting to see a business representative based on these scheduling estimations.

G. Method and System of Loading and Storing the Items in the Collection or Library

One of ordinary skill in the art will appreciate that there are many different ways to load and store the items in the collection or library. However, the following description is one preferred way of doing so. According to this embodiment, the system will have a screen dedicated to the installation and editing of items in the collection or library. One of the options on this screen is a “find” option, which allows the user to find different items based on different data fields stored for the item (i.e., title or category). Another option is the “add” option, which allows the user to add new purposes and categories for a given or new item. The “summary” option allows the user to view and/or edit a memo summary of what the item is about. The “clinic review option” allows the system to automatically place certain information into a client's record after the client has viewed some or all of a certain item. The “view clinic entry” option displays the information that will automatically be placed in the patient's record. The “exclude provider” option allows a user to exclude the item from the potential items to be selected from for a certain business representative or group of representatives. The “set associated document” option allows the user to select certain documents or notes to be associated with the item that then can be printed, e-mailed, faxed or otherwise provided to the client upon viewing the item. The “view” option allows the user to view the associated document or note. The system will also include controls which allow the user to associate point values for the items for certain client demographic and other information as discussed more thoroughly above. For example, as part of this ranking process, the user could select a specific rating criteria (i.e., data field) from the criteria specifics list box (which includes the possible fields that can be ranked). Then the user could select the point value (which preferably would be between 1-100) for the selection criteria. The user could later edit the points if the business determines changes to the priority or ranking should be made. As part of the loading and editing process, the system preferably allows the user to group certain items together so that they can be analyzed as a group in the selection process and/or be viewed together by the client.

Further according to this embodiment, when the video or media is loaded into the system, it can receive a quick rating by simply applying a specific point amount from zero to 10,000 points. This quick rating would not be based on any specific criteria other than the user determining a level of importance arbitrarily. At any time, the user can look at a list of the entire collection or library of items and view the title of the item, purpose, and the point rated for that item. One unique feature of this embodiment of this feature of the invention is that the user can select for which demographic data the item is intended to be played. For example, the user could select a specific set of diagnosis codes from a list provided, the gender could be selected, a certain age category, persons involved with recreational activities, persons engaged in a certain set of occupational categories, and the system would then search for those clients or patients that met those criteria and the video would have a high priority to be played for those individuals with a rating being added up from the total of different demographic components causing the media or video to be higher priority for one patient who met all of the above criteria and the media would be lower on the playlists if it only met one of the criteria in the example above. Further, a detailed description of these features and other features of this automatic selection aspect of the invention are set forth in FIGS. 3A-K, 5A-N, 8, and 9A-D, and discussed in Sections H.1, H.2, and H.3 below.

One skilled in the art will appreciate that the present invention will both decrease expenses for the business and generate new business from existing clients. For example, the present invention's automatic performance of the functions described above can allow a business to operate with fewer employees and requires less time and expense in training employees to perform these tasks. Further, the present invention's ability to store one version of videos, brochures, and other multimedia and other media will decrease the expenses for obtaining, copying and/or disseminating such materials. This can be a large benefit to a business in light of the high cost of these materials. Moreover, the present invention's ability to provide targeted marketing and other promotional materials to its already existing clients could dramatically increase business. Indeed, for most businesses, it is substantially more difficult and costly to generate new clients than it is to generate more business from already existing clients. Because this system takes into consideration what clients desire (i.e., targeted educational, marketing and other business-related information) and what clients do not desire (i.e., generic information and marketing information as well as information that the client has already viewed recently), the system can provide a potentially uniquely effective (both in terms of cost and new business generated) marketing program for the business.

One skilled in the art will instantly recognize that this example is representative of many different applications for the management of an office, including the storing and loading of educational, marketing and/or other business information and/or other materials. Further detail concerning potential embodiments of different aspects of the invention is set forth in the Figures and Sections H.1, H.2, and H.3 set forth below, which are incorporated herein by reference and comprise part of the specification for this invention.

H. Options and Alternatives

Having thus described a preferred embodiment and other embodiments of numerous aspects of the invention, it should be apparent to those skilled in the art that certain advantages of the present invention have been achieved. It should also be appreciated that various modifications, adaptations, and alternatives may be made. It is of course not possible to describe every conceivable combination of components for purposes of describing the present invention. All such possible modifications are to be included within the spirit and scope of the present invention which is to be limited only by the following claims.

Specific additional examples of options and alternative exemplary embodiments according to aspects of the present invention are set forth below to help understand aspects of the invention.

1. Example of DIEM

The following is a example of further detail and illustrations regarding features of DIEM. This description should be read in conjunction with FIGS. 3A-K.

a) Overview

A specific discussion of one exemplary embodiment of the invention will sometimes be referred as Digital-Imaging Education & Internal Marketing™ (or DEIM™). It can streamline a business by effectively serving two primary purposes: 1) reduce the amount of time spent by an employee educating a client on certain subject matter; and 2) provide internal marketing regarding other products/services offered by the business. In the following embodiment, any reference to a medical patient or client relates to the customer of the business or entity utilizing the software. DEIM™ is synonymous with and sometimes also referred to as “VPEIM”™, which is Video Patient Education Internal Marketing™.

DEIM is the “LINK” or connection between: a) the digital video imaging, digital graphic diagrams or posters, and illustrations (hereinafter collectively referred to as “digital imaging”) that educate the businesses customer (“client”); and b) the database, internal document storage, or data that relates to the client's information (input data). The key to DEIM is that it is driven by input data pertinent to the client. Presently, input data is used to determine what educational information is to be outlined for the client. This is typically done manually by an individual or employee of the business. Then the individual either discusses the information with the client or uses digital imaging, graphic diagrams, or illustrations to assist in the process by manually picking those that individual feels are pertinent. DEIM is the software program that utilizes the client's input data to: a) determine the best suited form of educational digital images for the client; b) play the digital images for the client; and c) document and track the digital images that the client has viewed.

Therefore, the DEIM selects digital images that are pertinent for each client based upon customized “selection criteria”. This selection criteria may be customized by the business. It also tracks the digital images that have been viewed by each client to ensure the client is not receiving the same information repeatedly.

Because DEIM allows the business to set the selection criteria, one major attribute of DEIM is that the business now has control of the information provided to a client. It is no longer left to the discretion of an individual employee. If the employer has other clients waiting, he/she may not be as thorough in outlining details on a subject or fail to market additional products/services of the business. Therefore, due to time constraints or the quality of the employee, the quality of the subject matter may suffer and the amount of information outlined may be limited or lack detail. DEIM provides the business an internal client education system and internal marketing system where the quality and content is controlled by the business based on the selection criteria. The digital images are also customized for insertion into the system allowing the business to determine the detail of the information resulting in quality control.

For example, in the health care industry, a patient/client completes an intake form, which includes such items as family history, occupation, etc. The physician also enters information for the patient file including such items as conditions, symptoms, diagnosis, etc. All of which create a patient file or data record, which can be utilized as input data. Based on the data related to the patient, DEIM selects digital images that are pertinent to the individual. Again, the owner of the DEIM product can customize the selection criteria as well as the images. Therefore, if a patient is a truck driver who is overweight experiencing low back pain, the DEIM will determine based upon the “selection criteria” a set of digital images that would benefit the client. These may include digital images related to: a) low back stretching techniques, which would be beneficial given the occupation of the client; b) the stress on the body associated with being overweight; c) lifting techniques to reduce stress on the low back; d) nutritional supplements offered within the practice (IE: dietary, energy, etc,). These digital images would use the input data to select and display the digital imaging during times when the patient is not with the health care provider. For example, the lifting technique digital image would play once the client, the truck driver, entered the exam room. Therefore, the business would be educating the patient while waiting for the physician to enter the room for the exam. An additional digital image would be displayed after the doctor exam while the patient receives therapy. Therefore, instead of a patient just sitting in a room receiving therapy (IE: ultrasound), he/she would also receive additional digital image education. In both these cases, the time spent educating the patient on pertinent information to the patient by the employee (physician and/or assistant) has been reduced.

Another example would be in the insurance industry. DEIM would select digital images based on the selection criteria to educate the client on certain products offered by the firm during times that are not typically utilized by the firm. Digital images could be displayed while clients are waiting to meet with a representative. Additional digital images would be viewed while the representative is with another client or preparing paperwork. Again, based on the selection criteria, the DEIM would select digital images to educate the client on certain subject matter such as annuities, life insurance, IRAs, which would explain the how they function and the benefits/returns of the programs. For example, if a client is scheduled for an appointment regarding retirement programs, DEIM would outline and play certain digital images in the employee's office on this subject. This could be done while the representative is completing paperwork or visiting with another client. The system can also utilize digital images to portray other services within the firm that the client may be unaware of. Yet, it may lead to additional questions and/or product sales because the client may not have been aware that this business offered these additional services or products.

The basis of DEIM is not the digital imaging sector or the data storage sector. The unique feature of the DEIM is that it is a “thinking” educational and marketing system utilizing data pertinent to the individual client. The software selects a digital image that is pertinent to the patient's health. The data and educational information is pertinent because it applies or pertains to the individual. Therefore, it creates the “LINK” or connection.

The primary purposes of DEIM are: 1) to effectively reduce the amount of time spent by employees to educate clients on subject matter; and 2) to market additional products/services to clients that they may be unaware of during time that is typically wasted in a business setting. While the digital images are playing, the employee has additional time to focus on other clients or generate new clients for the business. Also, the employee may be more efficient and generate additional sales relating to products/services that the employee did not outline, but the software brought to the attention of the client. For example in the health care industry, the family history portion of the intake form of a patient indicates that her child has scoliosis and her husband has diabetes. The software may select a digital image on these subjects, scoliosis and diabetes, outlining services other providers in the SAME health care practice offer for these conditions. The patient may have been unaware of these services being offered in the clinic and may suggest to the family member to seek out these services in this clinic. This generates additional services/income for the facility and benefits the family to improve their health. It also ensures that subject matter is addressed and the quality of the information is consistent in that it is not left solely to the discretion of the individual employee.

The DEIM software incorporates a digital imaging library on hundreds of topics, as well as promotional digital images and images informing the client of other services/products provided by the business. DEIM functions using INPUT from SOURCES stored and documented by the business. The application of DEIM is adaptable to any service related industry such as health care, financial planning, insurance, etc.

An example of the application of the fundamental principal to the health care industry follows. A chiropractor spends a portion of the day educating the patient prior to or after generating the actual service. According to the Job Analysis of Chiropractic 2005 (“Analysis”), a summary of a clinical day for a chiropractic physician reflects that approximately fifteen percent (15%) of a typical chiropractor's occupational time is spent with patient education. (Refer to figure below). Patient education in the health care industry represents the primary area that DEIM seeks to enhance. By minimizing the occupational time spent regarding patient education, the doctor and staff have additional occupational time to see more patients or have more personal “free” time outside the business. In addition, even though the occupational time spent on patient education is reduced, DEIM improves and enhances the delivery of patient education through visual graphics. In essence, the goal is to effectively reduce time spent on patient education while providing similar or greater quality. This time that is gained could be used by the staff and doctor for their personal life outside the practice OR could be added to direct patient care time to: 1) expand/grow the practice; or 2) provide more quality service with additional time spent with the patient.

b) Functions of the DEIM.

Examples of its use in the chiropractic health care industry include:
1. The software intelligently selects an appropriate digital imaging to be viewed by a patient.
2. Hundreds of digital images can be digitally downloaded into the digital imaging library to be automatically selected by the software.
3. The software tracks which digital images have been seen by a patient so that it does not select the same digital imaging on a subsequent visit.
4. After the patient has seen a complete digital imaging, the software automatically places a summary of the digital imaging into the patient chart denoting what material was explained to the patient.
5. The summary of the patient educational digital imaging can also be e-mailed, faxed, or printed for the patient to take home with them after viewing.
6. Approximately 1 out of every 4 of digital images selected will be an internal marketing digital imaging which will promote additional services provided by the clinic. This may result in more services provided. For example, a chiropractic patient on their fourth visit to the office would see a digital imaging promoting the medical department regarding asthma treatment for this given patient since the history form indicated this patient has asthma. This may result in more services of the clinic being chosen by this patient since they may have been unaware of these other services available. Another example would be to promote foot orthotics if the patient had marked foot pain or heel spur pain on their intake form.
7. The software looks at the hobbies and recreational favorite activities of a patient and would select educational digital images to improve performance or provide instructional injury prevention tips regarding those hobbies and sports activities. Therefore, the digital images are relevant and interesting to the patient rather than a generic digital imaging played to everyone. Other demographic data analyzed in selecting the appropriate video includes sex, age, diagnosis, treatment services already received, past health history, occupation, hobbies, allergies, medical complications, and a variety of other factors that are answered on the initial intake forms that the patient or client completes upon presentation to the clinic or business.
8. The software calculates the waiting time of the patient prior to the physician entering the exam room. This allows the software to select not only the relevant health related digital imaging but also the correct length of a digital imaging. For example, the computer estimates that there are three people waiting to see Dr. Jones, it estimates that patient number 2 has a seven minute wait and patient number 3 has a 15 minute wait. The software can select a longer length digital imaging for patient number three and would only select a five-minute digital imaging for patient number two.

DEIM successfully reduces time spent with patient education and internal marketing. If the doctor can spend more time seeing patients, they would be more productive resulting in an increase in services resulting in more productivity resulting in more profits. One reason that additional time is needed during a patient encounter is to explain certain conditions or instructions to a patient. After these instructions have been given, the doctor must then document those instructions that were provided to the patient. On certain conditions that require a standard explanation with minimal variation, and these explanations that would normally take five minutes could be handled with a digital imaging. Some doctors have communication difficulty. Occasionally, the hurried doctor may leave out one important feature of the explanation. Some patients don't understand the explanation given by the doctor. Some doctors use too much technical jargon. Some doctors simply cannot explain it in a clear manner. Many doctors in the United States are now foreign trained with speech accents that make it difficult to understand, especially amongst the elderly. Many patients have different methods of comprehension. It is a fact that some individuals respond and understand more clearly when there is a visual component to the explanation. Others respond more to auditory input. The DEIM provides digital imaging and audio explanation simultaneously. With simple graphics, analogies, and simple “plain” verbal instructions, the patient will likely understand the situation better than the doctor could have ever explained it through the use of our digital images. Patients often complain that things were not explained to them regarding their condition. Doctors would like to spend fifteen (15) or twenty (20) minutes explaining things in more detail but they simply don't have the time in order to remain profitable. If the doctor spent half an hour with a patient providing an examination and describing treatment options and explaining certain factors to the patient then he would only be allowed to see twelve (12) people a day since additional hours a day would be dedicated to documentation and clinic management. With this volume of patient care, they would soon be out of business.

The DEIM basically serves as an educated intern for the doctor. The digital imaging explains many items to the patient. The doctor still has the ability to check back with the patient should they have any questions on the material they just viewed. Once the patient sees the digital imaging, software immediately transfers certain data into the patient record documenting that this information was given to the patient. This saves the doctor even more time in documenting instructions provided to the patients. The information can even be summarized on a single sheet of paper and printed at the front desk so the patient has the information to read at home and share with the family. If the patient would like to do so, the information can also be automatically e-mailed to their home with the simple click of one-button on the software system. Modern society is a more educated society. Patients want more information from their doctors. No longer is society placing doctors on a pedestal and accepting their decisions at face value. Patients ask more questions. They want to know more details. People are more health-conscious than ever before. Patients have more choices in front of them for healthcare selections and treatment options. They want to make informed decisions. They want more information. The doctor can only provide so much information and still see a certain number of people to remain profitable. The DEIM system gives the patient a value added experience. They receive answers to questions in an understandable format. With the doctor's voice or image in part of the digital imaging, the doctor is now famous because they are on television or in a mini-movie. The doctor is now more of an expert in the eyes of the patients. After all, they just made an educational digital imaging on the exact subject the patient suffers from.

There are a significant number of patients who have a variety of doctors they see for different health conditions. Many patients believe that chiropractors treat only back conditions. They also believe physical therapists most only deal with sports injuries or physical ailments. Many physical therapists specialize in a variety of conditions that one would normally not think of a physical therapist. For example, bladder incontinence, is a condition that many physical therapists have special training, or specialized balance training for people who have dizziness and vertigo. If the patient had checked on their symptoms list on the intake form that they initially completed when arriving at the clinic, these subjects would be in a promotional digital imaging played in the room while the patient is waiting. This may prompt the individual to seek a completely different treatment regimen from the same or other healthcare provider within that clinic for those secondary conditions even though they may have been in the clinic for a knee condition.

This results in practically a brand-new patient with a totally different health-care condition. Healthcare experts have stated time and time again that the cost of generating a new patient in a clinic is five times that of cultivating an existing patient base for other services that they may not be aware the clinic provides. Medium to large clinics often have several different health-care providers. For example, in a multidisciplinary clinic there may be a massage therapist, an acupuncturist, a sports athletic trainer, an internal medicine medical doctor, a chiropractor, and an occupational therapist. One patient may only be seeing the chiropractor and may not be aware of all of the other types of services provided. By educating this patient on these other providers and services provided they may select the clinic for those services when they had been contemplating going elsewhere.

Because the DEIM will be used primarily to educate the patient and assist the doctor in explaining the diagnosis and treatment needed, it supports the doctor-to-patient dialogue and provides improved communication that ultimately equates to a better educated patient. Furthermore it allows the doctor to be in the digital imaging, which allows a more personal feeling of care. Patients want more time with the all-too-busy doctor, and the DEIM provides for that. Some of the educational digital images and promotional digital images regarding other services provided within the clinic will have pre-taped background and graphic portions of the digital imaging that will be the same for all users. However, certain sections of the digital imaging will allow the doctor to have his or her own image and voice over dubbed throughout the entire digital imaging. The doctor can be inserted into the digital imaging through the use of blue screens.

Another key feature of the DEIM is a fully accessible resource library available by the doctor and staff. Doctors currently spend thousands of dollars on books, digital images, posters and the like, to support theirs and the patients' education. The DEIM will have many of these at the doctor's fingertips, further improving time efficiencies with the patient. These can be updated electronically much more economically.

Educational posters and brochures cost hundreds of dollars annually for a given clinic and per provider specialty. Framing of these posters and the time to order updated information on the posters is a cost that all healthcare clinics encounter annually. Not only will the digital imaging library be available to the healthcare provider, but a poster library and a brochure library will also be available from the menu on the software product DEIM. Each user will be able to program the software to allow for a variety of methods of displaying the information can be either: 1) digital imaging format; 2) static poster format; 3) brochure like format with sound, silence, light background music; or 4) audio description of the information. In addition, how long the poster is on the screen or monitor in each examination room can be programmed. It could be in a scrolling format with as little as ten (10) seconds per screen image or as long as five minutes for a poster to be viewed. Interactive capabilities with a touch screen or voice activated response from the patient in the room is also possible. This will allow for a patient to simply answer a response of “yes” or “no” when the software system asks if it should proceed to the next slide or poster. Each selection of the images, posters, digital images, etc. will have relevance to the individual patient since the computer will be checking the diagnostic codes in the software to determine if the subject matter is applicable to a given patient's condition.

Also, other educational information that may not be related to a specific diagnosis for the patient could also be displayed. For example, pieces of demographic data (i.e. age, gender, race, hobbies such as golf, number of children within a certain age group, job type, etc.) are obtained from the initial intake forms completed when the patient enters the clinic or the doctor's interaction with the patient. The computer reviews this information. Based upon the demographics, the system determines whether or not a given poster or digital imaging is appropriate or applicable to the individual.

When each digital imaging, poster, or brochure is digitally entered into the digital imaging library, there will be a questionnaire to be completed by the user when downloading the digital imaging in order to “tag” the digital imaging or poster. This helps the computer select the item later to match the demographic data of a given patient. Some of the questions would include: what age group is this digital imaging directed for, what diagnosis list, any special sport hobbies or interests, men or woman or both, and other questions in order to identify the target audience for the selected educational graphic piece.

The graphic educational piece can be selected by both the computer or manually from the staff at the front desk area or it can be selected by the doctor while in the room and the patient may view the informational piece with the doctor during their discussion of the case or the doctor may select a short digital imaging for the patient to watch at the end of their office visit allowing the doctor to exit. The patient remains in the room learning more information. The main application of this software system is designated toward the patient who has arrived for their office visit and who is waiting for the doctor to begin their office encounter. Most patients wait several minutes if not longer for their doctor in the reception room or in the examination room. The benefit of this software allows the patient to receive educational information that is relative and pertinent towards their given healthcare condition. Instead of waiting impatiently in the reception room, the patient will receive value added benefits of being in this doctor's office learning more about their healthcare condition and benefits from their encounter. In this way, the entire number of minutes the patient is in the office is totally dedicated towards their healthcare rather than a perceived waste of time of fifteen (15) or so in the waiting room.

The benefits to the doctor include not having to repeat certain segments of information that are generic to the majority of patients. For example, how to apply home heat therapy and home ice therapy or ice massage therapy. The technique for the appropriate application of these modalities requires the same description and instructions for every patient rather than any customized description. It is these types of scenarios that would be described eloquently and with visual application on a three-minute educational digital imaging that the patient values. The information applies directly to their condition and the doctor would have mentioned in the office examination room that he wanted them to apply ice or perhaps the nurse may have mentioned it and stated that they should watch the appropriate application of ice or heat. The digital imaging would describe the number of minutes that the therapy is applied, how many minutes to leave it off, and any other pertinent application facts, as well as describing the benefits of applying such a modality and how it improves healing time.

The DEIM software will read and/or communicate with the VDS software (see, e.g., Section H.2 below) to determine what kind of treatment has the patient received, the diagnosis, and other demographic data to select which digital imaging to play. There can be many digital images that do not require any special demographic data in order to be viewed by a patient.

A motivation behind this business method was simply to streamline business operational time while providing the client more information that is more specific and pertinent to individual clients. Doctors spend 15% of their day with patient education. Doctors would like to educate the patient's more thoroughly on their condition. Patients want more information but cannot receive dedicated face-to-face time with their doctor. Patients are frustrated when doctors are behind schedule and their waiting time is increased.

There is no presently known product on the market that provides a “thinking” system for presenting information to individuals. DEIM has the ability to determine the presentations/digital images for an individual or a group utilizing a process of analyzing input on an individual or group to determine the best suited material for viewing. Specific educational videos for the patient's specific diagnosis is selected and viewed by the patient without any staff person needing to manually select the video. While the patient is waiting for the doctor, these educational videos automatically play to the specific room that the patient has been checked into at the clinic. Additional support of material surrounding the topic of the video can be printed and distributed to the patient on their exit. A summary of the video is described and placed into the patient charts automatically if the patient watched the entire video. The ability to control relevant information specific to a patient can be displayed to that patient and any room in the facility with the doctor knowing what is playing in every room in having the control to modify all aspects of subject matter and playlist control.

This problem was not effectively solved in the past. It was done manually be employees and business people taking the time to explain material on a case by case scenario. Or, they would take a video and manually place it in any VCR or DVD player and have the patient watch the video they selected. Or a company developed large presentations for a group that are not as specific and, therefore, individual characteristics are not accounted for. An employee may use videos, posters, brochures, etc., however, whether this information was provided to the client or not has been left to the thought process of the individual employee. There was no automatic generated record of watching the video. The business would have to invest in multiple VCRs and DVDs and staff would have to manually start and stop the playing. During the busy day the staff did not have time to assess what the waiting time would be for each patient in determining whether or not they should have the patient watched a video. Now the software is able to determine all of this and select a specific video that has relevance to the patient's condition and the software determines the appropriateness of the weight time in selecting which video.

This method can quickly transmit the video to a room and develop a rating system that allows specific customization within each clinic for business for them to determine the scoring or rating of each video as to its appropriateness for a given condition or client. These problems were solved with our software format.

Many organizations develop presentations to discuss a certain issue. However, these are very general in nature. The presentations are not specific for each individual's demographics or needs. The advantages of DEIM include:
1) It is not done manually.
2) It saves the business time spent educating clients, which can effectively be used with other clients, to generate new clients, or outside the business to regain personal time.
3) It provides more consistent, thorough educational material that the business wants the client to view. An employee does not have the ability to misstate, misquote, or overlook certain information. It provides a consistent delivery of the message. In the case of a health care physician, the software provides a short written summary in the patient chart documenting the digital image viewed by the patient and the content.
4) It provides an internal marketing system that provides the client other services/products that the business offers that the client may be unaware of.
5) It provides internal marketing and education that is pertinent to each individual client by utilizing the client's demographic and internal information to determine the material viewed by the client. Because the digital images are relevant to the individual patient, the patient receives a value-added office visit from an educational standpoint and is likely to purchase additional services from a marketing standpoint.
6) It is a cost effective source of educational information. The cost savings are significant in that the digital images can be displayed in an unlimited number of rooms within the business. In the case of a health care physician, the cost of posters and diagrams on the walls in each room is very costly. A doctor with 5 exam rooms may have the same poster in each room.
7) It offers a tracking system to allow the business an understanding of what the client has viewed in the past, which saves time in that information is not regurgitated each time.

(1) Installing and Rating the Digital Images

The software will access and maintain a database of patient data (diagnosis, demographics, medical history, etc). Media such as digital images, posters and audio files will be stored on pcs connected to the network with monitors in the various rooms (exam rooms, treatment rooms, etc). When the media items are installed in the system, they are assigned point values for the various demographics, diagnosis or medical conditions based on the content of the media item and its relevance to a particular demographic, diagnosis, etc. Patient playlist are then automatically generated and saved in the database based on the point value of the media items that have been installed (most relevant at the top of their playlist). When the patients arrive for their visit, they are logged into the system and the next items on their playlist are shown to them automatically in the room that that are assigned to. The program keeps track of what they viewed or how much of a media item they viewed if the viewing was interrupted. All the media that are being played in the office (with the patient name, room name, view time remaining, etc) can be monitored from tablet pc with a wireless connection to the central network. The user is able to sign-in/sign-out patients, bring up specific media for patients on the fly, adjust volume for any room and in general control all the monitors and playlist from the tablet PC.

A) Screen One: Media Maintenance (FIG. 3B)

Media Maintenance allows the users to view, edit, install, and analyze all types of media entered into the system. This portion of DEIM is accessed primarily when inputting new or additional digital images. The system itself and its functionality will be discussed separately. This section outlines how the digital information is inputted.

Screen One outlines the existing digital images already entered or loaded into the system. The primary portion of the screen denotes the following information pertinent to the images: Title, Type, Purpose, Category, Point Rating, Duration. “Title” is the name of the image. “Point Rating” is the rating of the video, which is outlined later in this section. “Duration” is the length of the video.

The organizational database outlining existing digital images inputted into the system can be searched based on: 1) the type; 2) the purpose; and 3) the category. Along the upper portion of the screen, there are 3 boxes for each of these classifications. Each has a drop-down menu allowing the user to select from any or all classifications. Each of these classifications are developed by the end user as digital images are inputted. The purpose of this screen is for easy access for an end user to refer to before installing any additional digital images.

TYPE: The drop-down box allows the user to search for existing digital images by selecting one of the following choices: All, poster, poster group, PowerPoint, video. These selections relate the “type” or form of media downloaded into the system. Additional types can be added.

PURPOSE: The drop-down box allows the user to search for existing digital images by selecting one of the following choices within purpose: All, educational, marketing, relaxation, waiting room, and others can be added. These represent the “purpose” or educational viewpoint of the media.

CATEGORY: The drop-down box allows the user to search the existing system by selecting one of the following choices within the category: chiropractic only, medical only, physical therapy only, OB/GYN only, exercises, back care, or others.

B) Screen Two: Install/Edit Media (FIG. 3C)

On the far right of Screen One, there is a button: “Install/Edit Media”. By selecting this button, a new window, which is Screen Two, appears.

1) INSTALLING/DOWNLOADING DIGITAL IMAGE AND IDENTIFICATION: In the upper left quadrant of Screen Two, there are the following items: Media File, Title, Type, Purpose, Category 1, Category 2, Category 3.
MEDIA FILE: This is the location of the existing digital image that is being inputted. By clicking the binoculars to the immediate right of this box, the user accesses the browser to locate the digital image at its source (C drive, A drive, etc.)
TITLE: Once the digital image has been downloaded from another location via the media file, the end user enters the title of the video.
TYPE: The end user also determines the type of media being used (IE: video, poster, audio only, etc.
PURPOSE: The end user identifies the general purpose of the digital image by using the drop-down menu via the button to the right of the purpose box. Additional purposes can be added or deleted using the buttons directly to the right.
CATEGORY 1; CATEGORY 2; CATEGORY 3: The end user identifies the general purpose of the digital image by using the drop-down menu via the button to the right of the category box. Additional categories can be added or deleted using the buttons directly to the right.

2) RATING CRITERIA/CRITERIA SPECIFICS FOR DIGITAL IMAGE CONTENT: The lower left quadrant of Screen Two relates to the selection criteria the end user wishes to utilize as the selection criteria for ALL digital images. This information will continually be developed as the amount of digital images increase. It will always be displayed when a new digital image is being inputted. This is where all information pertinent to the digital image is inputted. IMPORTANT: This section corresponds to the “Input Data” of the storage system being used for the individual customer/client. THE ITEMS IN THE FOLLOWING 2 STEPS CORRESPONDS WITH CODE/INFORMATION IN THE DATABASE to allow for the selection process of the digital image. For example in the health care industry, when a patient completes an intake form, this form that is inputted into the computer database has certain information pertinent to the patient. The code or choices with the computer database, which has the information/input data pertinent to the individual customer/client, should COINCIDE with the code or choices that are inputted into this section.

Therefore, the information from this sample Patient Intake Form (FIG. 3A) would represent the Rating Criteria and Criteria Specifics below that distinguish the digital imaging selection process.

STEP 1: RATING CRITERIA: This refers to the general categories of the rating criteria. For example in the health care industry, the end user wishes to have videos to be segregated by “Gender” because certain videos are more pertinent to either sex. This is inputted by using the “Add” button. Categories can also be removed using the “Delete” button. Another example would be “Occupational Activities” as a rating criteria.

STEP 2: CRITERIA SPECIFICS: This relates to subcategories within the initial rating criteria. Using the same example, the end user feels that certain digital images are segregated by gender. In this section, the categories of gender are identified (Male and Female). This is inputted by using the “Add” button. Categories can also be removed using the “Delete” button. In the second example using occupational activities, criteria specifics may outline “lifting”, “walking”, “sitting”, “typing”, etc. Therefore, if the digital image would be useful for occupational activities that incorporate a significant amount of typing, the video can be properly classified.

STEP 3: SETTING VALUE OF DIGITAL IMAGE: In the lower right quadrant of Screen Two is the settings. This is the most important aspect of the installation process. By highlighting one of the Rating Criteria, the Criteria Specifics are portrayed for that Rating Criteria. The end user then highlights a Criteria Specifics. Now, by clicking the “Add Button”, these are set as one of the criteria of that video. So if the end user feels the video would be pertinent for an occupation with lifting, this would be selected. Upon clicking “Add Button”, a small screen appears with a scroll bar called “Set Points”. The person then sets the “value” or “quality” of the video by determining its point value. The higher the point, the more useful value or quality of the video for the Rating Criteria/Criteria Specifics chosen. The box indicating “Settings” outlines the Rating Criteria, Criteria Specifics, and Points for each chosen for the specific video. There can be more than one chosen; these Settings can be edited or removed by using the buttons to the right of the Settings. The system calculates the total point value of the video, which determines its viewing priority. The higher the total points, the higher the video value, which increases its selection by the system. The system can search the input date of the individual customer/client for rating criteria/criteria specifics to determine the digital images most pertinent for that person. Digital images with the same rating criteria/criteria specifics are chosen or prioritized by the total point value given to the digital image.

3) SPECIAL FEATURES: In the upper right quadrant of the Install/Edit Menu there are several special features available. Several items are for information/tracking purposes and several are documentation purposes.
a) Informational/tracking purposes:
   i) “Content Summary” button allows the user to input a brief overview on the video for reference purposes. They user will be updating digital images in the future and may wish to replace or remove an image. If the user would not remember the content of the digital image 4-6 months later after inputting, he/she could reference this section to “refresh” their memory.
   ii) “Duration” button indicates the length of the video and may be pertinent when considering the amount of time a certain customer may have with the business.
b) Documentation purposes:
   i) “View Clinical Record Entry” button allows the user to enter any text phrase pertinent for documentation purposes. The user can enter this text phrase and click “Automatic Record Entry”. By doing so, whenever this digital image is selected and the entire duration is completed, which means the customer/client has viewed the entire digital image, then the Clinical Record Entry is inserted into the customer/clients file.
   ii) “This media excluded from the following providers” allows the system to exclude this video as an option for certain providers within the business. For example, if a digital image is installed but it is not useful for the physical therapist, the physical therapist would be chosen. Therefore, if the customer/client is visiting the physical therapist, this video is not an option on the viewing list for this customer/client.
   iii) “Associated Document to this Media File” section allows the user to identify any additional print media that the user would like the patient to receive upon viewing the digital image. For example, if a digital image regarding lifting techniques is played for a customer/client, there may be certain diagrams outlining stretching techniques that the user would like the customer/client to take with them as a reminder. This section allows the user to enter the print media and determine whether the user would like everyone that views the digital image to receive the print media or have the option of selecting the print media whenever the digital image is viewed. IMPORTANT: This can be automatically printed by selecting the “automatic” function; however, it can also be printed manually upon viewing the video from the “NOW SHOWING” segment, which is discussed later and is used to oversee the system in its daily functionality.

In addition, one special feature is located on the Install/Edit Media Screen 2 in the upper left quadrant. It is “Create/Edit a Poster Group.” By clicking this button, you will arrive at Screen 3 Create a Poster Group (FIG. 3D), which is specifically for poster/medical illustrations. Once you have entered all posters, you may go to this screen in order to group them in any pattern desired by the business for certain situations. For example, a poster reflecting the spine may be incorporated into a sequence of posters to address osteoporosis. However, the same poster of the spine may be incorporated into a sequence of posters for a pinched nerve, but the subsequent posters are different from those in the case of osteoporosis. The user can customize the sequence of posters and display time for educational purposes. Steps associated with establishing the group in Screen 3:
1) Name the group via the “Poster Group Title”;
2) Select a poster via the list of “Available Posters” using the ADD and REMOVE functions;
3) Select the duration for which the poster will be displayed using the EDIT function above the “Show For” display;
4) Return to item 2 until all posters are incorporated; and
5) Save the poster group.

The individual poster ratings will accumulate for each poster as it is added. Therefore, the poster group will automatically receive high priority on the playlist should it meet the Rating Criteria and Criteria Specifics.

Example Summary of Installation:

Upon reviewing the digital image and assessing its usefulness/rating criteria:
A) Go to Media Maintenance, which is Screen 1
B) Click Install/Edit Media, which brings you to Screen 2
C) Click the binoculars to download or import digital image (video, poster, PowerPoint, etc.)
D) Establish Title of the video
E) Establish Purpose
F) Establish Category or Categories the digital image is useful for.
G) Choose the Rating Criteria and Criteria Specific.
H) Establish the point value of G for each.
I) At this point, one can go back to G to enter additional Rating Criteria and Criteria Specifics. Once all are chosen with values assigned. The process is completed.
J) OPTIONAL: Upon having all media installed, a user can go back to Screen 2 to complete any poster groups that may be desired.

C) Screen 4: Change Logo (FIG. 3E)

From Screen 1 Media Maintenance, there is additional button to the right of the screen. This is “Change Clinic Logo”, which allows the business to enter a digital image related to the business. When this button is clicked, Screen 4 appears. At the top of the screen, “Select a File” allows the user to browse for the proper downloading of the digital image to the system. At the bottom of Screen 4, the user has the following options: 1) Show once at the start of media play (Logo is displayed at the beginning of the media play whether it is 1 or multiple digital images being viewed); 2) Show once at the end of the media play (Logo is displayed at the end of the media play whether it is 1 or multiple digital images being viewed); and 3) Show before every media item (Logo is displayed before every media play whether it is one or multiple digital images being viewed).

D) Screen 5: Media Statistics (FIG. 3F)

From Screen 1 Media Maintenance, there is one additional important feature screen. This is “Media Statistics”, which the button is located on the right side of Screen 1. Therefore, by highlighting a video on the Media Maintenance Screen and clicking Media Statistics, it provides Screen 5. This can be customized to provide statistical data related to the digital images that have been inputted into the system. For example, it may identify the digital images that have been viewed most frequently. It is useful to view prior to inputting new digital images that have similar content to others. The statistical data may determine whether a video is replaced. Screen 5 displays the rudimentary statistical data that is incorporated at present, which includes the ability to select a time frame in the past to present (duration of the statistical analysis), the number of times the digital image was viewed during that period, and the list of people that viewed the digital image.

(2) Functionality of System Once Digital Images are Inputted.

A) Screen 6: Manage Patient Playlist (FIG. 3G)

Screen 6 Patient Playlist is an example for the health care industry. A user arrives at this screen by clicking the first icon on the menu bar, which looks like a persons head. The system has a basic scheduling function. This is incorporated into the “Patient list” and “Patient Data” tabs. The Patient data includes the input data on the individual customer/client. Therefore, by highlighting a patient on the Patient List and clicking Patient Data, it will jump to Screen 7 (FIG. 3H), which is the patient's data that has been inputted. On Screen 7, you will find the same process involving Rating Criteria and Criteria Specifics pertinent to that individual patient. You can also click the tabs for the following, which is where DEIM is functioning:
1) “Current Playlist” tab from Screen 6 outlines the material for the upcoming patient. By clicking this tab, you arrive at Screen 8 (FIG. 31). The system has already chosen the digital images based on the selection criteria for the customer/client. This screen is static and solely reflects what has been viewed and has been determined by the system to be viewed. The Expected View Date is coordinated based upon the rudimentary scheduling system incorporated into the software. You will also see items pertaining to the video that relate to the installation process of the digital image. These include the Associate File and Clinic Note Entry. This will display whether the digital image viewed had either of these “attached” to the video.
   “Title” outlines the title of the digital image.
   “Points” outlines the valuation of the digital image as it relates to the input data for this customer/client. The digital images that meet the criteria with the highest valuation are prioritized first.
   “Media Type” outlines the format of the digital image.
   “Purpose” and “Category” outline more detail on the digital image.
   “Visit” outlines what visit the patient is scheduled to view the digital image portrayed.
   “Duration” outlines the length of the video.
   “Expected View Date” is the date the customer/client is expected to view the digital image, which relates to the coordination with the system's scheduler.
   “Clinic Note Entry” outlines whether or not there is any documentation associated with the digital image that will be entered into the customer/clients patient data.
   “Associated File” outlines whether or not there is any supporting print media that is available for the customer/client upon viewing the digital image.
When the customer/client appears for the next visit with the business, the highest rated digital image will be played once the customer/client has entered the room. There is a 60 second delay from the point the customer/client checks in and the digital image being portrayed/played in the room.
2) From Screen 6, there is an additional tab referenced as “Playlist Editor.” By clicking this tab, you arrive at Screen 9 (FIG. 3J). The bottom portion of the screen is a short summary of Current Playlist for reference purposes. The large box in the upper right portion of the screen portrays the upcoming digital images remaining to be viewed. If the patient has a visit scheduled, it reflected the Expected View Date. If not, the remaining videos are still outlined that are pertinent to this patient. The upper left hand of the screen allows the user to manipulate the list if desired.
   a) At the upper left of the Playlist Editor, the “Auto-Generate List” provides options for the person utilizing the software (for example, the receptionist) to sort the list of digital images available for this customer/client. This may be used to alter the order of the digital images being viewed.
   b) At the left center of the Playlist Editor, the “Manually Edit List” allows the user to “Add a Title” (add image), “Remove Selected Titles” (delete image), or “Remove All” (delete all images) in order to manually manipulate the list of digital images.
Lastly, on the Playlist Editor, there is a button to “Create/Edit Default Playlist” and “Use/Edit Default List”. By checking the box, it designates that the Default List is active. To create the Default List, click the box “Use/Edit Default List.” Upon doing so, you will arrive at menu that allows you to choose certain digital images that are part of the Default List. The Default List is static and solely plays if there are no remaining digital images in the Current Playlist. The Default List typically would consist of generic videos such as the practice and its location, the benefits of chiropractic care, a video outlining the office staff and its departments, etc. The system can also save a number of Default Lists, so when there are no additional digital images to be played via DEIM and the first Default List has been utilized, it has additional Default List to revert to.

B) Screen 10: Now Playing (FIG. 3K)

One of the tabs on the menu bar is “Now Playing” tab, which resembles a person next to a piece of film (third icon from the left). By clicking this icon, you will open Screen 10 to find the list of all digital images playing in the office and the location within the office being played. It, again, is coordinated with the scheduling system, which is included with this software. The top of the section reflects the location of digital image being played, the digital image being played, the time remaining, status, and provider. The right hand of the screen provides functions for manipulating the “playing” of the video. For example, if the video has some time remaining and the doctor wishes to transfer the patient to another room, he can pause the video and transfer it to the next room for the patient to view the last portion of the video. The bottom section outlines a summary detail of the Playlist for the specific patient. This section is determined by the patients on the schedule. Additionally, the screen allows you to revert to other screens including Install/Edit Media and Playlist Editor. Lastly, the user has the option to print or send the “Associated File” that is attached to the video (Refer to Install/Edit Media) in the case that the Associated File is NOT a requirement for the video.

Example Summary of the Functionality of the System
A) Customer/Client checks in at the reception desk.
B) Receptionist logs the customer/client into a certain room.
C) OPTIONAL: Receptionist and/or doctor may go to Current Playlist to review the Playlist, sort, manually edit to determine the digital image to be viewed.
D) OPTIONAL: Doctor can enter Playlist Editor to manually manipulate the order in which the digital images are utilized or viewed.
E) After a 60 second delay, the digital image plays in the room for the customer/client.
F) OPTIONAL: Receptionist or any user of the system may go to the Now Playing section to pause, stop, fast forward, replay, or relocate the video to an alternative room.
G) Upon completion of the video, if there is an “Automatic” Associated File, it will print to the front desk or other designated area. If it is not Automatic, front desk or doctor has option to print/send it as well.
H) Upon completion of the video, if there is a Clinical Note Entry, it will be stored to be recorded to the customers/clients file upon the doctor completing the documentation.
I) All digital images viewed are tracked and recorded for Media Statistics.
J) All digital images viewed are tracked with the individual customer/clients account within the system on the Current Playlist. The Expected View Date will indicate a date in the past denoting when it was viewed.

DEIM is useful for any service related industry where businesses have employees utilizing time educating clients on certain subject matter. Examples include the health care industry (chiropractic, podiatric, veterinary, optometry, etc.) and financial planning (insurance companies, investment brokerages, etc.).

The commercial value of the DEIM relates to its advantages outlined previously. It serves as a cost effective tool for service related businesses. DEIM educates clients on certain subject matter and provides an internal marketing system on additional services/products associated with the business. The time saving aspect of DEIM allows employees additional time that can be used by the employee to provide each client more attention or to see more clients. The internal marketing system generates additional opportunities for the business to generate income. All of this is achieved while maintaining consistent, thorough information being disclosed during periods that are not typically utilized as value-added time for the patient/client such as when the client is waiting or the employee is completing paperwork, making copies, or seeing another client. In the case of a physician, a normal office visit for a patient approximates 45 minutes. Of which, 5-10 minutes is spent with the doctor and an additional 5-10 minutes with a nurse or assistant. Therefore, there is an additional 20-25 minutes that could provide a value-added experience for the patient.

DEIM offers a cost effective way to utilize internal information to determine the best suited information for the client to receive during periods in a normal business setting that would normally be wasted.

2. Software Functionality

Below are further details regarding possible software implementation of a system according to the present invention.

A general specification for the system can include the following:
1. Basic Purpose
2. User Interface
3. Full Functionality
4. All Interfaces to other applications
5. Third Party development tools needed
6. Hardware requirements

a) Virtual Document Storage VDS
1. Faxed Docs to be stored in VDS
2. Needs to be fully integrated with TPS 2000 and Documentor
3. All documents in office could be stored in VDS
4. Need to be able to see as a thumbnail and then blowup
5. Must be able to write on the document
6. VDS would be able to sort docs by Patient, type, data, doctor, requires viewing Y/N
7. Doctor alert screen for docs entered on their patients but not view by them
8. Doctor View screen to easily view does. Then make them as viewed with a date, time and initial the note with stylus or finger printing on the touchscreen to authorize a computer generated signature.
9. Need the ability to store and display digital x-ray in dicom format.
10. Help text will be written into the same format as currently available in Documentor.
11. Create an image of a patient chart on the screen that is 80% the size of the computer screen with tabs that can range from 5-25 different tabs on 3-5 rows on the patient chart, with user to choose title of the tab names and ability to add tabs later in usage of VDS.
12. Customized clinical progress note (i.e. SOAP note) with body diagram, multiple click boxes, with ability to use voice activation and handwriting with stylus and touchscreen click boxes and handwriting recognition with handwriting then typed onto the note as a user option to create the soap note with all the above interchangeable on the same screen so that the user can choose all, or one method of creating the note. This note will be saved by all 3, or one only methods, at user discretion: patient name, date, and provider of the service.
13. Body diagrams can be small on the overall viewing screen, but will enlarge upon one click, and user can draw on body or click on body. The user can choose in the initial setup the method of how body diagram works, i.e. click on small boxes to color in parts of the body, or simply draw on the body with a stylus.
14. Multiple choices for the user in the initial start-up and programming of the VDS will allow user to have options for method utilization and options on selections of during the creation of a clinical progress note.
15. When user marks in handwriting on a graph system within the soap/clinical record, software will translate the mark or handwriting into a sentence format when final clinical/soap note for the day is established, such as special methods for range of motion, marking of body diagram for signs and symptoms, and when clicking a box to select a predetermined sentence or paragraph. User shall be able to customize as will FHI pre-determined sentences and paragraphs in the initial set-up for use on the daily clinical progress and/or exam form notes.
16. Ability to have footnotes in very small print/fontsize appear on bottom of printed soap note if user selects such an option.
17. When printing daily clinical notes the body diagram shall print legibly on each print-out if selected that day, with handwriting also printed on body diagram.
18. When doctor user selects a tab on the patient chart, then all documents within that tab section of the chart shall appear in an inventory format with type of test named, most recent date in chronological order, and ability to check normal or abnormal, and checkmark to demonstrate reviewed by Dr and/or with patient on what date. All of the above data shall appear on a summary inventory sheet as the first page each tab section. Then user selects by clicking anywhere on the row to pull up that test and review it. User may also add into to the row of info to properly designate and title the document, or to correct data describing the document.
19. When a templated area of the daily clinical record is not selected by the user then that area shall not show up on the final saved version or printed version of the note unless user selected it to be printed on initial set-up.
20. A user's clinic may have several computers with VDS, but one or two computers can be selected as master computers to result in special pop-up boxes to appear on the master screens or special report windows to pop-up when selected by user to designate such information as: a record/report has been stored in a certain file from the fax machine holding databank, unfinished daily clinical records that doctor clicked a box or VDS system automatically defaulted too to send patient list in a pop up window to master screens to remind doctor to complete notes with said list of patient names to be in order by user choice of alphabetical or by time of day seen on that day or if unfinished notes from a previous day then by date subfollowed by alpha or time of day. The doctor should also have the ability to select this reminder report at any time by date, including previous unfinished notes from prior days.
21. VDS shall be able to integrate with other common softwares from other manufacturers such as Outcomes Assessment would integrate with VDS with OA owners, currently the ACA, which said software would be a small subsection within the progress note or exam section. This re-eval or outcome assessment form would be able to be filled out by the patient on a computer or perhaps a handheld device with patient simply selecting a box for an answer to about 10-20 questions per questionnaire (which is the outcomes assessment software), with said results to be printed as part of the clinical record or part of the patient chart as a tab section. A click box on the daily clinical/soap note could be selected by the doctor to go immediately to a special tab section of the chart which would hold the OA questionnaires and then with that tab selected the patient could be allowed to complete the patient questionnaire and VDS software would prevent the patient from selecting any other area of the chart and to be restricted to just the questionnaire page. Then after completion of the questionnaire, a box could be clicked to go back to the clinical progress note at only the doctors selection. When printing out the progress notes or the patient file, then these questionnaires would also print out by the date completed within the correct order in the chart.
22. The tab sections may also have sub-tabs such as when selecting radiology, then a half page file appears with an additional 5-10 tabs with examples of sub-tabs being: Plain film x-rays, digital x-rays, MRI, CT, US, and Bone Scans, etc. Then, under each sub-tab there would be the summary inventory report that lists the type of exam, date performed, date received/filed, date reviewed with patient, date reviewed by doctor. Also, if doctor did not review the report then the pop-up window continues once a day to remind the master screen(s) to remind the doctor that the report has been received and filed in Jane Doe's file and doctor needs to review it. It would be nice to allow the doctor to simply select the report directly from the pop-up box, review the report on the screen in one click, then check/click the box on the report document screen that it has been reviewed, which would then automatically remove that report from the pop-up window as a report that needs reviewing (since it no longer needs to be reviewed.)
23. When a fax arrives from an outside source, the fax will be stored in the computer in a “holding tank” within the software. The fax will be reviewed by a staff member, and that staff member will then file the image of the fax without printing it out on paper, into the appropriate patient chart and into the appropriate tab section within the chart. The computer should automatically recognize that when the staff member files the fax document it would be noted by the staff member at the time of the filing which doctor or doctors should be notified that they have received a report on one of their patients. This software needs to be able to select multiple providers within the clinic since three providers may be working on the same patient and we may want several providers to be alerted to the incoming report document from the fax. The alert box to the doctor should be a special box dedicated to incoming documents in which the information within the alert box would list the patient name, the type of report or type of study, and from which doctor or facility the fax came from. The alert box would have a checkmark box after the report so that the in-house provider could click the box noting that he read the report which would then result in removing that patients name and fax from the alert list of documents/faxes to be read. We need to be able to have the patient's name stay in the alert box for several days if it took a few days before the doctor had a chance to review the report, or if the doctor would be gone on vacation for a week.
24. The software system needs a special tracking system for each patient in the clinic. From the time the patient enters the clinic at the front desk, the patient would sign in electronically. After signing in, the front desk staff would have one of two methods available to them: 1) a list of every room in the clinic and a blank box behind the name of each room so that they could place the patient's name (without having to type the full name, they would simply transfer it, drag it, or it would automatically appear by clicking the box or room name since the system would have that patients' name “activated” when clicking their name as arrived from the appointment calendar when they presented at the front desk); the name would appear in that box behind the room name, so that everyone in the clinic on their own computer would know who is in which room; and a second method 2) a schematic layout design of the office would be programmed initially when the clinic bought their software, this layout design would also have the rooms named but would also visually display the entire layout. The front desk could then click the patient's name and drag the name into the appropriate room. This entire method of both option one and option two both need to be available and the consumer would choose which method in the initial setup of the software. The purchaser of the software would be required to submit the layout and a certain format to be implemented into the software or they would have to pay a slightly increased additional fee to accomplish this.
25. Once the method in 24 above is established for visual purposes, this system will allow several functions. One function is simply to know where the patient is at all times. A second function is so that the computer will time how long they were in each room for the purpose of having the computer track which rooms have a specific individual patients and how long the room was being used on average. This will tell us the name of patients that take a long time to process in the clinic as well as demonstrating which providers are taking longer times to see patients, and telling us which departments overall are taking more time. This system should be able to track which provider's patients are in room's longer, and also have a timer system so that if we want a patient in a given therapy room for seven minutes or 10 minutes, the staff person could set that timer on the computer to know how long they were on a specific therapy then the computer should also vibrate or making some type of noise to alert the therapy person that the time is up for the therapy session. Each computer needs the ability to move (drag) the patient from one room to another. If the patient is going to be in three different rooms during that visit, then each person needs to be able to drag the patient name on the computer screen into a new room, and the computer will attract how much time there in the new room. A patient might be in the x-ray room, a therapy room, an adjusting room, and massage room all in one day. If everyone's computer can see the diagram/layout of the clinic they know which room they can transfer a patient into. Another method of transferring a patient into another room on the computer screen without dragging their name across the screen would be to simply to select a room name and the patient name would then be transferred on the screen into that room. The computer should automatically defaults to a specific estimated time that the patient is expected to be in a given room. On the initial setup of the software each clinic well estimate a basic time in minutes as to the expected timeframe a person would be in each room. The staff or doctor would then click a box to start the timer. Another box would be on the screen asking if we want a video to be played with the VPEIM system. Then the staff person could select one of three choices regarding the video education system. 1) One box would say let the computer choose the video or 2) the staff person could manually select from a list of videos that the computer selects based on the patient's diagnosis or 3) the staff could look at a huge master list to select the appropriate video.
26. Some of the ancillary staff need access to only parts of the VDS software as well as the information that is pulled from other software (e.g. HIPAA Compliant TPS 2000 practice management software available commercially from EON Systems Inc., 620 Lakeview Rd., Clearwater, Fla. 33756). For example, a small handheld wireless PDA type device would have a list of rooms within the clinic and the name of each person in the rooms. The software should be designed to select which rooms that specific PDA will display. Instead of showing an entire hospital or a huge clinic, perhaps the staff person only needs to know 10 of the rooms rather than all 30 rooms. That staff person may only deal with a certain section of the clinic. It is important for certain staff people to not have to carry a notebook but rather a pocket PDA. The minimal information that needs to be transferred via a wireless connection to the PDA is the: 1) patient name and 2) the room they are in, 3) as well as the soap note/body diagram for that day. The clinical progress note/soap note needs to show the body diagram of where the therapy is to be placed on the patient. The staff also needs their PDA to access the prior visits' note for that patient to see where was the therapy applied on the last visit if the doctor did not already mark on the body where to place the therapy. This basic information is needed so that the staff person knows where the patient is in the clinic, and the staff person has the ability to transfer the patient from one room to another room on the PDA, and to mark on the body diagram where the therapy was placed and to mark which therapy was performed. The PDA must also show the body diagram where the doctor marked on the body where to place the therapy if the doctor saw the patient first on that given day. The PDA must also show the timer designating how long the therapy is currently on a patient and a beeper noise to be elicited when the timer is up so the staff person knows to go to a certain room to take the therapy off the patient. It should also have the patient's name blinking off and on in that given room on the design layout to designate that the therapy session is over. All of these functions described above need to happen with great speed and simply take less than two seconds to go from screen to screen.
27. The staff person also needs to be able to receive a message from the doctor or from the front desk through the PDA. If there is an earpiece or headset attached to the PDA this message could be a one minute voice message or it could be a text message. The PDA needs to serve as a pager either through a beeper or through an instant message pop up box for such things as “come to the front desk”, “you are needed in the physical therapy dept”, “patient needs to be escorted from the front desk”, “Dr. Smith needs you now”.
28. When reviewing the clinical progress note or any section of the patient charts, the doctor needs the ability to transfer the image, report, x-ray, daily progress note, or document to a larger screen mounted on the wall in that room. While the doctor might be using his notebook, he may want the document on a large-screen monitor 1 TV mounted on the wall for better viewing for all those in the room. Therefore the x-ray may be transferred not to his notebook but to the large-screen in the room, or to both. There may be times during the creation of that day's clinical progress note, that the doctor does not want that data on the large-screen on the wall because he may not want the patient to view it. There needs to be a simple click button method to eliminate the image from the wall screen, something similar to PowerPoint presentation when the image is going to be on both the monitor projector and the laptop. It should not require more than a USB connection and it should be a simple click of the button on the notebook to cloak the image on the large-screen with something else or nothing at all.
29. Their needs to be multiple templated forms that can be accessed by a click of a button from one simple screen for such items is: Exam form, work excuse, school excuse, or any other form that the Documentor may create, but the VDS can access it quickly and through a simple click button section without going through several screens.
30. On the patient chart image on the computer, not only should the patient name be largely displayed on the cover of the chart, but an area for the patient's photo should also be on the cover of the chart. One of the tab sections inside the chart should have basic demographic data that can be extracted from TPS 2000 and automatically placed into a templated form that takes that data and permanently locates it into a designed format summary form, unless that data changes in TPS 2000, and it would automatically change in the patient chart. For example, inside the patient chart, the first section may display the patient's address, phone numbers, children, age, allergies, etc. This data would be taken from initial insurance information from TPS 2000 as well as from specific forms on the computer that the patient would initially fill out on the first visit coming into the clinic. Special update forms regarding medications and allergies would be completed annually and would then translate this data into this special summary tab of the patient chart.
31. Initial patient intake forms would be templated on the computer and the data would be typed by the patient or a staff member. This information would include insurance benefits and some info that was initially entered by the insurance Department in TPS 2000, plus info from intake form would also have address and contact information as well as the employer information. A short family history on important data such as surgeries, allergies, even a medication sheet would be automatically created from extracting this data from other forms completed on the computer by the staff or patient and placed into a specific format to be designed in one of the tabs of the patient charts.
32. Numerous additional features to the clinical progress note will be created with the focus on chiropractic office visit, the physical therapy office visit, and a standard medical office visit. There will be three standardized main templates with numerous offshoots into subcategories of visits. This will allow for the multidisciplinary clinic to function using the VDS system. These features pertaining to proper clinical documentation and the needs of the physician to adequately document the encounter.

b) Video Patient Education and Internal Marketing VPEIM
1. Needs to be fully integrated with Documentor and TPS 2000
2. Make it able to run stand alone as well
3. Would contain a library of 100+ video clips or 1-5 minutes in length
4. Videos would be placed in categories. i.e. All neck videos together
5. Need to be able to easily purchase and download videos over the internet
6. Need to be able to purchase and install certain selected videos
7. Doctor can construct Video sequences to play to patients. They can be for a single visit or multiple visits. One video or multiple on a single day
8. Doctor could look at a list of videos to play a customize them on the fly
9. VPEIM would remember which videos it had played and which ones didn't complete playing due to doctor stopping. The one that got stopped would be played again on the next visit or immediately if the doctor told it to play.
10. Doctor must be able to alter play list probably from Documentor. He must be able to queue up the exact video he wants to play and have it start playing in less than 30 seconds.
11. Must maintain a list of videos viewed and when.
12. If a video was clinical in nature and not promotional then it would select certain items to be placed in the patients document or daily soap note
13. Front desk must be able to select a video or videos to play in the room a patient is going to
14. Must warn if there are no videos queued to play or go to a default play list. Must check the default play list against what has recently been viewed by the patient and select a video that has not been seen in a specified time or visits.
15. Must be able to tell TPS 2000 that the patient is on the way back to the treatment room. Then delay a predetermined about of time say 30 seconds and then start the video
16. There could be an automatically selected video mode. This would check to see the current diagnosis and then select a video from that category. It would have to check to see which ones have been seen recently and show the one not recently seen.
17. Need the ability to run multiple monitors running videos in the same room. Then need to be able to control each one of them from either a computer station or from a Table PC running Documentor. Change videos, restart, stop, pause 18. Help text will be written into the same format as currently available in Documentor.
19. See #24 and #25 in VDS section to allow video selection via room and patient.
20. The computer must track which videos a specific patient has already seen so as not to allow that video to be replayed unless it was manually selected to be replayed.
21. If a video was stated and it was not more than half way complete when video was interrupted by the doctor choosing to stop the playing of the video, then the computer would replay that video on the next visit.
22. The video to be played will be selected by the computer based on the ICD-9 diagnostic Codes, with the first primary diagnosis choosing to video first. The second ICD-9 Code would then play a video on the next visit.
23. The software will keep track of which videos have already been played so as not to repeat the same video twice within a selected timeframe. A video may be played twice if a certain number of weeks has passed or a certain number of other videos has played in between since the first playing.
24. The computer will look at several demographics when selecting which video to play for a patient in regards to marketing videos. For example, the computer software will look in the billing section of TPS 2000, and the software will be programmed to look in any standard software that has billing demographics to select a video based on patient's age, number of children and the age of those children, race, male or female gender, and diagnosis. If a black female age 50 with two children who are adolescents were in a room, the computer would select videos such as sickle cell anemia, scoliosis checkups for children, or possibly menopause videos.
25. The computer will also randomly select marketing videos based on the above demographic screening and play educational videos dealing with the diagnosis for two or three visits but then on the third or fourth visit the computer would play a marketing video which has nothing to do with the patient's diagnosis. The computer would play the marketing video featuring other services that are provided in the clinic. Therefore, the software would tag certain videos as to the type of video; a purely educational video, or and internal marketing video, and perhaps a third category to be determined in the future.
26. Other methods of selecting a type of video should also be anticipated that has nothing to do with health-care. The software should be designed to expand into other industries such as auto mechanics or education levels or job classifications, and etc. The demographics could be things other than what is in TPS 2000. It may be demographics unrelated to health-care. This would allow VPEIM to be expanded into other industries.
27. Basically, we are creating software that is scanning multiple pieces of demographic data about an individual's background, health, their life's interests or experiences, and anything that is a descriptive fact about that persons life, and their individual interests in things that are important to them. After the software is able to scan these pieces of data and sort them together, it will select an appropriate video to play for them that is to be of high interest to that person, or they would be motivated by the marketing piece to stimulate them to purchase or select a service or product based upon the information received within the video clip.
28. At the beginning of each video the software needs to be programmed to display a specific clinic logo or clinic name at the start and ending in each video if selected in the initial setup of the software by the client purchasing the software.
29. The software needs to be designed in a way that a Doctor could change the menu of videos to be selected. Although a master list of 100 videos may be loaded into the software, a doctor needs the ability to select which videos out of those 100 that he wants to be selected for his rotation of videos. The doctor also needs the ability to group the videos into subsets and name those subsets so that on the computer screen there might be a list of 10 subsets, allowing the doctor to select a box clicking which subset he wants to choose, and then a list of 10 videos within that subset may pop up. The doctor needs to be able to design his own subsets.
30. The clinic can insert other videos that they may purchase, as long as it is in a certain digital format or DVD format that the could then be downloaded into the software. If that Doctor purchased that visual DVD or video then that Dr. would have the rights to insert his own separately purchased video into his clinic VPEIM software only. Their can be a simple, user-friendly setup screen as well as a review of the video library and a method to insert or deactivate specific videos.
31. As outlined in number 28 above, a specific video then needs to be tagged several ways: 1) the video needs to be included in a certain subset, 2) it needs to be marked as a internal marketing video or a patient education video based on diagnosis or 3) other categories that we may determine later.
32. If a patient is going to be in a room for a certain time, then the computer may select two or three of videos to play if it's going to be a 10 minute wait. The software should be able to handle up to a 15 minute video. Occasionally there are 30 minute videos out there than these would not be played on a frequent basis nor would they be in the rotation. These would be more of a manual selection for special circumstances.
33. The front desk needs to be able to see how much time is remaining on a certain video as the patient is watching it in a specific room. Or the doctor on his computer screen would show that the patient is again a specific room and watching a specific video. The doctor needs to know the title of the video that they are watching even though the doctor isn't and that room at that specific time. The doctor could look at his notebook computer and see who is waiting for him in which specific room in which specific video are they watching and how much time is remaining so that the doctor may choose to stand outside the door for 15 seconds before walking into the room.

c) TPS 2000 Appointment Book
1. Have the option of having “ ” instead of the Patients Name when there are multiple time slots being blocked off.
2. Appointment statuses enhanced to show missed, reschedules, cancels, moves etc and who changed the status and why
3. can have a past appointment history report with when they were in and which doctor did they see.
4. Make a simple process to make an appointment where one does not exist
5. Display who made the appointment

d) TPS 2000
1. Make Diagnosis doctor specific in TPS 2000
2. Add ability to select treatment room on the schedule book in TPS 2000
3. Add treatment room to the appt form on Documentor
4. Wants to be able to print appointment reminder cards
5. Make it so the computer will make a spreadsheet for physicians meeting. It must incorporate a spot for the Patients Name, Doctor, Diagnosis and how often they must be seen for Physical Therapy. It also must include a list of the new patients coming in for the next week. Once a patient is discharged the name is automatically moved to a discharge file or list.
6. Wants pop up warning messages
7. Custom statistical analysis report on CPT code categories and providers
8. Enhance claims area to allow for multi-disciplinary co-pays and percentages on visits with a common ledger
9. Have a digital sign in and be able to store signatures

e) Documentor
1. Select which Diagnosis go with which services when services are selected as part of a note.
2. Clinical Daily record. A small body diagram could also be printed out in the clinical daily record showing where the therapy was applied. It could be a simple list or report but it gives the staff a clear idea of where to place the electrodes. It could be transferred to the Tablet PCs the staff person might have so they know where to apply the therapy.
3. A treatment plan form that is customizable up to the minute by the doctor. It would show what services were supposed to be performed and a place to click off the services that were complete. When completed the service would be sent to TPS for posting. Would also need a same as last visit button to create the treatment plan. We want to create a treatment plan many visits into the future to follow. Then it would have the ability to save numerous plans for future use.
4. If double click on patient name on appt form then it goes to the notes creation screen and either recreates last visit or starts a new SOAP. This would be user definable as to which it would automatically do.
5. Add a body diagram that a doctor could draw on. This would be a new type of insert.
6. Add a graphical insert that you click on a list and it puts in a certain picture. Could be used for signatures.
7. After a document is printed ask if they want it locked so that it can not be changed without an edited note.
8. Lock documents so that only the provider who wrote the note can edit it at all.
9. If patient watched a video then the video software would tell Documentor so that was already selected when a note was written.
10. Add run inserts to a completed document. In other words select an insert location and click on add insert. Then pick from a list of “stand alone” inserts. Then the insert would run and put text in the doc.
11. Ability to transmit notes to another provider.

Following is additional description regarding possible software functionality. Software innovations:

When a record or document is faxed to the clinic from another health-care provider, the staff person would then take that document and scan it into the patient's file in a section appropriate to the documents. For example, an MRI reports would be scanned into John Smith's file under the radiology tab.

Immediately after this document is entered into the appropriate section of a patient's record in the computer, a flag or a report would be generated at the treating doctors computer to let that treating doctor know that a record has been entered into the patient's chart in the computer. This will allow the treating Dr. to review the scanned reports. For example: in the left-hand side of the screen a list of patient names would be provided, that had lab work, radiology reports, or other records from other sources entered into their file; these names would be listed with a box in front of their name. The doctor could then simply click their name and the record that was scanned into the chart would immediately appear to be reviewed. The doctor could then check the box knowing that he had reviewed the record and then the record would have his initial computer generated onto it into noting that he had reviewed the record. It would need to be made so that if multiple records were entered into the same patient's file, then that patients name might appear two or three times in a row since a lab report, a radiology report and a narrative report may have all been entered into the chart that day. So the list of patient names or the report that is generated for the treating Dr. would have the list alphabetically by patient name and then after their name or immediately underneath the name, would be which category of the patient's chart that the document was entered into such as radiology, lab, x-ray, etc.

The diagnosis for a given patient needs to follow the provider who gave that diagnosis in the billing screens. For example, if John Dell has four diagnosis codes on a given visit by Dr. Jones, then on the next visit those for diagnosis codes should be automatically in the billing screen from last visit. Here's where the current software does not allow for that. If John Dell has seen three different providers on Monday and those three providers all each have separate or different diagnosis codes for example, the medical doctor may have four diagnosis codes relating to diabetes, heart congestion, psoriasis, and carpal tunnel syndrome. The chiropractor may have diagnosis involving neck pain, low back pain, muscle spasms, and facet syndrome. The physical therapist may have diagnosis involving knee sprain strain, patellar tendonitis, back sprain strain, and gait imbalance. The insurance staff person then enters in the diagnosis codes by provider chiropractor, and then immediately after she wants to enter in the services provided by the physical therapist but needs to change the diagnosis codes to match up with the physical therapist services. It would be much easier for a multidisciplinary clinic to have the diagnosis codes not only be tracked by the patient's last visit but by both the patient's last visit and the specific provider. This way, when the staff person then clicks Dr. Jones, the medical doctor, then the four diagnosis codes that were used by Dr. Jones would automatically appear in the screen fields that Dr. Jones last used on the last visit. Then as soon as we click a different provider for the same patient, then the diagnosis codes would automatically change by themselves to the last diagnosis codes used by Dr. Smith, the chiropractor.

Using the documentor software, when the provider creates the soap note, the top 10 or 20 services available to the provider would be automatically on the screen with a small box in front of the service. The services would be abbreviated with three or four letters. Once the doctor clicks the box to do note that the service was provided on that day, three things need to happen as a result of clicking that box for that given service. The first thing that would need to happen, would be that the front desk would receive the information that the service was provided and transfer that code into the billing portion of the software as a charge for that day. This will allow for the front desk to know which service was provided and the billing would be automatically entered in to the insurance section of the software automatically from the documentation software. The only item that would need to be clicked after the service was marked would be which diagnosis the service follows, in terms of diagnosis one, two, three, or four. A window would pop up next to the service requiring the doctor to click the numbers one through four. The second thing that would happen as result of clicking the box for a specific service provided that day would be that an automatic templated sentence or paragraph describing that service would be automatically entered into the soap note. The computer would have a choice of 10 or 20 different ways to describe the service and which body part the service was provided such as a wrist or a knee; and the method in which the computer would select which description it would choose would be based on a body diagram next to the services that the Dr. would then click an area of the body that the service was provided. For example, if an ultrasound code was clicked, then a body diagram next to the services would need to be click on a certain body part in order for the computer to know which description to give; such as a small box on the right shoulder would be clicked and then the paragraph would be automatically typed into the soap note about how the ultrasound was performed over the deltoid muscle. This small body diagram could also be printed out in the clinical daily record showing where the therapy was applied. This isn't a high priority to print out the body diagram, but it gives the staff a clear idea of where to place the electrodes. It at least needs to be transferred to the Palm pilots in the staff person might have so they know where to apply the therapy. The third thing that would happen by clicking the service would be whether the service had already been provided prior to the doctor being in the exam work treatment room with the patient or whether the doctor was simply ordering the service to be done that day but it would be performed by a staff member. The staff would need to know if the service had already been provided even though the doctor was clicking the service code because he was ordering it to be done that day. A clicked method would need to be established such as another box behind the service that would denote that the service was done or if the second box was still open then it would mean the service was not yet done by the staff. This way, if the staff had a Palm pilots in the therapy day they could see you what the doctor wanted for therapy that day and they would also see where on the body the doctor wanted the therapy by the body diagram and they could apply the therapy without the doctor having to describe it to them exactly where he wanted the electrodes placed oral exactly where he wanted the ultrasound performed, they would simply just have to look at their Palm pilot and look at the body diagram to see where they wanted the treatment applied. When the staff person was finished with the service they could simply click done on the box after the service and realize that the patient was finished for the day once all of the items that were selected by the doctor had been completed for the treatment session. The other feature that would be essential in this case would be if the treatment is identical to the last visit or to another visit prior to the last visit, then the doctor could click one box with the last visit date and all of the items would automatically be checked except for the completion “done” box. It could even be made that the staff or the doctor could go through the list of patients scheduled for that day and go into their soap note and mark what services the doctor was anticipating to be performed for that day, and then the staff could simply apply some of those therapies even before the Dr. entered the room for the adjustment. None of these services would be charged up in the insurance screen until the box marked done was clicked.

Another option is having the patient's sign in on a computerized sign in sheet. This signature would then be transferred to their patient record for that day and would be a part of that day's soap note signifying that they were in fact in the clinic.

Because we are going to a completely electronic file there would be no file or travel card placed in the door of the treatment room. The Dr. would then be unaware of the patient in the room prior to opening the door. It is extremely important for the doctor to know who is in the room before he walks into the room. Therefore we need a method to make the doctor aware of who is in which room. The front desk would have a schematic layout of the entire office specific to the different rooms that patient would go into. The front desk staff would have the appointment scheduler on their screen and then they could drag the patient name into a specific room or just simply click a code as to which room they are putting the patient into. This info would then be transferred to the doctor's tablet and a small pop-up box in the bottom left corner would make the doctor aware that Eddie Jones is in room two and Bob Smith is in room three. That would stay on the document or tablets so the doctor knows who is in each room until the doctor clicked that name to remove it from the screen resulting in the patient info popping up after clicking the patient name. Therefore, after the doctor clicked that patient name prior to walking into the room, a soap note template would automatically appear so he could begin creating that day's clinical record.

A body diagram can appear on each daily clinical note. The doctor needs to be able to draw onto the body diagram by either coloring in a section of the body diagram or drawing a squiggly line down the arm from the neck or even making notes alongside the body diagram. When the clinical note is printed out for the day, this body diagram and any notations or drawing on it would also printed out. The size of the body diagram would be approximately 2 or 3 in. tall. This body diagram is separate and distinct from the smaller body diagram used in the therapy locator section described previously.

The clinical soap notes or the templated formats for the documentor would also follow a similar pattern as my currently designed soap note. The Dr. would have the ability to either dictate with voice activation into certain areas of the notes or the doctor could hand right on the tablets in certain areas of the notes. And of course, the doctor could type into certain areas of the notes. The other areas would be boxes that the Dr. would check and by checking these boxes certain sentences or paragraphs would be automatically printed into the clinical record. In order to create a variety of macros describing the same thing, we want the computer to check the last one or two notes to be sure that a different method of describing the items would be selected by the computer. In essence, were talking about a randomized selection, but the computer would make the selection rather then requiring the doctor to select which macros he wanted.

The ability to integrate the document or software with other software's net deal with patient records would also be important. For example digital x-ray software that captures the image of the x-ray would need to be imported into the patient record. There is a standardized format using dicom systems for digital x-ray images. In addition, there is a copyrighted software put out by the ACA for outcomes assessments. There are about 25 patient assessment surveys regarding the different joints of the body and functional activity questionnaires that the patient would actually fill out on the computer and then the computer would score the survey. The ability to score and save the results of this questionnaire into the patient record is very important. These outcome assessment tools are used by more than 50% of all PCs in the field and are highly recommended in the medical field. The ability to have the document or software integrate this is beneficial and creating the ability to have patient access to fill out without allowing the patient to access other parts of the software. The ideal situation would be for the front desk staff to have the questionnaire up on a monitor either in a consultation room or any actual treatment room and the patient would stay in their and complete the questionnaire before the doctor enters the room. They could do this prior too, or while waiting for their adjustment. These questionnaires are usually completed on a progress examination day or the doctor may choose to have them periodically complete the form in between progress examinations in the middle of the month.

Once the doctor completes a form on behalf of the patient such as a work excuse form, a sports excuse form, or a disability form for FM LA, these forms should be already loaded in the software so that when the doctor does complete the form he can hit a button to print the form for the patient at the front desk and the form would also be stored in the appropriate section of the patient charts since the computer would know where to store the form based upon the title of the form. The computer should have 80 simple select button entitled patient forms and the doctor could click this icon or marker in the document or software and by clicking this a list of forms would appear. The Dr. would then select which form he wanted to complete on behalf of the patient. All forms should have a box in front of the name of the form on this list so that the doctor can click the box resulting in the form popping up all into the screen with all of the pertinent data already filled out based upon which patient filed you are in. For example if I was in Bob Jones's charts or file, then when I selected the box in front of him he given form then when the form appeared in the screen it would already have printed Bob's name on the form as well as today's date, and my name would already be typed at the bottom of the form since I am the provider. If a different provider in the clinic clicks the form then that doctor's name would already be typed at the bottom of the form. An electronic signature would also be available on any form in the doctor could click a button at the conclusion of completing the form denoting that it was completed and when he hit the signature button that would indicate it was completed and ready to print at the front desk. Rather than have to hit all these multiple buttons by simply hitting the signature button it serves three purposes. One, it signifies by authorizing the electronic signature that the form is in fact completed. It then automatically stores the form completed in the patient file in the appropriate section of the file. It also automatically would print at the front desk since they will need to give the form to the patient. If the doctor realized after printing the form that he wanted to make a slight change to the form while the patient was still in the office because he discovered he wanted to place additional light duty restrictions on the patient then the doctor could simply access the form in the patient charts and make the changes to its by modifying the form in the computer would allow that to happen without changing any date or signature in the doctor could hit reprint button for the form.

With all records in the patient charts, the ability for only the doctor to make a change to a form that was filled out or to the clinical record should be made available for only the doctor's discretion. Examples would be that the doctor would complete the clinical record in the room with the patient but then at noontime or later today the doctor wishes he would have added more information but just didn't have the time during the patient encounter. The doctor at the end of the evening to go back into the record that he completed is being done earlier in the day and could add additional information that was verbally exchanged between the doctor and the patient. The date on the record would need to stay the same and not have the computer glitch of changing a date especially if the doctor added to the note the next morning. In addition to attaching information to the clinical record for about given day, any information that the doctor discussed regarding exercises, home treatment recommendations, or simply discussing and educating the patient on the condition on ergonomic considerations or utilization of a brace or how to lay on a fulcrum for the neck or how to sleep properly and any other activities of daily living recommendations would need to be templated and added to the clinical record. For example, if the patient viewed a video showing the patient how to perform certain exercises we would want the software to automatically print a paragraph describing the exercises that were instructed to the patient; or if the patient was instructed on how to sleep properly with a cervical pillow and how to put a pillow between the knees, the software could simply describe all of this by simply clicking the box on the clinical record. Even better, if the patient watched a video educating the patient on these topics prior to the doctor coming into the room, the computer would note that they watched that video and this would signal a paragraph to be automatically added to the clinical record so that it was documented in the chart that the patient was given information on the following subjects.

Having the overall software integrated with a video patient education and internal marketing component is also a main feature that could be added to the existing TPS 2000 software. Approximately 100 to 150 different one minute to three-minute in length video vignettes could be produced on subject matter relating to different health conditions and subjects discussing other services provided within a given clinic. The doctor purchasing the software would have the ability to select which video vignettes he would like played in his arsenal of educational tools. The doctor would have a list of these videos and he would select which ones he once in his rotation. For example, if the doctor did not provide orthotics to his patients he would not want a short video talking about orthotics to patients in his clinic. In addition to doctor may want to customize and make his old short videos and we would provide guidelines and timeframe parameters to do so. Once he produced these videos we could then insert them into the video rotation. They would have the ability to create this locally or our company would create them for him and he could come and we would video tape him in a professional setting. The doctor may also want to have his voice as the video narrator uncertain subjects rather than our hired narrator. Therefore every single one of the video vignettes could be customize to a given clinic, obviously they would get extra charge for this. The method of playing to videos for a patient would give the doctor a few options. One, the doctor could specifically select that video while in the room with the patient in the patient could viewed the video as the doctor left the round at the completion of the visit in the patient would sit there and watch the short video. The computer could document and remember that the patient saw this specific video so that the computer would not play this video again for the patient until several visits later. We would not want to show the same video in the next one or two visits. We also could want the computer document or software to document in the clinical record for that day that the patient saw the video to document that the doctor discussed the subject matter with the patient as long as the subject matter was clinical in nature and not a promotional piece for additional services. Another method which would be desirable would be for the front desk to select a video prior to the patient entering a specific treatment room. Here is how this situation would ideally work: when the patient checks at the front desk, the front desk would collect the name of the patient and then mark which round the patient is going into while waiting for the doctor. So if the patient goes into Rwanda the computer knows that they will start to play a video in approximate 30 seconds or less. It would take less than 30 seconds to the patient to walk from the front desk and to be seated in a given treatment room. The front desk staff could select the specific video or even better the computer would select the appropriate video for the patient based on the following criteria: the last primary diagnosis code used on the patient would select from a handful of videos on that diagnosis. The computer would remember which video the patient saw on their last visit to be sure not to replay the same video. We may even consider playing five-minute videos not for the treatment room but for the therapy bay. A monitor would be in each treat room as well as above each treatment bay bed. The patient is laying on a table receiving electric stem or some other therapy they would be watching a monitor up on the ceiling or while waiting in the treatment room they would be watching a monitor attached to the wall and the treatment room. When the doctor walks into the exam room in the patient is in the middle of video would want the ability for the doctor on his tablet to stop the video from playing in the computer would remember where in the video it was stopped so that on the next visits the video would resume playing not necessarily at the exact spot that if the video had just started the software would simply replay the video or if the video was more than 75% completed it would not replay that video again until a few visits down the line in the treatment plan. The important aspect of this portion of the system this speed of the delivery of the video vignettes to the room in which is being played. It is essential that from the time the front desk clicks the patient name to go into a specific room that the video would start playing within 30 seconds or sooner. Some of the videos may be instructional videos and they would be longer in length such as the five minutes described earlier. These may or may not be played in the actual adjusting room but rather a separate room such as the consultation room or a specialized room designed for this purpose. For example there are numerous things that a doctor repeats over and over every day in practice. These items of the type of videos that may need five minutes of instruction but they could be a videotape of the doctor describing the proper application of sleeping a cervical pillow or what ever. The method in which the video would be played would need to be extremely clinic for the software because it takes about a minute to get the video queued up to play; the doctor should just as well as described the instruction to the patient due to the length of time to queue up the video. It is expected that the doctor selecting these videos would need to invest in significant hardware applications to allow for the speedy transfer of the video components.

Other options relate to appointment scheduling software. Rather than repeating the patient name from one box to the next in a situation where the patient is scheduled for half an hour and the appointment boxes are 10 minute increments, the patient's name could be repeated three times in three separate boxes. It would be better to have the patient's name in the first box only with ditto marks on the second and third box. Otherwise, a quick glance at the schedule her makes it appear that there are different people jam packed into the morning schedule. It is more relaxing psychologically for the staff not to see it all jam packed such is not because it may affect their mind on how to schedule. They may be more reluctant to squeeze a person and what it looks like all these names are in the schedule in reality there isn't as many human bodies actually present. The appointment scheduler could track statistics in regards to missed appointments and to provide more reports on this data. If the patient was late for an appointment would currently have to go into the patient demographic file to extract their phone number. The patient's name is clicks or highlighted on the appointment schedule her some simple demographic data should automatically be placed on the same screen as the appointment schedule her especially the phone number so that we can call them immediately if they missed the appointment. Having a message file a patient permanently would also be advantageous. The message box at the top of the scheduling screen could have a message to follow the patient permanently. Right from the scheduling screen, the staff could enter in a brief message on a patient and allow that message to stay in that MessageBox permanently unless the staff decided to delete it. Having to go to another screen to into the message is cumbersome and not realistic. There would be an ability to access the MessageBox right from the scheduling screen. There might be special circumstances on the patient's regarding “never put them in the treatment room first” because they might want therapy first and they insist upon it. We could have a message automatically following the patient without having to click another box to force the message to pop up, we could have the MessageBox to automatically display the message to the staff so they would know they need to place therapy on the patient first before putting them in the treatment room.

When a patient's name is highlighted on the scheduling screen or the name is clicked upon by the staff, a small window should automatically pop up in the bottom right hand corner or up in the demographic region above, regarding the charges for the day without having to go into another screen. If the patient's name was clicked and they had not been seen yet, the charge box would simply not appear, or if it did appear it would have zeros in it showing that no services had been provided yet. There could also be a box that could be clicked by the staff that would say: any additional services? The reason for this would be if the doctor forgot to click certain charges that were provided, that the staff knew it was provided, they could then add the service for the days charges. For example the doctor may have told the patient to get a multivitamin at the front desk but the doctor did not click that service because he had already exited that patients record and was standing in the hallway when he mentioned it to them. The front desk needs the ability to add services to the charges by only a few clicks rather than going through multiple screens. This whole concept of marking up charges is essential. And then when the charges are marked up, the computer needs to automatically document some type of a paragraph or a templated sentence into the patient's clinical record that they actually received that service. It could also have the ability to not charge for a given service on that day. Even though the service may have been provided the doctor may have decided not to charge a specific item. Some method of documenting that the service was actually provided still needs to be in place in the clinical record but the charge may be zero and technically not even show up on the billing. If the service isn't charged it is better not to even have the service on the billing, especially to an insurance company as this would affect the usual reasonable and customary values when they calculate their averages since it was a zero charge.

Regarding the appointment scheduler, in addition to what has already been previously supplied for recommend changes, the ability to attach a message that would permanently stay with the patient name and a message box prominently viewable without having to click a button or without having to click a window is needed. The ability to go back and delete a blocked timeframe is also possible; for example, the doctor might be blocked out from noon until two o'clock so that no appointments could be scheduled. However the doctor may change his mind and extend 15 minutes into the lunch hour for 2 more appointments. The staff has no immediate or easy ability to change this. It could be a simple one step process to allow the staff to open up certain time slots that had been previously blocked out. Detailed reports going over missed appointments, reasons for missed appointments, could be generated and accumulated. The computer could have a simple way of documenting who made the appointment by placing the users initials very small in the bottom corner of the box of the appointment name. That way if somebody cancels an appointment we would know who made the original appointment. More specifically, when a staff person actually cancels an appointment, we need to know which staff person made the cancellation without completely eliminating the patient name from the box. Some record could be made that the patient did have an appointment but it was removed from the schedule. The reason why it was removed, as well as who removed it from the schedule all needs to be documented in a simple format. The computer should automatically do this based upon whoever's logged in at that station.

The billing component could also have the following features. Statistical analysis of collections by multiple CPT code categories by each individual provider could be accounted for. We need to know how many nutritional sales one Dr. provided versus another doctor. We also need to know how many injections the doctor provided on how many separate patients. The doctor may have provided five injections but all of them on the same patient. How many patients actually received injections? How many overall injections were provided in that month? Orthopedic supports could be categorized as one whole lump category.

Nutrition could be categorized as a separate lump category by provider. Daily statistics as well as monthly reports regarding how many services were performed by each individual provider and under each individual category of CPT codes. The ability to lump a few CPT codes into one category could also be important. Having the freedom to lump two or three CPT codes because they are closely related, could be allowed for. Or if a given clinic wants to keep each and every single CPT code separately in regards to the dollar amounts and number of services provided that month under that one CPT code, they could have that ability as well. Certain providers are paid differently by category and it is important to allow statistics to be kept by service or CPT code. The providers are also usually paid on the collections in those areas and therefore we need to know what they collected in each department or CPT code by provider. Some services are provided by a facility and not an actual provider. Certain codes may also be accounted towards the facility rather than individual provider. Another feature could be to track different percentages of coverage for each provider on the same patient. For example, the patient may be seen by three different provider types, i.e. MD, DC, or PT. The medical doctor might be covered at 80% coverage for the patient with a $15 co-pay for visits. The chiropractor may be covered at 70% with no co pay for visits. And the physical therapist might be covered at a $25 co-pay for visits. These three different levels of coverage or by the same insurance company on the same patient but have different coverages based on the provider tight. The computer needs to know that when a physical therapist provider is providing services for their coverage amounts are based upon the physical therapy coverage and not the medical coverage. This would be advantageous if doing business with integrated practices.

3. Example of User Manual for VPEIM

Following is additional detail about how an exemplary embodiment would be operated and how an end-user might be instructed in a hypothetical user manual how to operate the system. This is intended to give further exemplary details on how to make and use a system according to aspects of the present invention. Variations are, of course, possible.

a) Video Patient Education and Internal Marketing Module (VPEIM)

The VPEIM module will provide user screens which will allow the user to manage and maintain the showing of various types of media to patients for both educational and marketing purposes. The Now Show icon (film strip) will launch the main monitor interface for media that are showing in the office. Clicking this icon will also bring up the Media Maintenance bar which has an icon for Media Maintenance (wrench with film clip) and Manage Patient Playlist icon (buddy with film clip). The top level interface of VPEIM will appear as follows:

The ‘Now Showing’ icon (film strip), ‘Media Maintenance’ icon (file strip with wrench) and ‘Patient Playlist’ icon (buddy with film strip) will launch their respective screens as detailed in sections 2.6.1, 2.6.2 and 2.6.3. The schematic hardware diagram for the system is as follows:

The Now Showing screen displays a list of which media are playing in which room and for which patients. The Now Showing screen will appear as follows:

The Now Showing screen will behave as follows:
1) The main grid at the top will populate based on the data stored in the database by the Chart Interface (Section 2.4) [patient code and room number] or a compatible scheduling program, such as TPS 2000. The video(s) assigned to that patient (see Patient Playlist Maintenance in 2.6.3.3 and 2.6.3.4) will queue up and begin playing after a certain number of seconds, which is preset by the user from video options (see section 2.9.3).
2) The upper grid will have the following columns of data: Room (room that the patient was assigned to), Patient (last and first name of patient), Feature Title (name of media item that is playing), Time Remaining (playtime left for this media in mm:ss format), and Status (the state of the current media: Playing, Paused, Stopped, Viewed, Pending, Continued [from last visit]).
3) The Time Remaining column will update every 10 seconds by default but this refresh rate can be set through the video options screens (see section 2.9.3).
4) The grid will sort based by clicking on the header titles for Room or Patient.
5) The Pause, Play and Stop buttons will control video playback of the selected row and update the status column appropriately.
6) The fast forward button (“>>”) will move the video forward and update the Time Remaining column appropriately. The default fast forward rate is 10:1 but can be set from the video options screen.
7) The Rewind button (“<<”) will move the video back and update the Time Remaining column appropriately. The default rewind rate is 10:1 and will be adjusted by the same setting as is used to set the fast forward rate in the video options screen.
8) The Change Room command button will bring up a drop down listbox which will allow the user to change the room assignment for the selected row.
9) The Remove command button will remove the selected item from the main grid and also remove it from the patient playlist. A warning will be issued to the user if the media item selected for removal from the patient playlist has already been viewed.
10) The Select Title command button brings up the Select Title screen (Section 2.6.1.2), which allows the user to manually pick a media item and queue it up for playing.
11) The ‘Media Details’ button will launch the Install/Edit Media Screen (section 2.6.2.1) with the details for the media in question loaded up.
12) ‘Send Associated File’ button will bring up a dialog which will allow the user to print, e-mail or FAX the “associated file” (which would contain text and key images from the video) to the patient.
13) The “Edit Patient Playlist” button will bring up the Manage Patient Playlist screen (Section 2.6.3) initialized with the data for the selected patient.
14) The bottom grid will show a list of the videos on today's playlist for the patient selected in the upper grid (with the play status of the each item). The columns included will be Feature Title, Duration (the length of the media playtime in mm:ss), Status and the view date or expected view date. The grid will scroll down and highlight the first media on the list that has not been viewed yet.

The Select Title screen is launched by the Select Title button on the Now Showing Screen and allows the user to select a title from the full media library. The Select Title screen will appear as follows:

The Select Title screen will behave as follows:
1) The Media Library grid will be populated with the entire, available media library (see Media Maintenance in section 2.6.2 for adding media into the media library). The columns of the grid will be: Title (the title name assigned to the media item by the user when the media item was installed), Type (video, poster group, audio, poster), Purpose (Educational, Marketing, Experimental), Category (primary category for this media, such as Neck, Back, Favorites, etc), Duration (length of the media play time in mm:ss format).
2) The Media Library contents can be filtered by media Type, Purpose or Category by using the drop down list boxes at the top of the grid.
3) Clicking on the Title, Type, Purpose or Category header columns will sort the grid by that column.
4) The Select a Patient edit box will be populated with patient on the selected row of the Now Showing screen. Using the Find command button (binoculars), the user can bring up a patient selector dialog and select any patient in the database.
5) The Select a room drop down listbox will be populated with the room of the active row in the Now Showing grid. The user can use this drop down list box to assign a new room for the media that is being queued.
6) The ‘Play this Title’ radio option group will allow the user to select when the media will be played on the patient playlist. ‘Immediately’ means interrupt any currently playing media, ‘Next on playlist’ means after any currently playing media completes, ‘At the end of today's playlist’ means to play it after every media for today's playlist is complete and ‘First to view on next visit’ means the video will be added after the last item that will be played on today's visit.
7) Clicking OK will queue the selected media based on the user selection and update the patient's playlist in the database.

The Media Maintenance screen will be launched either from the Media Maintenance icon in the main toolbar area or from the Media Maintenance item on the Tools menu (main menu). The Media Maintenance screen will appear as follows:

The Media Maintenance screen will behave as follows:
1) The Media Library grid will be populated with the entire, available media library. The columns of the grid will be: Title (the title name assigned to the media item by the user when the media item was installed), Type (video, poster group, audio and poster), Purpose (Educational, Marketing or Experimental), Category (Neck, Back, Favorite, etc) and Duration (length of the media play time in mm:ss format).
2) The grid contents can be filtered by media Type, Purpose or Category using drop down list boxes at the top of the grid.
3) The Install/Edit Media command button will bring up the Install/Edit Media screen which will allow the user to select a media file and make the appropriate settings as defined in section 2.6.2.1.
4) The Create/Edit a Poster Group will launch the Create/Edit Poster Group screen which allows the user to select from the installed posters in the media library and combine them into a group which will show sequentially (see section 2.6.2.2).
5) Change Clinic Logo brings up a screen which allows the user to load a clinic logo that will play at the front of every video shown as selected on Change Clinic Logo screen (Section 2.6.2.3).
6) The Media Statistics grid will bring up a dialog which will allow the user to see how often the video has been playing for a given date range and how many patients have this video on their playlist.
7) The Delete command button will remove the selected media item from the media library (after asking “Are you sure?”)
8) The Print command button will print a formatted output of the contents of the media library grid. media excluded from playlist when patients come in to see them. The media will be on the patient's playlist but just would not be shown if they were in the clinic to see that provider.
7) The ‘Set Associated Document’ button brings up a standard Windows file open dialog which allows the user to select a document that this then associated with this media (such as diagrams of exercises that were described in the video). A copy of the document will be saved away in a location protected the VPEIM program.
8) The ‘View’ button will bring up the associated note for viewing.
9) If the media is purchased from Future Health Inc, an initialization text file will be included (same name as media file with the VPEIM extension). In this case the fields will be initialized based on an accompanying document with the media but they can be changed by the user if desired.
10) The Add button in the main attributes box (upper left) will allow the user to add Class types (such as “Clinic Special”, “Experimental”, etc).
11) Outside the main attribute box are controls which allow the user to associate point value for this video with specific diagnosis and patient demographics. These point values will be used to auto-generate a playlist for patients based on their own diagnosis and demographics.
12) In Step one, the user selects a Rating Criteria (diagnosis or demographic) in the Rating Criteria listbox. When this is done, the Criteria Specifics list box will populate with the items available in the database for that category.
13) In Step two the user selects one of the items in the Available Items listbox.
14) In Step three, the user clicks the “Add >” button which brings up the Set Points dialog. The user selects the point value of this media for this item on a 1-100 scale (if higher values are desired, the user can enter the number directly).
15) Once OK or <Enter> is clicked on the Set Points dialog, the item gets added to the setting listbox with the specified point value.
16) The user repeats these there steps for any other diagnosis or demographic data for which point values should be assigned.
17) In the upper right area there is a section where the user can set point values for age brackets and children under a user specified age.
18) The Edit command button will bring up the Set Points dialog so the user can change the points setting for the selected row in the setting listbox.
19) The Remove command button will remove the selected row from the listbox (and database).
20) The Quick Rating will bring up the Set Points dialog and then once the user clicks OK will make an entry under “Quick Rating” criteria. This would be used for the clinic intro video for all patients, etc.
21) The Total Points text box will keep a total of the point values assigned for all settings in the Settings listbox.
22) The ‘Print’ button will print out all the data, notes and associated documents for this media.
23) The OK command button will clear all user input fields and list boxes so that a new media can be installed.

b) Install/Edit Media Screen/VPEIM Module

The Install/Edit Media Screen will launch from the Install/Edit Media command button on the Media Maintenance Screen and will appear as follows:

The behavior of the Install a Media screen is as follows:
1) In the upper left boxed area, the user selects the main attributes of the media. The Find button (binoculars) will bring up a standard windows file search dialog from which the user will locate the media file to install (can be on a DVD). The user enters a title for this media in the Title text box. The user then selects the Media Type and Purpose from the drop down list boxes (as defined in section 2.6.1.2). Lastly the user can select categories under which the media will be classified (such as “Neck”, “Back”, “Favorites”, etc).
2) The two ‘Add’ button can be used to add new Purposes and Categories which will then appear on the drop down lists.
3) The Summary button will allow the user to view/edit a memo summary of what the media is about.
4) Clicking the ‘Clinic Record Entry’ checkbox will cause VPEIM to send/log the fact of viewing the video in a clinic note for the patient (made in DOCUmentor).
5) The ‘View Clinic Entry’ will display the text that is inserted in the clinic note when this media is viewed. This text will be created and stored in DOCUmentor but will be viewable from this screen.
6) The ‘Exclude Provider’ button will bring up a listbox with all the clinic providers. The user can click on providers and those providers will have this

c) Create/Edit Poster Group Screen/VPEIM Module

The Create/Edit Poster Group screen will be launched by the Create/Edit Poster Group command button on the Media Maintenance screen and will appear as follows:

The Create/Edit Poster Group screen will behave as follows:
1) In the upper left box the user will select the Poster Group title either through the Find button (binoculars) (for an existing poster group) or by typing in the poster group title name (for new poster group). The Add button will clear the Media Title edit box as well as the Poster Group listbox below.
2) Using the Available Posters listbox, the user selects the poster, which will then be shown in the preview area on the right, and then clicks the Add>> button.
3) Clicking the Add>> button will bring up a Set Timing dialog whereby the user will set the number of seconds that the selected group of posters will display for in the in the poster group.
4) The user then repeats these two steps until the poster group is complete.
5) The Edit command button will bring up the Set Timing dialog for the title selected in the Poster Group listbox.
6) The Remove command button will removed the selected item from the Poster Group listbox (and database).
7) The Clear All button will remove all the items from the Poster Group listbox (and database).
8) The ‘Speed Play (×10)’ will play the poster group back at 10× the actual rate in the Preview area.
9) The OK button will clear all user input fields and listboxes in preparation for the creation of the next poster group.

d) Change Clinic Logo Screen/VPEIM Module

The Change Clinic Logo Screen will allow the user to change or set the logo that will play at the beginning of each video clip and will appear as follows:

The behavior of the Change Clinic Logo will be as follows:
1) Clicking the Select a File command button will bring up a standard Windows™ file open dialog from which the user will select the logo image file.
2) Using the Zoom-in, Zoom-out and Fill Screen buttons the user can adjust the size of the image.
3) Clicking the ‘Edit’ button will lunch Microsoft Paint (comes with Window XP) where the user can make adjustments to their logo.
4) The user enters the number of seconds that the logo will show in the Timing box.
5) At the bottom, the user select the checkboxes for when the logo will be shown (at the start of play, end of play and after each media item).
6) Clicking the OK command button will save the settings to the database and dismiss this screen.

e) Manage Patient Playlist screen/VPEIM Module

The Manage Patient Playlist screen is launched either from the Patient's Playlist icon on the main toolbar (buddy with film clip-when the Now Showing screen is active) or from the Manage Patient Playlist item on the Tools Menu. The Manage Playlist is a multi-tab interface that allows the user to generate, view and edit the patient playlist. The four tabs of the Manage Patient Playlist screen are described in section 2.6.3.1-2.6.3.4. The toolbar icon for launching the Manage Patient Playlist screen appears as follows:

f) Patient List Tab/VPEIM Module

The Patient List tab will allow the user to select a patient for which the play list will be generated, viewed or edited. The Patient List tab will appear as follows:

The behavior of the Patient List tab is as follows:
1) The Grid will be populated with all patients in the database. The columns of the grid will be: Patient Code (alpha-numeric code assigned to the patient), Last Name (last name of the patient), First Name (first name of the patient) and Claim Description (name assigned to the particular insurance claim or incident that the patient is being treated for).
2) Clicking on header title for Patient Code or Last Name will cause the grid to sort by that column.
3) Typing text in the Look For edit box will move the selected row to the first match of the text in the active column.
4) Double clicking on a row or clicking the OK button will activate the Patient Data tab and bring in the data for the selected patient.
5) Clicking the Today's Patients check box will filter the list for patients that are scheduled today (in the TPS 2000 Scheduler or a compatible one).
6) User the calendar button the user can specify dates for the “Scheduled Between” boxes that will filter the list for only patients with appointments between those dates.

g) Patient Data Tab/VPEIM Module

The Patient Data tab will be launched by double clicking on a row in the Patient list tab or by clicking no the tab itself The Patient Data tab will appear as follows:

The Patient Data tab is read only screen and has no behavior other that the inherent behavior of the listboxes. The exact list items that will appear on the patient data screen will be supplied by FHI.

h) Current Playlist Tab/VPEIM Module

The Current Playlist tab will be activated by clicking on the tab and will appear as follows:

The behavior of the Current Playlist tab will be as follows:
I) The grid will be populated with what is currently stored in the database as the playlist of media for the selected patient. The columns of the grid will be Title (Title given to the media item), High Points (the highest scoring points value on the criteria settings), Duration (playtime of the media in mm:ss format), visit # (expected patient visit number for the when the media will be viewed), Expected View Date (expected date that the media will be viewed or the date that it was viewed), Clinic Note Entry (whether or not a note mentioning that the media was seen was entered in the clinical note for that day), Associated File (how and whether or not the associated document for that media was given to the patient [printed, FAXed or e-mailed]).
2) The tab will read the current visit data from the database and display it over the Visit # column.
3) The user can enter a date bracket for the expected view date column by using the two calendar button on the upper right.
4) Clicking the Print button will print a formatted output of the contents of the Current Playlist grid.

i) Playlist Editor Tab/VPEIM Module

The Playlist Editor tab will be activated by clicking on the tab and will appear as follows:

The Playlist Editor tab will behave as follows:
1) In the upper left Auto-Generate List box the user can select options that will be used by the program to automatically generate a playlist for the patient. These options are: By Diagnosis, By Patient Data, Exclude titles already viewed (3 months, 6 months and 1 year) and Include All.
2) Clicking the OK Command button in the Auto-Generate List box will cause the computer to generate a list of videos that have scored points with this patient based on the user selections. The default order of the list will be highest point value media at the top.
3) In the Manually Edit List box, the user has three options for manually manipulating the list. Add a title will bring up the Media Search form so the user can select any title. The Remove Selected Title command button will remove the selected title from the Playlist listbox.
4) Remove all will clear the Playlist listbox.
5) The OK command button will store the generated playlist back to the database and activate the Current Playlist tab.
6) The Use Default button will cause the default list selected in the drop down listbox to be inserted into the patient's playlist.
7) The user can change to order of the them generated items by sliding them up and down using the slider button on the left of the listbox.
8) The Create Default Playlist command button will make a slight adjustment to the controls as detailed in section 2.6.3.5.

j) Default Playlist Editor Tab/VPEIM Module

The Default Playlist Editor tab is a slightly altered version of the Playlist Editor tab is activated by clicking on the Create Default Playlist button (see Playlist/Editor screen in section 2.6.3.4). This tab will allow the user to create and name a default playlist for use when no patient playlist is available. The difference in the Default Playlist editor is that the auto-generate features are disabled and replaced by the dialog that allows the user to input a name for the list.

The behavior of the default list is as follows:
1) The tab will behave the same as the patient playlist editor tab with these minor changes. The user can use the Add and Find button to enter new titles or find existing default playlist to edit. When OK is command button is clicked, the playlist will be entered into the database the and playlist will be cleared.

It is to be understood that the foregoing exemplary descriptions of aspects according to the invention are by way of illustrative only and are not exhaustive. Variations obvious to those skilled in the art are included within the invention, which is defined solely by the appended claims herein and not by the exemplary examples herein.

What is claimed is:

1. A method for automatically managing different functions of an office, comprising:
a) inputting different types of client and/or business data related to multiple different functions performed by an office in different data fields;
b) storing or linking together the different types of data;
c) updating the stored or linked together data in such a way that a change to one piece of data for a given client updates the information for all relevant fields of data across the different functions for that client; and
d) generating a summary report based on the stored or linked together information.

2. The method of claim 1 wherein the different functions performed by the office include at least one of the following functions billing, scheduling, client recordkeeping, and client education and marketing.

3. The method of claim 1 wherein the method for automatically managing different functions of an office further comprises the step of automatically selecting client education, marketing or other business-related information or materials from a stored collection of such information and materials based on selection criteria established by the business.

4. The method of claim 1 wherein the step of storing or linking together the different types of data is further includes the step of storing all of the data for a given client in a single database table.

5. The method of claim 1 wherein the step of storing or linking together the different types of data is further includes the step of storing multiple different types of data in different tables and linking those tables based on key fields that are common between the different tables.

6. A system for automatically managing different functions of an office that allows a user to input different types of client and/or business data related to multiple different functions performed by an office in different data fields, to store or link together the different types of data, to update the stored or linked together data in such a way that a change to one piece of data for a given client updates the information for all different functions for that client, and to generate a summary report based on the stored or linked together information.

7. The system of claim 6 wherein the different functions performed by the office include at least one of the following functions billing, scheduling, client recordkeeping, and client education and marketing.

8. The system of claim 6 wherein the system further comprises a system for automatically selecting client education, marketing or other business-related information or materials from a stored collection of such information or materials based on selection criteria established by the business, such that the selected information or materials are targeted to the specific client.

9. The system of claim 6 wherein system includes a database with a single table corresponding to each client of the business that stores all of the data for that particular client.

10. A method for automatically selecting client education, marketing or other business-related items to be viewed by a client at a location owned by, operated by or otherwise affiliated with a business comprising:
a) storing multiple different types of client education, marketing or other business-related items to be viewed by a client in a collection of such items;
b) storing multiple different types of data relevant to a client or clients and/or the business;
c) establishing selection criteria based on at least some of the multiple different types of data stored;
d) comparing the selection criteria with the available items in the collection; and
e) automatically selecting items from the collection that targeted to the client based upon the comparison.

11. The method of claim 10 wherein the selection criteria includes client demographic data.

12. The method of claim 11 wherein the client demographic data includes at least one of the following: client age, address, gender, occupation, recreational interests, hobbies, life interests, medical history, family members or family members' medical histories.

13. The method of claim 10 wherein the selection criteria include billing data for the business.

14. The method of claim 10 wherein the selection criteria include at least one of the following types of data related to the client education, marketing or other business-related information or materials: duration of the item and prior viewing status of the item.

15. The method of claim 10 wherein the selection criteria include scheduling data for the business.

16. The method of claim 15 wherein the scheduling data includes at least the estimated waiting time for the client.

17. The method of claim 10 further comprising the step of tracking which items have been viewed by each of the business' clients.

18. The method of claim 17 further comprising the step of tracking how much of each item has been viewed by each of the business' clients.

19. The method of claim 10 wherein the method forms part of a method of virtually managing an office.

20. The method of claim 10 wherein the method is interoperable with a method of virtually managing an office.

21. The method of claim 10 wherein the method is linked to a method of virtually managing an office.

22. The method of claim 10 further comprising the step of generating a playlist of multiple items to be potentially played for a client based on the results of the comparison wherein the items in the playlist are ranked in order of priority to the client based on the selection criteria.

23. The method of claim 22 further comprising the step of causing the items on the playlist to be provided to the client in the priority order of the playlist.

24. The method of claim 10 further comprising the step of automatically inserting information into at least one of the stored types of data when the client has viewed some or all of the item.

25. A system for automatically selecting client education, marketing or other business-related items from a stored collection of such items based on selection criteria established by the business comprising:
a) a collection of multiple different types of client education, marketing or other business-related items to be viewed by a client;
b) a collection of multiple different types of data relevant to a client or clients and/or the business; and
c) selection criteria related to at least some of the collection of data that can be compared with the collection of items to automatically select one or more of the items that targeted to the client based upon the comparison.

26. The system of claim 25 wherein the collection of data is stored in a manner that all of a particular client's data is stored or linked together.

27. The system of claim 25 wherein the collection of items is stored in a virtual document management system.

28. The system of claim 27 wherein the virtual document management system comprises a video server.

29. The system of claim 28 wherein the video server comprises a personal computer (PC) with a video card.

30. The system of claim 25 wherein collection of data includes a field that tracks which items have been viewed by the client.

31. The system of claim 25 wherein the selection criteria includes client demographic data.

32. The system of claim 31 wherein the client demographic data includes at least one of the following: client age, address, gender, occupation, recreational interests, hobbies, life interests, medical history, family members or family members' medical histories.

33. The system of claim 25 wherein the selection criteria include billing data for the business.

34. The system of claim 25 wherein the selection criteria include at least one of the following types of data related to the client education, marketing or other business-related information or materials: duration of the item and prior viewing status of the item.

35. The system of claim 25 wherein the selection criteria include scheduling data for the business.

36. The system of claim 35 wherein the scheduling data includes at least the estimated waiting time for the client.

37. The system of claim 25 further comprising the step of tracking which items have been viewed by each of the business' clients.

38. The system of claim 25 further comprising a playlist generated as a result of the comparison wherein the playlist comprises a list of multiple items to be potentially played for a client wherein items in the playlist are ranked in order of priority to the client based on the selection criteria.

39. The system of claim 38 further comprising a video server that causes the items on the playlist to be provided to the client in the priority order of the playlist.
